(19) United States
(12) Patent Application Publication
(10) Pub. No.: US 2026/0052191 A1
(43) Pub. Date: Feb. 19, 2026

(54) SYSTEMS AND METHODS FOR TRANSFORMING DATA STRUCTURES USING AN INTEGRATION GATEWAY

(71) Applicant: AS0001, Inc., Carmel, IN (US)

(72) Inventors: Timothy Butler, Carmel, IN (US); Jonathan J. Thompson, Carmel, IN (US)

(73) Assignee: AS0001, Inc., Carmel, IN (US)

(21) Appl. No.: 19/169,583

(22) Filed: Apr. 3, 2025

Related U.S. Application Data
(63) Continuation-in-part of application No. 18/808,778, filed on Aug. 19, 2024, now Pat. No. 12,299,162.

(51) Int. Cl. H04L 67/567; H04L 9/40; H04L 67/565; H04L 67/5682

(52) U.S. Cl. CPC H04L 67/567; H04L 63/102; H04L 67/565; H04L 67/5682

(57) ABSTRACT

Systems, methods, and computer-readable for transforming data structures using an integration gateway are disclosed. A system can include one or more processing circuits configured to receive a connection request comprising a first unique identifier (UID) corresponding with at least one data source. The processing circuits can connect, using the first UID, the at least one data source to an entity computing system. The processing circuits can receive data request for accessing a data structure on the at least one data source, the data request comprising a second UID. The processing circuits can obtain, using the second UID, the data structure. The processing circuits can identify a transformation model stored in a secure environment based on a third UID. The processing circuits can model, using the transformation model, the data structure to generate a transformed data structure. The processing circuits can provide the transformed data structure to an integration gateway.

### CROSS-REFERENCE TO RELATED PATENT APPLICATIONS

The present application is a Continuation-In-Part of U.S. patent application Ser. No. 18/808,778, filed Aug. 19, 2024, and claims the benefit of the foregoing application under 35 U.S.C. § 120. The foregoing application is incorporated herein by reference in its entirety and for all purposes.

### BACKGROUND

The present implementations relate generally to computer security architecture and software for information security and cybersecurity. In a computer networked environment, entities such as people or companies have vulnerabilities that can result in security incidents. Some entities can desire to implement protections, and some entities can desire to offer protections.

### SUMMARY

Some implementations of the present disclosure relate to a method. In some implementations, the method can include receiving, by one or more processing circuits, a connection request comprising a first unique identifier (UID) corresponding with at least one data source. In some implementations, the method can further include connecting, by the one or more processing circuits using the first UID, the at least one data source to an entity computing system. In some implementations, the method can further include receiving, by the one or more processing circuits, a data request for accessing a data structure on the at least one data source. In some implementations, the data request can include a second UID. In some implementations, the method can further include obtaining, by the one or more processing circuits using the second UID, the data structure. In some implementations, the method can further include identifying, by the one or more processing circuits, a transformation model stored in a secure environment based on the third UID. In some implementations, the transformation model can include executable code for updating the data structure. In some implementations, the one or more processing circuits can restrict access, using the third UID, to the transformation model and corresponding executable code from a public environment. In some implementations, the method can further include modeling, by the one or more processing circuits using the transformation model, the data structure to generate a transformed data structure. In some implementations, the method can further include providing, by the one or more processing circuits, the transformed data structure to the integration gateway.

In some implementations, the method can further include identifying, by the one or more processing circuits, connection instructions stored in the secure environment based on the first UID. In some implementations, the connection instructions can include executable code for connecting the at least one data source to the entity computing system. In some implementations, the one or more processing circuits can restrict access, using the first UID, to the connection instructions and corresponding executable code from the public environment.

In some implementations, the second UID can correspond to at least one application program interface (API). In some implementations, the at least one API can include executable code for obtaining the data structure on the at least one data source

In some implementations, the method can further include enabling, by the one or more processing circuits, the first UID, the second UID, or the third UID. In some implementations, enabling the first UID, the second UID, or the third UID can expose the first UID, the second UID, or the third UID to the public environment

In some implementations, the public environment can include at least one open-source component, module, or library. In some implementations, the one or more processing circuits can communicate, via the integration gateway, with the at least one open-source component, module, or library to transform the data structure.

In some implementations, the secure environment can correspond to one or more secure data sources inaccessible by one or more computing systems operating in the public environment and executing open-source code.

In some implementations, the unique identifier (UID) can be at least one of a globally unique identifier (GUID), a universally unique identifier (UUID), and a universally unique lexicographically sortable identifier (ULID).

In some implementations, the data structure can correspond to a first format, structure, fields, or protocols (FSFP). In some implementations, updating the data structure can include updating the first FSFP to a second FSFP. In some implementations, the second FSFP can correspond to a default or standardized FSFP.

In some implementations, the method can further include generating, by the one or more processing circuits, activity metrics based on using the transformation model. In some implementations, the activity metrics can include at least one of performance data, demand data, security data, or error data of the transformation model. In some implementations, the method can further include mapping, by the one or more processing circuits, the activity metrics to the first UID, the second UID, or the third UID. In some implementations, using the UID as a parameter to a user data request can allow a user device to display the activity metrics via a graphical user interface (GUI).

In some implementations, the method can further include generating, by the one or more processing circuits, an activity token including at least the activity metrics. In some implementations, the method can further include broadcasting, by the one or more processing circuits, the activity token to a plurality of network nodes. In some implementations, the method can further include validating, by the one or more processing circuits, the activity token using a consensus mechanism. In some implementations, the method can further include recording, by the one or more processing circuits, the activity token on a distributed ledger.

In some implementations, the method can further include determining or identifying, by the one or more processing circuits, a creator or owner of a plurality of transformation models. In some implementations, the method can further include in response to using the transformation model, allocate an amount or a percentage of an amount to an account of the creator or owner of the plurality of transformation models.

Some implementations of the present disclosure relate to a system. In some implementations, the system can include one or more processing circuits configured to receive a connection request comprising a first unique identifier (UID) corresponding with at least one data source. In some implementations, the one or more processing circuits can be further configured to connect, using the first UID, the at least one data source to an entity computing system. In some implementations, the one or more processing circuits can be further configured to receive a data request for accessing a data structure on the at least one data source. In some implementations, the data request can include a second UID. In some implementations, the one or more processing circuits can be further configured to obtain, using the second UID, the data structure. In some implementations, the one or more processing circuits can be further configured to identify a transformation model stored in a secure environment based on a third UID. In some implementations, the transformation model can include executable code for updating the data structure. In some implementations, the one or more processing circuits can be further configured to restrict access, using the third UID, to the transformation model and corresponding executable code from a public environment. In some implementations, the one or more processing circuits can be further configured to model, using the transformation model, the data structure to generate a transformed data structure. In some implementations, the one or more processing circuits can be further configured to provide the transformed data structure to the integration gateway.

In some implementations, the one or more processing circuits can be further configured to identify, connection instructions stored in the secure environment based on the first UID. In some implementations, the connection instructions can include executable code for connecting the at least one data source to the entity computing system. In some implementations, the one or more processing circuits can be configured to restrict access, using the first UID, to the connection instructions and corresponding executable code from the public environment.

In some implementations, the second UID can correspond to at least one application program interface (API). In some implementations, the at least one API can include executable code for obtaining the data structure on the at least one data source.

In some implementations, the one or more processing circuits can be further configured to enable the first UID, the second UID, or the third UID. In some implementations, enabling the first UID, the second UID, or the third UID exposes the first UID, the second UID, or the third UID to the public environment.

In some implementations, the public environment can include at least one open-source component, module, or library. In some implementations, the one or more processing circuits can be further configured to communicate, via the integration gateway, with the at least one open-source component, module, or library to transform the data structure.

In some implementations, the secure environment can correspond to one or more secure data sources inaccessible by one or more computing systems operating in the public environment and executing open-source code.

In some implementations, the unique identifier (UID) can be at least one of a globally unique identifier (GUID), a universally unique identifier (UUID), and a universally unique lexicographically sortable identifier (ULID).

In some implementations, the data structure can correspond to a first format, structure, fields, or protocols (FSFP). In some implementations, updating the data structure includes updating the first FSFP to a second FSFP. In some implementations, the second FSFP can correspond to a default or standardized FSFP.

Some implementations of the present disclosure relate to one or more non-transitory computer-readable media (CRM) having instructions stored thereon that, when executed by one or more processing circuits, cause the one or more processing circuits to receive a connection request comprising a first unique identifier (UID) corresponding with at least one data source. In some implementations, the instructions can further cause the one or more processing circuits to connect, using the first UID, the at least one data source to an entity computing system. In some implementations, the instructions can further cause the one or more processing circuits to receive a data request for accessing a data structure on the at least one data source. In some implementations, the data request can include a second UID. In some implementations, the instructions can further cause the one or more processing circuits to obtain, using the second UID, the data structure. In some implementations, the instructions can further cause the one or more processing circuits to identify a transformation model stored in a secure environment based on a third UID. In some implementations, the transformation model can include executable code for updating the data structure. In some implementations, the instructions can further cause the one or more processing circuits to restrict access, using the third UID, to the transformation model and corresponding executable code from a public environment. In some implementations, the instructions can further cause the one or more processing circuits to model, using the transformation model, the data structure to generate a transformed data structure. In some implementations, the instructions can further cause the one or more processing circuits to provide the transformed data structure to the integration gateway.

### BRIEF DESCRIPTION OF THE DRAWINGS

The present systems and methods for particle upscaling and motion modeling for particle-based simulation are described in detail below with reference to the attached drawing figures, wherein:

FIG. 1A depicts a block diagram of an implementation of a system for managing and configuring incident responses, according to some implementations.

FIG. 1B depicts a block diagram of a more detailed architecture of certain systems or devices of FIG. 1A, according to some implementations.

FIG. 2 depicts a computer system, according to some implementations.

FIG. 3 depicts an architecture that facilitates data acquisition and analysis, according to some implementations.

FIGS. 4A-B depicts a flowchart for a method for incident response preparedness and readiness, according to some implementations.

FIG. 5 depicts an example vendor-provider marketplace, according to some implementations.

FIG. 6 depicts a flowchart for a method for capturing the state of capabilities, according to some implementations.

FIG. 7 depicts a block diagram of an implementation of a system for cyber resilience tokenization, according to some implementations.

FIG. 8 depicts a block diagram of a more detailed architecture of certain systems or devices of FIG. 7, according to some implementations.

FIG. 9 depicts a block diagram of a more detailed architecture of certain systems or devices of FIG. 7, according to some implementations.

FIGS. 10A-10I depict an architecture for tokenized cyber resilience data, according to some implementations.

FIG. 11 a block diagram of an implementation of a system for endpoint integration and mapping, according to some implementations.

FIG. 12 depicts a block diagram of a more detailed architecture of certain systems or devices of FIG. 11, according to some implementations.

FIG. 13 depicts a flowchart for a method of endpoint integration and mapping, according to some implementations.

FIG. 14 depicts a flowchart for a method of transforming data structures using an integration gateway, according to some implementations.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Referring generally to the FIGURES, systems and methods relate generally to implementing endpoint integrations and mapping. In some implementations, the implementations can include a security architecture that models cyber resilience data using cyber resilience identities and associated metadata. In some implementations, the system represents an implementation of an endpoint integration and mapping system.

Existing cybersecurity systems and architectures exhibit multiple technical limitations, reducing effectiveness in managing and responding to cyber threats. One technical limitation involves the absence of integrated incident response capabilities. Numerous systems operate in isolation, utilizing separate tools for threat detection, response, and recovery, leading to delays in response times, communication challenges between components, and fragmented visibility into the overall security posture. Another limitation involves the absence of streamlined processes for engaging third party vendors for incident response services, often requiring navigation through complex procurement protocols during a cyber incident, which delays mitigation efforts. Systems frequently implement incomplete assessment mechanisms for readiness in incident response, resulting in unclear visibility into system capabilities and constraints, complicating communication with potential response providers. Static defenses, often employed by current systems, fail to adjust to emerging threats. These static defenses introduce vulnerabilities, as attackers continuously evolve their strategies and methods. Systems fail to account for changes in infrastructure and operations, such as the integration of new technologies or modifications in business processes, introducing new potential attack vectors. The reliance on static defenses limits the system from maintaining a robust security posture, increasing exposure to an evolving threat landscape.

The implementations described herein provide technical capabilities for preventing cyber threats, including unauthorized access, data breaches, and cyberattacks, by generating a customized cybersecurity framework tailored to technical requirements. The framework and implementations can be used to identify current cybersecurity vulnerabilities and facilitate connections with vendors offering targeted protection plans. Thereby, the systems can provide enhanced data protections including safeguarding sensitive information such as medical records, financial data, and proprietary business information. The framework and implementations can also reduce economic, and infrastructure burdens associated with data breaches, including expenses related to infrastructure failures, forensic investigations, and legal actions. The cybersecurity models described herein can detect and address vulnerabilities while providing dynamic monitoring of relationships between networks, hardware, devices, and financial entities. The implementations can also improve cybersecurity by enhancing network, infrastructure, technology, and data security. Vendors can use the systems and methods described herein to actively monitor and provide responses to potential threats, improving the overall security posture. The customized cybersecurity frameworks address existing vulnerabilities and anticipate future threats, offering an adaptive and proactive solution to cybersecurity.

Implementation of customized cybersecurity frameworks facilitate technical systems to identify existing vulnerabilities, map vulnerabilities to assets, and provide targeted protection strategies. The technical benefit includes generating remediation recommendations and preventing successful hacking activities, cyberattacks, data breaches, and other cyber incidents. Systems and methods disclosed herein facilitate connections of systems to suitable vendors and other entities, offering security plans customized to vulnerabilities and technical needs identified. Implementations of customized cybersecurity frameworks can improve the process of identifying and addressing vulnerabilities by streamlining resources, facilitating continuous monitoring of cybersecurity status of the system by vendors, providing dynamic responses to potential threats, and maintaining the integrity and security of system infrastructure. Customized frameworks provide technical capabilities to facilitate determinations about cybersecurity strategies by selecting from a range of vendor plans and services, activating plans as needed, and ensuring cybersecurity is actively monitored and managed.

A technical improvement in dynamic cybersecurity architecture comprehension is provided by identifying and mapping cybersecurity vulnerabilities within customized cybersecurity frameworks. The need to maintain separate inventories of network weaknesses, infrastructure vulnerabilities, and operating system susceptibilities can be reduced or eliminated. The implementations of the customized cybersecurity framework can include identifying potential security gaps associated with system identifiers, such as domain identifiers, IP addresses, or subnets. Rather than assessing at least one (e.g., each) subclass of vulnerabilities separately, a computing system utilizes a unified view into the computing environment of the target system and centrally manages the identification of different types of vulnerabilities and associated potential security threats. Vulnerability identification operations can include computer-executed processes to model one or more cybersecurity statuses, determine vulnerabilities based on statuses, and integrate or connect systems to suitable vendors offering appropriate cybersecurity plans.

Additionally, the cybersecurity framework enhances data management and sharing through tokenization of cybersecurity information. Tokenization can encrypt cybersecurity posture and insurance information for secure access and storage, with access controlled by smart contracts. Tokenization can be used to prevent unauthorized access and improves data integrity, enhancing data sharing and trust among stakeholders. Additionally, Distributed Non-Fungible Tokens (DNFTs) can provide transparency in tracking and verifying cybersecurity management events and insurance-related activities. Transparency in these processes can improve the accuracy of cyber risk assessments and reduces the likelihood of fraud, as all parties verify the authenticity of performance history events through mechanisms such as multi-signature wallets or signature verification within smart contracts. Tokenization of cybersecurity information, using NFTs or DNFTs, provides real-time visibility into a cyber risk posture of the client. For example, dynamic visibility can facilitate monitoring of compliance and adjustments to policies based on the current risk status of the client. That is, access to up-to-date information allows insurers to provide accurate and fair policy pricing, aligning incentives between insurers, brokers, and policyholders. Real-time monitoring capabilities can also provide responsive updates to potential threats, enhancing the overall security posture. The ability to adapt to changes in the cyber threat landscape and organizational infrastructure provides a cybersecurity framework that is improved and remains responsive to evolving risks.

Token integration within cybersecurity frameworks provides a unified view of system cybersecurity status. By consolidating information from various security systems into a single platform, the implementations can conduct cyber threat and risk assessments with greater accuracy and efficiency by accessing data mapped to tokens. That is, the implementations facilitate communication and collaboration between systems, vendors, and carriers, ensuring systems can identify cyber risks collectively. Data location mapping, connection of security stacks, and provision of targeted protection strategies can improve alignment of incentives between various cyber resilience entities. Tokenization also enhances systems through improved protection and fair policy pricing.

Decentralized ledger implementation, such as Blockchain, can be used to enhance the security and integrity of the data exchange process. Decentralized ledgers verify that transactions and data entries are immutable and verifiable, providing a secure and transparent audit trail for cybersecurity activities. Blockchain architecture provides a distributed consensus mechanism that validates transactions without requiring a central authority, reducing the risk of data tampering and unauthorized access. The decentralized nature of Blockchain enhances interoperability between different security platforms, allowing seamless integration and communication among various cybersecurity tools and stakeholders. Resilient infrastructure capable of withstanding cyberattacks facilitates secure and efficient data sharing and management. Tokens on a decentralized ledger improve reliability in cyber risk assessments and strengthen stakeholder confidence in implemented security measures.

Integration of decentralized compute and data store interface (DCDSI) endpoints into cybersecurity frameworks streamlines management and execution of endpoint requests across diverse systems with various integrations and implementations. Identifying and mapping endpoint access information into a standardized format enhances compatibility and interoperability between different APIs and decentralized endpoints. This mapping capability reduces errors during data retrieval and enforces accurate access permissions, improving the overall security posture. Integration of endpoint information into object packages dynamically invoked for tasks provides consistent and adaptable system operations, aligning endpoint interactions with current security policies and access rules.

Generating object packages customized to endpoint types increases flexibility and scalability within cybersecurity frameworks. This approach facilitates the incorporation of new endpoints and the updating of existing endpoints without disrupting ongoing operations. That is, the structuring object packages according to endpoint types and mapping access information to predefined schemes integrates endpoints into the broader cybersecurity infrastructure more efficiently with improved accuracy. Additionally, using machine learning models to extract and update access information from relevant documents can maintain the latest endpoint configurations and requirements, minimizing potential for misconfigurations.

The disclosed system provides an improved model for verifying authenticity and integrity of data exchanged through DCDSI endpoints. Incorporating token-based authorization and rule-based access controls into endpoint management processes restricts access to data to authorized entities. Enhanced data security is achieved by preventing unauthorized access while logging and auditing endpoint interactions. Validation of access information against rules, either before or after data retrieval, improves the security framework through access controls and real-time monitoring of endpoint activities. Additionally, the mapping of output data to predefined formats for storage can facilitate consistent organization and accessibility for future analysis, contributing to a technically improved, dynamic, and responsive cybersecurity infrastructure.

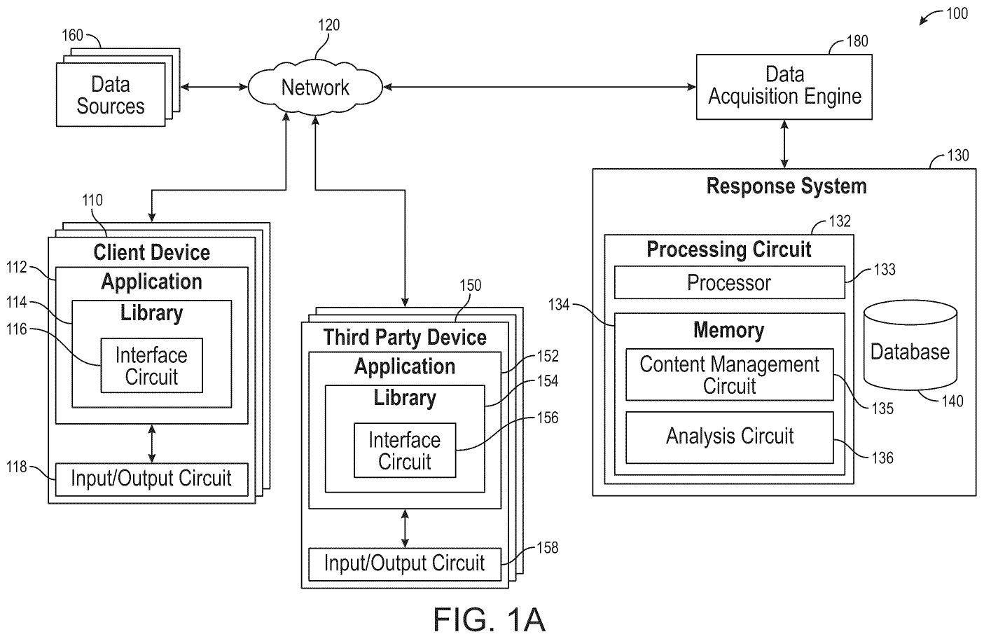

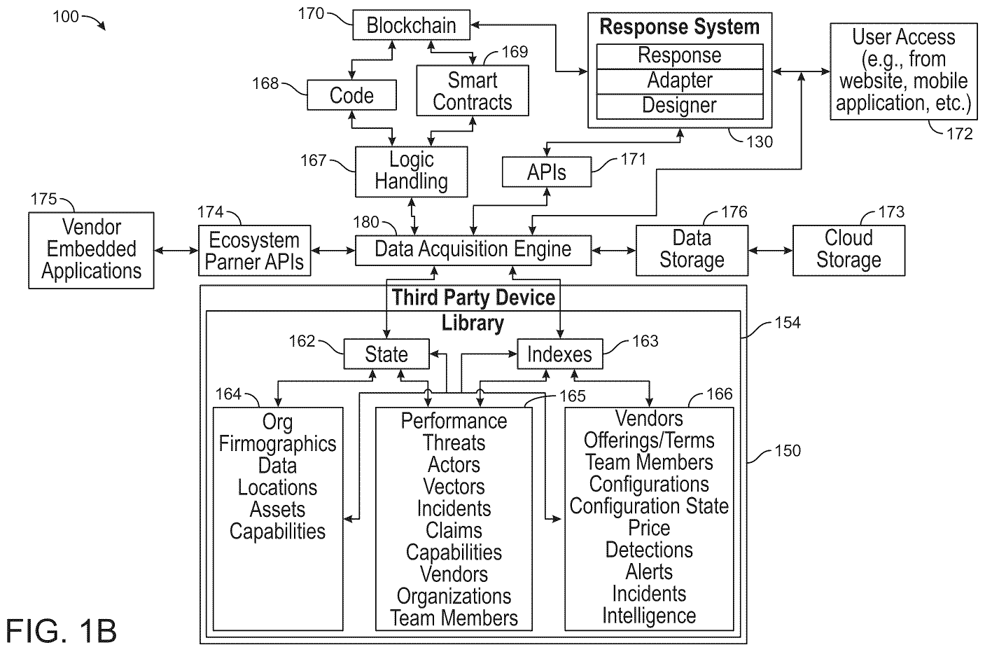

Referring to FIGS. 1A and 1B generally, system 100 is an implementation of a security architecture utilizing modeling to provide an incident response management platform that includes multiple components, such as client device 110, response system 130, third party devices 150, and data sources 160. These components can be interconnected through a network 120 that supports secure communication protocols such as TLS, SSL, and HTTPS. In some implementations, the response system 130 can generate and provide an application for incident response readiness that guides users through the steps to prepare for and manage incidents effectively. The application can integrate with various technologies and vendors to purchase services to resolve issues and provides integration points for incident response workflow management. For example, users can access a marketplace within the application to purchase products, insurance, and services, and can determine the capabilities of their organization, limitations, and threat focus. In some implementations, the response system 130 also presents the readiness of the organization to incident response providers and automatically routes them to pre-associated panel vendors or organization-selected vendors at the point of need, contracting and activating the incident room immediately.

In some implementations, the response system 130 can integrate readiness, including insurer data, into various third party devices via APIs. In some implementations, the response system 130 can map an incident response (IR) plan from a static document or documents to the task enablers in Responder that bring them to life, showing where the tasks used by partners such as IR firms, insurers, and breach counsel are covered by the IR plan and IR playbook. The response system 130 can decompose the response plan into associated actionable tasks and activities by the organization, incident response providers, and other stakeholders, and provides different users and partners with a unified view of tasks, activities, and progress/status tracking.

In some implementations, the response system 130 stores data regarding key milestones in an authoritative data source such as blockchain (e.g., database 140), ensuring that results are traceable and linkable. For example, issues can be identified, tasks can be created, work can be routed to vendors, and proof of resolution can be recorded. In some implementations, the response system 130 can also supports real-time status tracking of policy-aligned tasks to status updates provided for incident response. In some implementations, instant intake is achieved by a remote embeddable widget on a website, which starts an incident response process that begins with a proposal stage and continues through workflows to achieve response readiness based on pre-defined logic and automation. For example, services can be purchased or extended within the application, and in the event of an inbound incident, the application facilitates routing to a claim manager.

In some implementations, the response system 130 can provide an application for incident response readiness that guides users through the steps to ensure they are prepared for any potential incidents. The application can be configured to integrate with technology and vendors to purchase services that are used to resolve issues. For example, the user can access the application through a variety of devices, including client device 110. In particular, the application can offer integration points for incident response workflow management, allowing users to streamline their incident response process. The organization incident readiness feature of the response system 130 offers several features, including the integration of readiness, including insurer data, into various third party systems, such as via an API. By integrating with third party systems, the response system 130 can ensure that users have access to the most up-to-date information regarding the readiness of their organization for potential incidents. In addition, the response system 130 can offer incident response plan mapping from a static plan document to the task enablers in Responder, which brings the tasks used by partners such as IR firms, insurers, and breach counsel to be measurable and identified.

Still referring to FIGS. 1A and 1B generally, the response system 130 can offer a marketplace for purchasing products, insurance, and services that can be used in the event of an incident. The marketplace includes various vendors that offer different products and services, allowing users to choose the best fit for their organization based on their capabilities, limitations, and threat focus. The application also determines organization readiness levels with proof of date, time stamps, and artifacts (e.g., on the blockchain), which can be used to identify any gaps in the incident response plan of their organization. In some implementations, the response system 130 can automate the routing of incidents to pre-associated, panel vendors or organization-selected vendors at the point of need and immediately contracts and activates the incident room (e.g., when a cyber incident occurred or potentially occurred). Accordingly, the system 100 can ensure that the organization can respond to an incident as quickly and efficiently as possible. Additionally, the response system 130 can decompose the response plan into associated actionable tasks and activities by the organization, incident response providers, and others. This allows users to better understand the response plan of their organization and identify areas for improvement.

In general, the application (e.g., graphical user interface provided by content management circuit 135) provides different users/partners with a unified view of tasks, activities, and progress/status tracking. For example, the status tracking can be tied back to incident readiness and managing the incident through resolution. Users can collaborate via the tool instead of via phone calls and emails, which ensures that everyone is working from the same information and avoids any miscommunication. The application can also offers real-time (or near real-time) status tracking of policy aligned tasks to status updates provided for incident response, allowing users to quickly and easily see how their incident response plan is progressing. In some implementations, data regarding key milestones is stored in an authoritative data source such as blockchain (e.g., database 140 (private ledger) or data sources 160 (public ledger)), ensuring that results can be traceable and linkable. Thus, this can allow users to identify areas for improvement in their incident response plan and make changes as necessary. In some implementations, the response system 130 offers an instant intake feature that can be integrated into a remote embeddable widget on a website. For example, the widget can start an incident response process that starts with a proposal stage and continues through workflows to achieve response readiness based on pre-defined logic and automation. This ensures that incidents are quickly identified and resolved, and that the organization is prepared for any potential incidents.

Still referring to FIGS. 1A and 1B generally, the response system 130 of system 100 includes a data acquisition engine 180 and analysis circuit 136 that democratizes posture threats, incidents, and claim data. In particular, all stakeholders in the incident response process can have access to relevant data to make informed decisions. The analysis circuit 136 can use the democratized data in underwriting, claims, and the resilience process to enhance the overall response to an incident. With the data acquisition engine 180, the response system 130 can collect and process data from various sources, such as third party devices 150 and data sources 160, to provide a view of the security posture of the organization. In some implementations, the response system 130 also implement incident response protocols and features via analysis circuit 136 that provide a centralized location for managing and configuring incident responses. For example, an application can walk users through the steps of incident response readiness and integrates with technology and vendors to purchase services to resolve issues. The response system 130 can automate the routing of incident response tasks to pre-associated, panel vendors, or organization-selected vendors at the point of need and immediately contracts and activates the incident room. By decomposing the response plan into associated actionable tasks and activities by the organization, incident response providers, and other stakeholders, the response system 130 ensures that all parties are working together to manage the incident through resolution.

In some implementations, the response system 130 includes a vendor-provider marketplace that allows organizations to purchase products, insurance, and services that enhance their incident response capabilities. For example, the marketplace can be integrated into the response system 130, allowing users to easily access relevant products and services during an incident. Additionally, the response system 130 can determine the capabilities of the organization, limitations, and threat focus to present readiness to incident response providers. In some implementations, the response system 130 can include collection, recall, and proof of state features that provide that data regarding key milestones is stored in an authoritative data source such as the blockchain. This includes capabilities pre-incident, what happened after the incident occurred, what was the root cause, and recording. For example, results are traceable and linkable, and issues are identified, tasks are created, work is routed to vendors, and proof of resolution is recorded. In some implementations, the response system 130 can include a drag and drop file tokenization feature that allows users to securely tokenize and store sensitive files. In particular, this feature is useful when organizations desire to share sensitive information with third parties or with internal stakeholders. The system ensures that the information is secure and that authorized parties can access it. Thus, this feature is designed to streamline the incident response process and ensure better collaboration between all stakeholders.

Referring now to FIG. 1A in more detail, a block diagram depicting an implementation of a system 100 for managing and configuring incident responses. System 100 includes client device 110, response system 130, third party devices 150, and data sources 160. In various implementations, components of system 100 communicate over network 120. Network 120 can include computer networks such as the Internet, local, wide, metro or other area networks, intranets, satellite networks, other computer networks such as voice or data mobile phone communication networks, combinations thereof, or any other type of electronic communications network. Network 120 can include or constitute a display network. In various implementations, network 120 facilitates secure communication between components of system 100. As a non-limiting example, network 120 can implement transport layer security (TLS), secure sockets layer (SSL), hypertext transfer protocol secure (HTTPS), and/or any other secure communication protocol.

In general, the client devices 110 and third party devices 150 can execute a software application (such as application 112 or application 152, e.g., a web browser, an installed application, or other application) to retrieve content from other computing systems and devices over network 120. Such an application can be configured to retrieve an interfaces and dashboards from the response system 130. In one implementation, the client device 110 and third party device 150 can execute a web browser application, which provides the interface (e.g., from content management circuit 135) on a viewport of the client device 110 or third party device 150. The web browser application that provides the interface can operate by receiving input of a uniform resource locator (URL), such as a web address, from an input device (such as input/output circuit 118 or 158, e.g., a pointing device, a keyboard, a touch screen, or another form of input device). In response, one or more processors of the client device 110 or third party device 150 executing the instructions from the web browser application can request data from another device connected to the network 120 referred to by the URL address (e.g., the response system 130). The other device can then provide webpage data and/or other data to the client device 110 or third party device 150, which causes the interface (or dashboard) to be presented by the viewport of the client device 110 or third party device 150. Accordingly, the browser window presents the interface to facilitate user interaction with the interface. In some implementations, the interface (or dashboard) can be presented via an application stored on the client device 110 and third party device 150.

The network 120 can facilitate communication between various nodes, such as the response system 130, third party device 150, client device 110, and data sources 160. In some implementations, data flows through the network 120 from a source node to a destination node as a flow of data packets, e.g., in the form of data packets in accordance with the Open Systems Interconnection (OSI) layers. A flow of packets can use, for example, an OSI layer-4 transport protocol such as the User Datagram Protocol (UDP), the Transmission Control Protocol (TCP), or the Stream Control Transmission Protocol (SCTP), transmitted via the network 120 layered over an OSI layer-3 network protocol such as Internet Protocol (IP), e.g., IPv4 or IPv6. The network 120 is composed of various network devices (nodes) communicatively linked to form one or more data communication paths between participating devices. At least one (e.g., each) networked device includes at least one network interface for receiving and/or transmitting data, typically as one or more data packets. An illustrative network 120 is the Internet; however, other networks can be used. The network 120 can be an autonomous system (AS), e.g., a network that is operated under a consistent unified routing policy (or at least appears to from outside the AS network) and is generally managed by a single administrative entity (e.g., a system operator, administrator, or administrative group).

Client device 110 (sometimes referred to herein as a “mobile device”) can be a mobile computing device, smartphone, tablet, smart watch, smart sensor, or any other device configured to facilitate receiving, displaying, and interacting with content (e.g., web pages, mobile applications, etc.). Client device 110 can include an application 112 to receive and display content and to receive user interaction with the content. For example, application 112 can be a web browser. Additionally, or alternatively, application 112 can be a mobile application. Client device 110 can also include an input/output circuit 118 for communicating data over network 120 (e.g., receive and transmit to response system 130).

In various implementations, application 112 interacts with a content publisher to receive online content, network content, and/or application content. For example, application 112 can receive and present various dashboards and information resources from distributed by the content publisher (e.g., content management circuit 135). Dashboards and/or information resources can include web-based content such as a web page or other online documents. The dashboards information resources can include instructions (e.g., scripts, executable code, etc.) that when interpreted by application 112 cause application 112 to display a graphical user interface such as an interactable web page and/or an interactive mobile application to a user (e.g., dashboards). In various implementations, application 112 can include one or more application interfaces for presenting an application (e.g., mobile application, web-based application, virtual reality/augmented reality application, smart TV application and so on).

Application 112 is shown to include library 114 having an interface circuit 116. The library 114 can include a collection of software development tools contained in a package (e.g., software development kit (SDK), application programming interface (API), integrated development environment (IDE), debugger, etc.). For example, library 114 can include an application programming interface (API). In another example, library 114 can include a debugger. In yet another example, the library 114 can be an SDK that includes an API, a debugger, and IDE, and so on. In some implementations, library 114 includes one or more libraries having functions that interface with a particular system software (e.g., IOS, Android, Linux, etc.). Library 114 can facilitate embedding functionality in application 112. For example, a user can use library 114 to automatically transmit event logs whenever an event occurs on application 112. As a further example, library 114 can include a function configured to collect and report device analytics and a user can insert the function into the instructions of application 112 to cause the function to be called during actions of application 112 (e.g., during testing as described in detail below). In some implementations, interface circuit 116 functionalities are provided by library 114.

In various implementations, interface circuit 116 of system 100 can provide one or more interfaces to users, which can be accessed through an application interface presented in the viewport of client device 110. These interfaces can take the form of dashboards and other graphical user interfaces, offering a variety of functionality to the user. For example, a user can view incident responses, remediate claims, communicate with team members, purchase or extend products and services, and more. The interfaces provided by interface circuit 116 can be customizable and dynamic, allowing users to configure and adjust them to suit their needs. They can also be designed to present real-time data associated with current incident responses, potential incidents or threats, and other important information, allowing users to make informed decisions and take proactive steps to manage risk.

For example, interface circuit 116 can generate dashboards that provide real-time data and insights. These dashboards can be customized to suit the needs of individual users or groups, providing a view of incident responses, potential threats, and the status of remediation efforts. For example, a dashboard might show the status of incident responses across different regions, or highlight areas where additional resources are needed. In another example, the interface circuit 116 can generate a landscape of all currently connected devices to the entity, such as a company or institution. This can include information on the types of devices, their locations, and other data that can help inform incident response efforts. With this information, users can better understand the scope of potential threats, identify vulnerable areas, and take steps to improve security and resilience.

In another example implementation, the application 112 executed by the client device 110 can cause a web browser to the display the interfaces (e.g., dashboards) on the client device 110. For example, the user can connect (e.g., via the network 120) to a website structured to host the interfaces. In various implementations, interface can include infrastructure such as, but not limited to, host devices (e.g., computing device) and a collection of files defining the interface and stored on the host devices (e.g., in database 140). The web browser operates by receiving input of a uniform resource locator (URL) into a field from an input device (e.g., a pointing device, a keyboard, a touchscreen, mobile phone, or another form of input device). In response, the interface circuit 116 executing the interface in the web browser can request data such as from content (e.g., vendor information, settings, current incident response, other dashboards, etc.) from database 140. The web browser can include other functionalities, such as navigational controls (e.g., backward and forward buttons, home buttons). In some implementations, the debugging interface can include both a client-side interface and a server-side interface. For example, a client-side interface can be written in one or more general purpose programming and can be executed by client device 110. The server-side interface can be written, for example, in one or more general purpose programming languages and can be executed by the response system 130.

Interface circuit 116 can detect events within application 112. In various implementations, interface circuit 116 can be configured to trigger other functionality based on detecting events (e.g., transactions, in-app purchases, performing a test of a vendor, scrolling through an incident response plan, sending a contract to a vendor, spending a certain amount of time interacting with an application, etc.). For example, interface circuit 116 can trigger a pop-up window (overlayed on an interface) upon selecting an actionable object (e.g., button, drop-down, input field, etc.) within a dashboard. In various implementations, library 114 includes a function that is embedded in application 112 to trigger interface circuit 116. For example, a user can include a function of library 114 in a transaction confirmation functionality of application 112 that causes interface circuit 116 to detect a confirmed transaction (e.g., purchase cybersecurity protection plans, partnering). It should be understood that events can include any action important to a user within an application and are not limited to the examples expressly contemplated herein. In various implementations, interface circuit 116 is configured to differentiate between different types of events. For example, interface circuit 116 can trigger a first set of actions based on a first type of detected event (e.g., selecting actionable objects within the static response plan) and can trigger a second set of actions based on a second type of detected event (e.g., running a test). In various implementations, interface circuit 116 is configured to collect event logs associated with the detected event and/or events and transmit the collected event logs to content management circuit 135.

In various implementations, the interface circuit 116 can collect events logs based on a designated session. In one example, the designated session can be active from when application 112 is opened/selected to when application 112 is closed/exited. In another example, the designated session can be active based on a user requesting a session to start and a session to end. At least one (e.g., each) session, the interface circuit 116 can collect event logs while the session is active. Once completed, the event logs can be provided to any system described herein. During the session, the event logs can trace at least one (e.g., each) event in the session such that the events are organized in ascending and/or descending order. In some implementations, the events can be organized utilizing various other techniques (e.g., by event type, by timestamp, by malfunctions, etc.).

In various implementations, the interface circuit 116 of the client device 110 (or third party device 150) can start collecting event logs when application 112 is opened (e.g., selected by the user via an input/output circuit 118 of the client device 110), thus starting a session. In some implementations, once the application is closed by the user the interface circuit 116 can stop collecting event logs, thus ending the session. In various implementations, the user can force clear event logs or force reset application 112 such that the current session can reset, thus ending a particular session and starting a new session. Additional details regarding the interface circuit 116 functionalities, and the dashboards and interfaces presented within a viewport of client device 110 are described in additional detail.

The input/output circuit 118 is structured to send and receive communications over network 120 (e.g., with response system 130 and/or third party device 150). The input/output circuit 118 is structured to exchange data (e.g., bundled event logs, content event logs, interactions), communications, instructions, etc. with an input/output component of the response system 130. In one implementation, the input/output circuit 118 includes communication circuitry for facilitating the exchange of data, values, messages, and the like between the input/output circuit 118 and the response system 130. In yet another implementation, the input/output circuit 118 includes machine-readable media for facilitating the exchange of information between the input/output device and the response system 130. In yet another implementation, the input/output circuit 118 includes any combination of hardware components, communication circuitry, and machine-readable media.

In some implementations, the input/output circuit 118 includes suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or other user interaction purposes. As such, the input/output circuit 118 can provide an interface for the user to interact with various applications stored on the client device 110. For example, the input/output circuit 118 includes a keyboard, a keypad, a mouse, joystick, a touch screen, a microphone, a haptic sensor, a car sensor, an IoT sensor, a biometric sensor, an accelerometer sensor, a virtual reality headset, smart glasses, smart headsets, and the like. As another example, input/output circuit 118, can include, but is not limited to, a television monitor, a computer monitor, a printer, a facsimile, a speaker, and so on. As used herein, virtual reality, augmented reality, and mixed reality can at least one (e.g., each) be used interchangeably yet refer to any kind of extended reality, including virtual reality, augmented reality, and mixed reality.

In some implementations, input/output circuit 118 of the client device 110 can receive user input from a user (e.g., via sensors, or any other input/output devices/ports described herein). A user input can be a plurality of inputs, including by not limited to, a gesture (e.g., a flick of client device 110, a shake of client device 110, a user-defined custom gesture (e.g., utilizing an API), biological data (e.g., stress level, heart rate, hand geometry, facial geometry, psyche, and so on) and/or behavioral data (e.g., haptic feedback, gesture, speech pattern, movement pattern (e.g., hand, food, arm, facial, iris, and so on), or combination thereof, etc. In some implementations, one or more user inputs can be utilized to perform various actions on client device 110.

For example, a user can use a gesture, such as a flick or a shake, to quickly invoke an incident response through the response system 130 from their client device 110. With the use of biological and behavioral data, a user could trigger an incident response, access the vendor marketplace, or recall proof of state using custom-defined gestures via an API with input/output circuit 118. The drag and drop file tokenization feature can also be activated by a gesture, allowing a user to seamlessly tokenize files and secure them on the blockchain with a simple motion or touch on their client device 110.

Input/output circuit 118 can exchange and transmit data information, via network 120, to all the devices described herein. In various implementations, input/output circuit 118 transmits data via network 120. Input/output circuit 118 can confirm the transmission of data. For example, input/output circuit 118 can transmit requests and/or information to response system 130 based on selecting one or more actionable items within the interfaces and dashboards described herein. In another example, input/output circuit 118 can transmit requests and/or information to third party devices 150 operated one or more vendors. In various implementations, input/output circuit 118 can transmit data periodically. For example, input/output circuit 118 can transmit data at a predefined time. As another example, input/output circuit 118 can transmit data on an interval (e.g., every ten minutes, every ten hours, etc.).

The third party device 150 includes application 152, library 154, interface circuit 156, and input/output circuit 158. The application 152, library 154, interface circuit 156, and input/output circuit 158 can function substantially similar to and include the same or similar components as the components of client device 110, such as application 112, library 114, interface circuit 116, and input/output circuit 118, described above. As such, it should be understood that the description of the client device 110, such as application 112, library 114, interface circuit 116, and input/output circuit 118 of the client device 110 provided above can be similarly applied to the application 152, library 154, interface circuit 156, and input/output circuit 158 of the third party device 150. However, instead of a user of a company or institution operations the third party device 150, a vendor or providers (e.g., goods or services) operates the third party device 150.

The response system 130 can include a logic device, which can be a computing device equipped with a processing circuit that runs instructions stored in a memory device to perform various operations. The processing circuit can be made up of various components such as a microprocessor, an ASIC, or an FPGA, and the memory device can be any type of storage or transmission device capable of providing program instructions. The instructions can include code from various programming languages commonly used in the industry, such as high-level programming languages, web development languages, and systems programming languages. The response system 130 can also include one or more databases for storing data and an interface, such as a content management circuit 135, that receives and provides data to other systems and devices on the network 120.

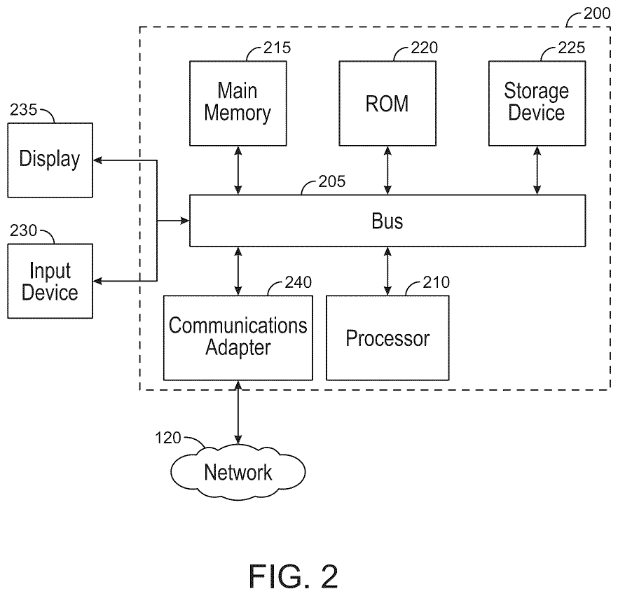

The response system 130 can be run or otherwise be executed on one or more processors of a computing device, such as those described below in FIG. 2. In broad overview, the response system 130 can include a processing circuit 132, a processor 133, memory 134, a content management circuit 135, an analysis circuit 136, a database 140, and a user dataset 142. The interface and dashboards generated by content management circuit 135 can be provided to the client devices 110 and third party devices 150. Generally, the interfaces and dashboards can be rendered at the client devices 110 and/or third party devices 150. The content management circuit 135 can include a plurality of interfaces and properties. The interfaces and dashboards can execute at the response system 130, the client device 110, the third party devices 150, or a combination of the three to provide the interfaces and dashboards. In some implementations, the interfaces and dashboards generated and formatted by content management circuit 135 can be provided within a web browser. In another implementation, the content management circuit 135 executes to provide the interfaces and dashboards at the client devices 110 and third party devices 150 without utilizing the web browser.

The response system 130 can be a server, distributed processing cluster, cloud processing system, or any other computing device. Response system 130 can include or execute at least one computer program or at least one script. In some implementations, response system 130 includes combinations of software and hardware, such as one or more processors configured to execute one or more scripts. Response system 130 is shown to include database 140 and processing circuit 132. Database 140 can store received data. For example, the database 140 can include data structures for storing information such as, but not limited to, the front end information, interfaces, dashboards, incident information, claim information, user information, vendor information, contact information, invoices, a blockchain ledger, etc. The database 140 can be part of the response system 130, or a separate component that the response system 130, the client device 110, or the third party device 150 can access via the network 120. The database 140 can also be distributed throughout system 100. For example, the database 140 can include multiple databases associated with the response system 130, the client device 110, or the third party device 150, or all three. Database 140 can include one or more storage mediums. The storage mediums can include but are not limited to magnetic storage, optical storage, flash storage, and/or RAM. Response system 130 can implement or facilitate various APIs to perform database functions (e.g., managing data stored in database 140). The APIs can be but are not limited to SQL, ODBC, JDBC, NOSQL and/or any other data storage and manipulation API.

Processing circuit 132 includes processor 133 and memory 134. Memory 134 can have instructions stored thereon that, when executed by processor 133, cause processing circuit 132 to perform the various operations described herein. The operations described herein can be implemented using software, hardware, or a combination thereof. Processor 133 can include a microprocessor, ASIC, FPGA, etc., or combinations thereof. In many implementations, processor 133 can be a multi-core processor or an array of processors. Memory 134 can include, but is not limited to, electronic, optical, magnetic, or any other storage devices capable of providing processor 133 with program instructions. Memory 134 can include a floppy disk, CD-ROM, DVD, magnetic disk, memory chip, ROM, RAM, EEPROM, EPROM, flash memory, optical media, or any other suitable memory from which processor 133 can read instructions. The instructions can include code from any suitable computer programming language.

The data sources 160 can provide data to the response system 130. In some implementations, the data sources 160 can be structured to collect data from other devices on network 120 (e.g., client devices 110 and/or third party devices 150) and relay the collected data to the response system 130. In one example, a user and/or entity can have a server and database (e.g., proxy, enterprise resource planning (ERP) system) that stores network information associated with the user and/or entity. In this example, the response system 130 can request data associated with various data stored in the data source (e.g., data sources 160) of the user or entity. For example, in some implementations, the data sources 160 can host or otherwise support a search or discovery engine for Internet-connected devices. The search or discovery engine can provide data, via the data acquisition engine 180, to the response system 130. In some implementations, the data sources 160 can be scanned to provide additional data. The additional data can include newsfeed data (e.g., articles, breaking news, and television content), social media data (e.g., Facebook, Twitter, Snapchat, and TikTok), geolocation data of users on the Internet (e.g., GPS, triangulation, and IP addresses), governmental databases, generative artificial intelligence (GAI) data, and/or any other intelligence data associated with the entity of interest.

The system 100 can include a data acquisition engine 180. In various implementations, the response system 130 can be communicatively and operatively coupled to the data acquisition engine 180. The data acquisition engine 180 can include one or more processing circuits configured to execute various instructions. In various implementations, the data acquisition engine 180 can be configured to facilitate communication (e.g., via network 120) between the response system 130 and systems described herein. The facilitation of communication can be implemented as an application programming interface (API) (e.g., REST API, Web API, customized API), batch files, and/or queries. In various implementations, the data acquisition engine 180 can also be configured to control access to resources of the response system 130 and database 140.

The API can be used by the data acquisition engine 180 and/or computing systems to exchange data and make function calls in a structured format. The API can be configured to specify an appropriate communication protocol using a suitable electronic data interchange (EDI) standard or technology. The EDI standard (e.g., messaging standard and/or supporting technology) can include any of a SQL data set, a protocol buffer message stream, an instantiated class implemented in a suitable object-oriented programming language (e.g., Java, Ruby, C#), an XML file, a text file, an Excel file, a web service message in a suitable web service message format (e.g., representational state transfer (REST), simple object access protocol (SOAP), web service definition language (WSDL), JavaScript object notation (JSON), XML remote procedure call (XML RPC)). As such, EDI messages can be implemented in any of the above or using another suitable technology.

In some implementations, data is exchanged by components of the data acquisition engine 180 using web services. Where data is exchanged using an API configured to exchange web service messages, some or all components of the computing environment can include or can be associated with (e.g., as a client computing device) one or more web service node(s). The web service can be identifiable using a unique network address, such as an IP address, and/or a URL. Some or all components of the computing environment can include circuits structured to access and exchange data using one or more remote procedure call protocols, such as Java remote method invocation (RMI), Windows distributed component object model (DCOM). The web service node(s) can include a web service library including callable code functions. The callable code functions can be structured according to a predefined format, which can include a service name (interface name), an operation name (e.g., read, write, initialize a class), operation input parameters and data type, operation return values and data type, service message format, etc. In some implementations, the callable code functions can include an API structured to access on-demand and/or receive a data feed from a search or discovery engine for Internet-connected devices. Further examples of callable code functions are provided further herein as implemented in various components of the data acquisition engine 180.

The data sources 160 can provide data to the response system 130 based on the data acquisition engine 180 scanning the Internet (e.g., various data sources and/or data feeds) for data associated with a user or entity (e.g., vendor, insurer). That is, the data acquisition engine 180 can hold (e.g., in non-transitory memory, in cache memory, and/or in database 140) the executables for performing the scanning activities on the data sources 160. Further, the response system 130 can initiate the scanning operations. For example, the response system 130 can initiate the scanning operations by retrieving domain identifiers or other user/entity identifiers from a computer-implemented DBMS or queue. In another example, a user can affirmatively request a particular resource (e.g., domain or another entity identifier) to be scanned, which triggers the operations. In various implementations, the data sources 160 can facilitate the communication of data between the client devices 110 and third party devices 150, such that the data sources 160 receive data (e.g., over network 120) from the client devices 110 and third party devices 150 before sending the data other systems described herein (e.g., response system 130). In other implementations and as described herein, the client devices 110 and third party devices 150, and the data sources 160 can send data directly, over the network 120, to any system described herein and the data sources 160 can provide information not provided by any of the client devices 110 and third party devices 150.

As used herein, the terms “scan” and “scanning” refer to and encompass various data collection operations, which can include executing and/or causing to be executed any of the following operations: query(ies), search(es), web crawl(s), interface engine operations structured to allow the data acquisition engine 180 to activate an appropriate system interface to continuously or periodically receive inbound data, document search(es), dataset search(es), retrieval from internal systems of previously received data, etc. These operations can be executed on-demand and/or on a scheduled basis. In some implementations, these operations include receiving data (e.g., device connectivity data, IP traffic data) in response to requesting the data (e.g., data “pull” operations). In some implementations, these operations include receiving data without previously requesting the data (e.g., data “push” operations). In some implementations, the data “push” operations are supported by the interface engine operations.

One of skill will appreciate that data received as a result of performing or causing scanning operations to be performed can include data that has various properties indicative of device properties, hardware, firmware, software, configuration information, and/or IP traffic data. For example, in an implementation, a device connectivity data set can be received. In some implementations, device connectivity data can include data obtained from a search or discovery engine for Internet-connected devices which can include a third party product (e.g., Shodan), a proprietary product, or a combination thereof. Device connectivity data can include structured or unstructured data.

Various properties (sometimes referred to as “attributes”) (e.g., records, delimited values, values that follow particular pre-determined character-based labels) can be parsed from the device connectivity data. The properties can include device-related data and/or IP traffic data. Device-related data can encompass data related to software, firmware, and/or hardware technology deployed to, included in, or coupled to a particular device. Device-related data can include IP address(es), software information, operating system information, component designation (e.g., router, web server), version information, port number(s), timestamp data, host name, etc. IP traffic data can include items included in packets, as described elsewhere herein. Further, IP traffic data included in the device connectivity data can include various supplemental information (e.g., In some implementations, metadata associated with packets), such as host name, organization, Internet Service Provider information, country, city, communication protocol information, and Autonomous System Number (ASN) or similar identifier for a group of devices using a particular defined external routing policy. In some implementations, device connectivity data can be determined at least in part based on banner data exposed by the respective source vendor or insurer. For example, device connectivity data can include metadata about software running on a particular device of a source entity.

In various implementations, vendors and users can utilize Internet-wide scanning tools (e.g., port scanning, network scanning, vulnerability scanning, Internet Control Message Protocol (ICMP) scanning, TCP scanning, UDP scanning, semi-structured and unstructured parsing of publicly available data sources) for collecting data (e.g., states and performance of companies, corporations, users). Further, in addition to this data, other data collected and fused with the data obtained via scanning can be newsfeed data (e.g., articles, breaking news, television), social media data (e.g., Facebook, Twitter, Snapchat, TikTok), geolocation data of users on the Internet (e.g., GPS, triangulation, IP addresses), governmental databases, and any other data associated with the user or entity (e.g., vendor or insurer), their capabilities, configurations, cyber insurance policy, coverage, attestations, questionnaires and overall state of aforementioned attributes.

In some implementations, scanning occurs in real-time such that the data acquisition engine 180 continuously scans the data sources 160 for data associated with a vendor or user (e.g., real-time states of vendors or users, real-time threats, real-time performance). In various implementations, scanning can occur in periodic increments such that the data acquisition engine 180 can scan the Internet for data associated with the vendor or user periodically (e.g., every minute, every hour, every day, every week, and any other increment of time.) In some implementations, data acquisition engine 180 can receive feeds from be various data aggregating systems that collect data associated with vendors or users. For example, the response system 130 can receive vendor or user data from the data sources 160, via the network 120 and data acquisition engine 180. The information collected by the data acquisition engine 180 can be stored in database 140. In some implementations, an entity (e.g., company, vendor, insurer, any service or goods provider, etc.) can submit data to response system 130 and provide information about their products or services, pricing, capabilities, statuses, etc., which can be stored in database 140.

Memory 134 can include analysis circuit 136. The analysis circuit 136 can be configured to perform data fusion operations, including operations to generate and/or aggregate various data structures stored in database 140, which can have been acquired as a result of scanning operations or via another EDI process. For example, the analysis circuit 136 can be configured to aggregate entity data stored in the database 140. The entity data can be a data structure associated with an entity and include various data from a plurality of data channels. In some implementations, the analysis circuit 136 can be configured to aggregate line-of-business data stored in the database 140. The line-of-business data can be a data structure associated with a plurality of line-of-business of an entity and indicate various data from a plurality of data channels based on line-of-business (e.g., information technology (IT), legal, marketing and sales, operations, finance and accounting).

The analysis circuit 136 can also be configured to receive a plurality of user and entity data. In some implementations, the analysis circuit 136 can be configured to receive data regarding the network 120 as a whole (e.g., stored in database 140) instead of data specific to particular users or entities. The received data that the analysis circuit 136 receives can be data that response system 130 aggregates and/or data that the response system 130 receives from the data sources 160 and/or any other system described herein. As previously described, the response system 130 can be configured to receive information regarding various entities and users on the network 120 (e.g., via device connectivity data). Further, the response system 130 can be configured to receive and/or collect information regarding interactions that a particular user or entity has on the network 120 (e.g., via IP traffic data). Further, the response system 130 can be configured to receive and/or collect additional information. Accordingly, the received or collected information can be stored as data in database 140. In various implementations, the database 140 can include user and entity profiles.

The response system 130 can be configured to electronically transmit information and/or notifications relating to various metrics, dashboards (e.g., graphical user interfaces) and/or models it determines, analyzes, fuses, generates, or fits to user data, entity data, and/or other data. This can allow a user of a particular one of the client devices 110 and third party devices 150 to review the various metrics, dashboards, or models which the response system 130 determines. Further, the response system 130 can use the various metrics to identify remediation actions for users and entities. The analysis circuit 136 implements data fusion operations of the response system 130. In various implementations, the analysis circuit 136 can be configured to receive a plurality of data (e.g., user and entity data) from a plurality of data sources (e.g., database 140, client devices 110, third party devices 150, data sources 160) via one or more data channels (e.g., over network 120). At least one (e.g., each) data channel can include a network connection (e.g., wired, wireless, cloud) between the data sources and the response system 130.

In some implementations, the analysis circuit 136 can also be configured to collect a plurality of data from a particular data source or from a plurality of data sources based on electronically transmitting requests to the data sources via the plurality of data channels, managed and routed to a particular data channel by the data acquisition engine 180. A request submitted via the data acquisition engine 180 can include a request for scanning publicly available information exposed by a user or entity. In some implementations, the request submitted via the data acquisition engine 180 can include information regarding access-controlled data being requested from the user or entity. In such cases, the request can include trust verification information sufficient to be authenticated by the target entity (e.g., multi-factor authentication (MFA) information, account login information, request identification number, a pin, certificate information, a private key of a public/private key pair). This information should be sufficient to allow the target entity to verify that a request is valid.

In various implementations, the analysis circuit 136 can be configured to initiate a scan, via the data acquisition engine 180, for a plurality of data from a plurality of data sources based on analyzing device connectivity data, vendor information, scheduling information (e.g., team members), network properties (e.g., status, nodes, element-level (sub-document level), group-level, network-level, size, density, connectedness, clustering, attributes) and/or network information (e.g., IP traffic, domain traffic, subdomain traffic, connected devices, software, infrastructure, bandwidth) of a target computer network environment and/or environments of the entity or associated with the entity. The operations to fuse various properties of data returned via the scan can include a number of different actions, which can parse device connectivity data, packet segmentation, predictive analytics, cross-referencing to data regarding known vulnerabilities, and/or searching data regarding application security history. These operations can be performed to identify costs of vendors, services offered, hosts, ports, and services in a target computer network environment. The target computer network environment can be identified by a unique identifier, such as a domain identifier (e.g., a top-level domain (TLD) identifier, a subdomain identifier, a URL string pointing to a particular directory), an IP address, a subnet, etc. Further, the target computer network environment can be defined with more granularity to encompass a particular component (e.g., an entity identified by an IP address, software/applications/operating systems/exposed API functions associated with a particular port number, IP address, subnet, domain identifier). In some implementations, one or more particular target computer network environments can be linked to an entity profile (e.g., in the database 140). In one example, scanning can include parsing out packet and/or device connectivity data properties that can indicate available UDP and TCP network services running on the target computer network environment. In another example, scanning can include parsing out packet and/or device connectivity data that indicates the operating systems (OS) in use on the target computer network environment.

In various implementations, vendor information can be determined based accessing a vendor device (e.g., third party device 150) or website of the vendor to collect vendor information (e.g., via an API call). In various implementations, vulnerabilities and incidents can be determined based on any software feature. hardware feature, network feature, or combination of these, which could make an entity vulnerable to cyber threats, incidents, such as hacking activities, data breaches, and cyberattacks. In turn, cyber-threats (sometimes referred to herein as “cyber-indents” or “incidents”) increase the probability of cyber-incidents. Accordingly, a vulnerability or incident can be a weakness that could be exploited to gain unauthorized access to or perform unauthorized actions in a computer network environment (e.g., system 100). For example, obsolete computing devices and/or obsolete software can present vulnerabilities and/or threats in a computer network environment. In another example, certain network frameworks can present vulnerabilities and/or threats in a computer network environment. In yet another example, business practices of an entity can present vulnerabilities and/or threats in a computer network environment. In yet another example, published content on the Internet can present vulnerabilities in a computer network environment. In yet another example, third party computing devices and/or software can present vulnerabilities and/or threats in a computer network environment. Accordingly, as shown, all devices (e.g., servers, computers, any infrastructure), all data (e.g., network information, vendor data, network traffic, user data, certificate data, public and/or private content), all practices (e.g., business practices, security protocols), all software (e.g., frameworks, protocols), and any relationship an entity has with another entity can present vulnerabilities and/or threats in a computer network environment that could lead to one or more cyber-incidents.

In broad view, the analysis circuit 136 can also be configured to receive company and vendor information regarding the company/vendor. In some implementations, the analysis circuit 136 can receive a registration request and register user accounts (e.g., accounts). For example, a user of library 114 can register their user account with a client device such that the client device 110 can execute the library 114 and perform various actions. Registering a client device 110 or user (or vendor) can include, but not limited to, providing various identifying information (e.g., device name, geolocation, identifier, etc.), platform designations (e.g., IOS, Android, WebOS, BlackBerry OS, etc.), user actions (e.g., activation gesture, haptic, biometric, etc.), authentication information (e.g., username, password, two-step criteria, security questions, address information, etc.). Once the analysis circuit 136 approves a registration request, the information associated with the request can be stored in database 140. Additionally, a notification can be transmitted to the client device 110 indicating the user, vendor, or client device 110 (or third party device 150) is registered and can utilize the dashboards to perform actions associated with one or more applications.

In various implementations, analysis circuit 136 performs statistical operations on received data to produce statistical measurements describing the received data. For example, analysis circuit 136 can determine capabilities of individuals, objectives, cost estimates, etc. In various implementations, the statistical operations can be calculated based on performing various statistical operations and analysis. In some implementations, received data and previously collected data stored in database 140 can be used to train a machine-learning model. That is, predictions regarding vulnerabilities and incidents could be based on artificial intelligence or a machine-learning model. For example, a first machine-learning model can be trained to identify particular incidents and output a prediction. In this example, a second machine-learning model can be trained to identify remediation actions based on incident. In various implementations, machine learning algorithms can include, but are not limited to, a neural network, convolutional neural network, recurrent neural network, linear regression model, and sparse vector machine). The various computing systems/devices described herein can input various data (e.g., event logs, debugging information and so on) into the machine learning model, and receive an output from the model indicating a particular action to perform. In some implementations, analysis circuit 136 can be configured to perform source testing on one or more networks. Source testing on one or more networks can include performing various test plans. During the source testing, various malfunctions and exceptions can be identified. Additionally, the network can be identified such that the testing occurs on a designated network (e.g., or multiple designated content networks).

Memory 134 also includes content management circuit 135. The content management circuit 135 can be configured to generate content for displaying to users and vendors. The content can be selected from among various resources (e.g., webpages, applications). The content management circuit 135 is also structured to provide content (e.g., via a graphical user interface (GUI)) to the client devices 110 and/or third party devices 150), over the network 120, for display within the resources. For example, in various implementations, a claim dashboard or incident response dashboard can be integrated in a mobile application or computing application or provided via an Internet browser. The content from which the content management circuit 135 selects can be provided by the response system 130 via the network 120 to one or more client devices 110 and/or third party devices 150. In such implementations, the content management circuit 135 can determine content to be generated and published in one or more content interfaces of resources (e.g., webpages, applications).

The content management circuit 135 can be configured to interact with a database management system or data storage vault, where clients can obtain or store information. Clients can use queries in a formal query language, inter-process communication architecture, natural language or semantic queries to obtain data from the DBMS. In some implementations, one or more clients obtain data from the DBMS using queries in a custom query language such as a Visualization API Query Language. In some implementations, the content management circuit 135 can be configured to provide one or more customized dashboards (e.g., stored in database 140) to one or more computing devices (e.g., client devices 110, third party devices 150) for presentation. That is, the provided customized dashboards (also referred to herein as “customized interface”) can execute and/or be displayed at the computing devices described herein. In some implementations, the customized dashboards can be provided within a web browser or installed application. In some implementations, the customized dashboards can include PDF files. In some implementations, the customized dashboards can be provided via email. According to various implementations, the customized dashboards can be provided on-demand or as part of push notifications.

In various implementations, the content management circuit 135 executes operations to provide the customized dashboards to the client devices 110 and third party devices 150, without utilizing the web browser. In various implementations, the customized dashboards can be provided within an application (e.g., mobile application, desktop application). The dashboard from which the content management circuit 135 generates can be provided to one or more users or entities, via the network 120. In some implementations, the content management circuit 135 can select dashboards and/or interfaces associated with the user or entity to be displayed on the client devices 110 or third party devices 150. Additional details regarding the dashboards and the content presented are described in detail.

In an example implementation, an application executed by the client devices 110 and/or third party devices 150 can cause the web browser to display on a monitor or screen of the computing devices. For example, the user can connect (e.g., via the network 120) to a website structured to host the customized dashboards. In various implementations, hosting the customized dashboard can include infrastructure such as host devices (e.g., computing device) and a collection of files defining the customized dashboard and stored on the host devices (e.g., in a database). The web browser operates by receiving input of a uniform resource locator (URL) into a field from an input device (e.g., a pointing device, a keyboard, a touchscreen, mobile phone, or another form of input device). In response, the content management circuit 135 executing the web browser can request data such as from the database 140. The web browser can include other functionalities, such as navigational controls (e.g., backward and forward buttons, home buttons, other navigational buttons or items). The content management circuit 135 can execute operations of the database 140 (or provide data from the database 140 to the client devices 110, and/or third party devices 150 for execution) to provide the customized dashboards at the client devices 110 and/or third party devices 150.

In some implementations, the content management circuit 135 can include both a client-side application and a server-side application. For example, a content management circuit 135 can be written in one or more general purpose programming languages and can be executed by client devices 110 and/or third party devices 150. The server-side content management circuit 135 can be written, for example, in one or more general purpose programming, or a concurrent programming language, and can be executed by the response system 130. The content management circuit 135 can be configured to generate a plurality of customized dashboards and their properties. The content management circuit 135 can generate customized user-interactive dashboards for one or more users and entities, such as the client device 110 and third party devices 150, based on data received, collected, and/or aggregated from the analysis circuit 136, any other computing device described herein, and/or any database described herein (e.g., database 140).

The generated dashboards can include various data (e.g., data stored in database 140 and/or data sources 160) associated with one or more entities including scheduling information, profile information, cybersecurity risk and/or vulnerabilities cybersecurity vulnerabilities (e.g., malware, unpatched security vulnerabilities, expired certificates, hidden backdoor programs, super-user and/or admin account privileges, remote access policies, other policies and procedures, type and/or lack of encryption, type and/or lack of network segmentation, common injection and parameter manipulation, automated running of scripts, unknown security bugs in software or programming interfaces, social engineering, and IoT devices), insurer and vendor information (e.g., policies, contracts, products, services, underwriting, limitations), incident information, cyberattack information (e.g., phishing attacks, malware attacks, web attacks, and artificial intelligence (AI)-powered attacks), remediation items, remediation actions/executables, security reports, data analytics, graphs, charts, historical data, historical trends, vulnerabilities, summaries, help information, domain information, and/or subdomain information. As used herein, a “cyber-incident” can be any incident where a party (e.g., user, individual, institution, company) gains unauthorized access to perform unauthorized actions in a computer network environment. The database 140 can also include data structures for storing information such as system definitions for customized dashboards generated by content management circuit 135, animated or other content items, actionable objects, graphical user interface data, and/or additional information.

The analysis circuit 136 can be configured to determine organization incident readiness. Readiness is the process an organization follows to prepare for a cyber incident before it happens. This includes entering information that can be used at the initiation of an incident by incident response teams and breach counsel. Readiness levels are calculated by binary completion of the n tasks that are included in the readiness activities of the organization. An organization with 10 readiness steps and 5 completed shows as 50%. In some implementations, determining organization incident readiness can include integrating readiness (e.g., insurer data and other vendor data) into third party devices 150. For example, the insurer data of an insurer of the company can be recorded and stored at a third party device 150. In various implementations, determining organization incident readiness can include the analysis circuit determining organization capabilities, limitations, cyber threats, and focus associated with cyber threats. Additionally, organization incident readiness can be provided to incident response providers (e.g., security providers, firmware providers, software providers, infostructure providers). The analysis circuit 136 can also be configured to automatically route incidents and claims to vendors associated with a company or user (e.g., client device 110) and in turn contracting and activating an incident response. In some implementations, a response plan can be submitted by a company and the analysis circuit 136 can decompose and analyze the response plan to determine actionable tasks and activities to complete (e.g., by the company or after contracting with a vendor).

In various implementations, the determined organization incident readiness can be stored (e.g., by the analysis circuit 136) as a block in a blockchain (or on a ledger) that can metadata identifying the readiness including, but not limited to, a time stamp, proof of date, and artifacts. In various implementations, the data regarding key milestones (e.g., capabilities pre-incident, what happened after the incident occurred, root cause, recoding) can be stored on a blockchain (e.g., such that it is immutable). In particular, key milestones can be traceable and linkable within a blockchain (or ledger) such that issues can be identified, actionable tasks can be tracked, work is routed to vendors (e.g., third party device 150), and proof of resolution is recorded. In some implementations, database 140 can include a plurality of ledgers or blockchains and the database 140 can be a node of a plurality of nodes on a ledger or blockchain. It should be understood that the various data and information described herein can be implemented on a blockchain. For example, the blockchain can be used to provide for irrefutable proof in a data set of the data, locations, capabilities, configurations, that were in place prior to an incident. In another example, the block can be used to link the incident occurrence with what worked (e.g., effective in preventing an incident) and what did not work (e.g., vulnerability that led to the incident). For example, the irrefutable permanent ledgers (or blockchain) can be used by users at points in the process where they wish to record proofs on chain. This can include configurations, capabilities, assets, policies, threats, actors, claims, incident reports, cyber threat intelligence artifacts, and any other state-based attribute that needs to be recorded and can be shared with others to irrefutably prove that the state of that attribute was “x” at time “t”. Combinations of attributes for different data, assets, configurations, capabilities, are collected and rolled up to show if any elements have changed through the use of Merkel Trees, allowing a check of the top-most hash of the combination of downstream values facilitating a single checkpoint to determine if any other elements and configurations, combinations of parameters is the same or if they have changed.

In various implementations, the analysis circuit 136 can intake potential or current incidents based on an embedded widget on remote web sites or within remote web applications. This allows an incident response provider or vendor (sometimes referred to herein as “IR providers” or IR vendors”) the ability to seamlessly intake incident response requests for assistance from their web site or one of their sales channel partner sites and have it load into the incident intake process within responder. In turn, an embedded widget could be communicably coupled to the analysis circuit 136 (e.g., via network 120) to allow the analysis circuit to start an incident response process (e.g., at proposal stage) and continue through a workflow to achieve response readiness based on pre-defined logic or rules. This rule mechanism can allow for the user to specify attributes, collection of attributes, order, and routing method for connecting inbound requests to those who are best-fit to execute on the requests. For example, when an inbound instance of an incident response can be routed to a claim manager based on pre-defined logic or rules, such as to route inbound cases to the IR provider that is active currently, or to the provider who specializes in ransomware extortion cases where the ransom exceeds 10 million, or to round-robin inbound cases among a set of panel IR providers, etc.

In some implementations, the analysis circuit 136 can facilities invoice processing within an incident response process across different insurers. Furthermore, throughout an incident response conditions can be modified, added, or removed to route tasks (or work) to different vendors or partners (e.g., third party device 150). In some implementations, the analysis circuit 136 can also be configured to collect incident submission data, normalize the data (e.g., based on historical data or trends), and automatically submit insurance claims based on the normalized data. Moreover, the analysis circuit 136 can connect the underlying root cause to the capability failure or procedural issue and have that data submitted with the insurance claim. For example, the analysis circuit 136 can connect underlying root cause back to the insurers underwriting questions. In various implementations, the analysis circuit 136 can integrate organization incident readiness into all related parties to a company. As such, the analysis circuit 136 can integrate incident response activation and collaborative across business, teams, insurers, etc. Further, the analysis circuit 136 can be configured to link the root cause of an incident to the capability failure or procedural issue and then link back the insurers underwriting questions.

The content management circuit 135 can also be configured to allow a user (e.g., of a company) to purchase and extended services via the generated dashboards. In some implementations, the content management circuit 135 allows the user (e.g., via a step through process) to integrate into technology and vendors to resolve issues (e.g., incidents) and/or prevent incidents in the future. For example, the dashboards can provide users integration points for incident response workflow management. As such, the content management circuit 135 can generate dashboards (and/or interfaces) on an application (e.g., application 112 or application 152) for purchasing products, insurances, and services. In particular, the generated dashboards can provide users of the application with a unified (or universal) view of tasks, activities, and progress/status tracking of incidents, claims, etc. The dashboards can also tie back to incident readiness and managing the incidents through resolution. The content management circuit 135 can also generate the dashboards to include collaboration tools (e.g., video calls, calendar, chats), and the dashboards can include real-time status tracking of policies, incidents, claims, insurers such that policy aligned tasks and status updated can be provide for incident responses and claims.

Referring now to FIG. 1B, a block diagram depicting a more detailed architecture of certain systems or devices of system 100. System 100 includes the data acquisition engine 180 and response system 130 described in detail with reference to FIG. 1A. However, it should be understood that the response system 130 also encompasses the capability to generate content and dashboards tailored for at least one (e.g., each) aspect of the response process, including the response, adapter, and designer components. These content and dashboards are generated by the content management circuit 135.

To illustrate further, the response system 130 facilitates the presentation of diverse information related to security and threats of an organization through the adapter dashboard and architecture. This facilitates an understanding of the security landscape and helps inform decision-making processes. Additionally, the dashboard functionality can be customized by the vendor and/or organization using the designer dashboard and architecture. This empowers them to tailor the visual representation of data, making it more intuitive and aligned with their requirements. Furthermore, the responder dashboard and architecture provided by the response system 130 allows the vendor and/or organization to effectively prepare for, track, and update incidents and readiness. This dashboard encompasses the entire incident response lifecycle, from the initial incident detection and response through to the final incident closure and claim submission. By leveraging the responder dashboard and architecture, the vendor and/or organization can facilitate smooth incident management, streamline processes, and facilitate efficient collaboration among stakeholders.

In the depicted architecture, both organizations and vendors operating the third party devices 150 or client devices 110 have the ability to store states 162 and indexes 163 within the library 154 (or library 114). In some implementations, these states 162 and indexes 163 can be determined based on data derived from various datasets, including the organization dataset 164, performance dataset 165, and vendor dataset 166.

In some implementations, the organization dataset 164 encompasses a wide range of information such as firmographics, data related to locations, assets, and capabilities of the third party or client organization. This dataset provides an understanding of the profile and resources of the organization. In some implementations, the performance dataset 165 includes diverse sets of data, including threat data, actor data, vector data, incident data, claim data, capability data, vendor data, organization data, and team member data. These performance-related datasets capture information for assessing the security posture, incident history, and overall operational performance of the organization. They facilitate effective monitoring, analysis, and decision-making in incident response activities. In some implementations, the vendor dataset 166 contains information related to offerings (cybersecurity protection plans), terms, team member data, configuration data, configuration state data, pricing data, detection data, alert data, incident data, and intelligence data. This dataset allows organizations to gain insights into the capabilities and services provided by vendors, facilitating informed decision-making when selecting and collaborating with vendors.

In general, the states 162 and indexes 163, derived from the datasets, are utilized as input by the data acquisition engine 180 (or analysis circuit 136) to output a security posture. In some implementations, the data acquisition engine 180 is configured to scan and perform data collection based on accessing vendor embedded applications 175, via ecosystem partner APIs 174. This facilitates integration with vendor systems, allowing for efficient retrieval and synchronization of relevant data. In the depicted architecture, the states 162 and indexes 163 improve the efficient operations of the response system 130. These states 162 and indexes 163 can stored within the library 154 (or library 114) and are determined based on data from various datasets, including the organization dataset 164, performance dataset 165, and vendor dataset 66.

In some implementations, the states 162 represent the current condition or status of the organization or vendor operating the third party 150 or client devices 110. They encapsulate information such as system configurations, security policies, incident response readiness, and other relevant parameters. By maintaining these states, the response system 130 can quickly access and reference the most up-to-date information about the environment of the organization or vendor. Additionally, in some implementations, the indexes 163 serve as pointers or references to data or resources within the library 154 (or library 114). They streamline the retrieval and access of information, ensuring efficient data processing and analysis. These indexes are designed to optimize search operations and allow access to relevant datasets, contributing to the overall responsiveness and effectiveness of the response system 130.

Accordingly, to verify the accuracy and currency of the states 162 and indexes 163, the data acquisition engine 180 can be configured to scan and collect data by interacting with the vendor embedded applications 175. The communication can occur through ecosystem partner APIs 174, establishing a connection between the response system 130 and the embedded applications 175 used by vendors. Through this communication, the data acquisition engine 180 can retrieve real-time (or near real-time) information from the systems of the vendor, including offerings, configurations, alerts, incidents, and other relevant data. In some implementations, the data acquisition engine 180 can utilize the retrieved data to update and synchronize the states 162 and indexes 163, providing that the response system 130 has the latest and accurate information to support incident response activities.

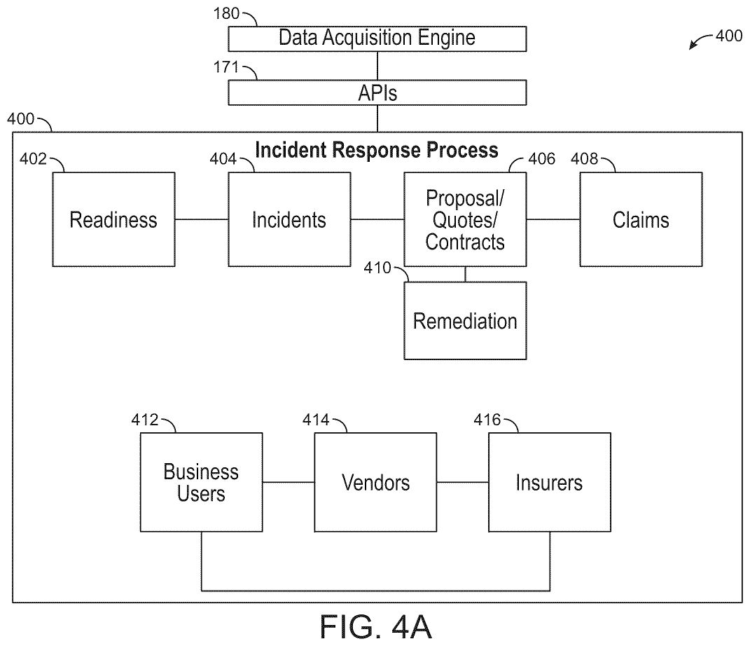

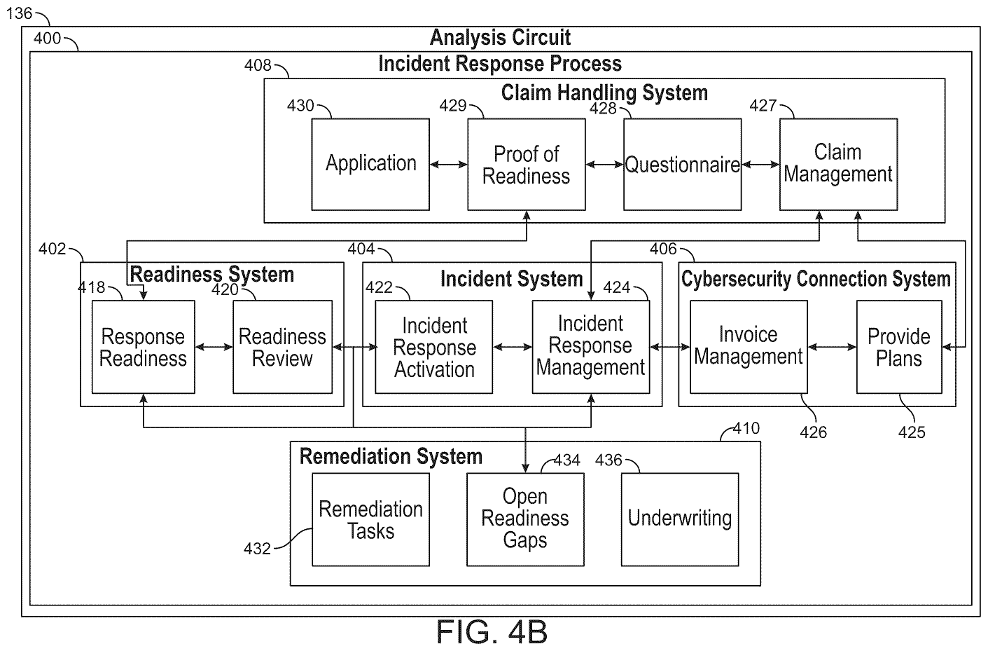

Expand further on states 162 and indexes 163, the data acquisition engine 180 can maintain the security posture of the organization. That is, the data acquisition engine 180 can actively check an API of the vendor for any changes in the configuration “State,” the data acquisition engine 180 that the security posture remains up to date and aligned with the evolving environment. By recording these configuration updates to the corresponding index, the data acquisition engine 180 and response system 130 establishes a view of the security landscape of the organization. This approach goes beyond static assessments and provides a dynamic and real-time perspective on the security posture of the organization. By linking the configuration data with real incident data and other relevant metadata, the response system 130 enhances the accuracy and actionability of the match, facilitating quick and effective response to potential threats. In various implementations, this continuous monitoring and adaptation of the security posture over time is provided and/or presented in a posture stream (as shown with reference to FIG. 4A), which captures and analyzes the evolving information. As new data points are gathered and recorded in the posture stream, the response system 130 can execute proactive incident response activities.

As used herein, a “security posture” refers to the current state and overall cybersecurity profile of an organization or vendor. It is determined based on various factors and information collected from entity data, including system configurations, security policies, incident response readiness, and/or other relevant parameters. In some implementations, the data acquisition engine 180 (or analysis circuit 136) scans and collects data from vendor embedded applications through ecosystem partner APIs, ensuring the accuracy and currency of the states and indexes used to represent the security posture. In various implementations, the analysis circuit 136 utilizes a distributed ledger to tokenize and broadcast the security posture, ensuring transparency and immutability. The analysis circuit 136 can also be configured to model the security posture and multiple security objectives to generate a set of cybersecurity attributes specific to the entity.

Furthermore, the data acquisition engine 180 is shown to gather data from blockchain 170 (e.g., ledgers storing various immutable information about entities, vendors, and/or corporations) via code 168 and smart contracts 169 that are executed by logic handling 167 (e.g., of the data acquisition engine 180). In some implementations, data acquisition engine 180 can communicate with response system 130 directly (e.g., via a wired or hard-wired connection) or via APIs 171. To allow user access and interaction with the dashboards and content generated by the response system 130, user access 172 is provided. Users, including organizations, vendors and/or entities, can access the dashboards and content through dedicated applications such as application 112 or application 152. These applications can be accessed through user devices, such as client device 110, or through third party devices 150.

Additionally, user access 172 to the dashboards and content can be provided to users (e.g., organizations, vendors, entities) via an application (e.g., application 112 or application 152) a user device (e.g., 110) and/or third party device 150. Additional, fewer, or different systems and devices can be used. It is important to note that the depicted system and devices are not exhaustive and/or additional, fewer, or different systems and devices can be employed depending on implementation requirements. The architecture can be tailored to suit the unique needs of organizations, vendors and/or entities, allowing for flexibility and customization in the deployment of the response system 130.

In addition to gathering data from the blockchain 170, the response system 130 can establish a communication channel with the blockchain 170. This communication allows the response system 130 to interact with the blockchain 170 in a secure and decentralized manner. By accessing the blockchain 170, the response system 130 can leverage its inherent properties of immutability, transparency and/or distributed consensus to enhance the integrity and reliability of incident-related data and information. Accordingly, the response system 130 can use blockchain 170 to record and verify incident data, maintain an auditable trail of actions and transactions and/or ensure the integrity of information throughout the incident response process.

It will be recognized that some or all of the figures are schematic representations for purposes of illustration. The figures are provided for the purpose of illustrating one or more implementations with the explicit understanding that they will not be used to limit the scope or the meaning of the claims.

Referring now to FIG. 2, a depiction of a computing system 200 is shown. The computing system 200 that can be used, for example, to implement a system 100, response system 130, client devices 110, third party devices 150, data sources 160, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information and/or instructions to be executed by the processor 210. Main memory 215 can also be used for storing position information, temporary variables, or other intermediate information during execution of instructions by the processor 210. The computing system 200 can further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 can be coupled via the bus 205 to a display 235, such as a liquid crystal display, or active matrix display, for displaying information to a user. An input device 230, such as a keyboard including alphanumeric and other keys, can be coupled to the bus 205 for communicating information and/or command selections to the processor 210. In another implementation, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some implementations, the computing system 200 can include a communications adapter 240, such as a networking adapter. Communications adapter 240 can be coupled to bus 205 and can be configured to facilitate communications with a computing or communications network 120 and/or other computing systems. In various illustrative implementations, any type of networking configuration can be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various implementations, the processes that effectuate illustrative implementations that are described herein can be achieved by the computing system 200 in response to the processor 210 executing an implementation of instructions contained in main memory 215. Such instructions can be read into main memory 215 from another computer-readable medium (e.g., CRM, non-transitory memory, etc.), such as the storage device 225. Execution of the implementation of instructions contained in main memory 215 causes the computing system 200 to perform the illustrative processes described herein. One or more processors in a multi-processing implementation can also be employed to execute the instructions contained in main memory 215. In alternative implementations, hard-wired circuitry can be used in place of or in combination with software instructions to implement illustrative implementations. Thus, implementations are not limited to any specific combination of hardware circuitry and software.

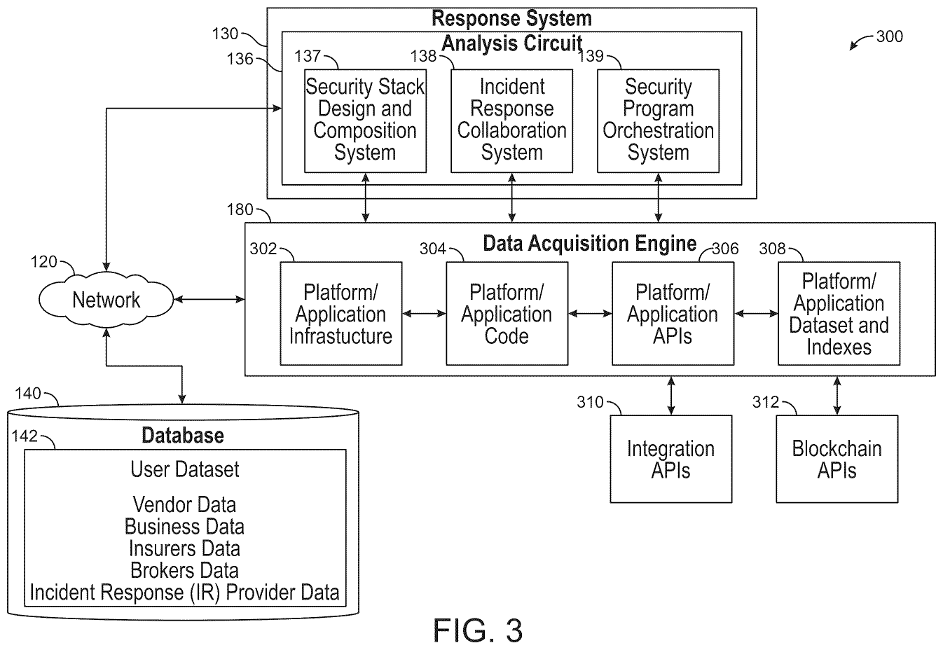

Referring now to FIG. 3, the data acquisition engine 180 and analysis circuit 136 of the response system 130, as depicted in FIG. 1A, depict an architecture 300 that facilitates efficient data acquisition and analysis. In some implementations, a user dataset 142, containing diverse data associated with different entities and users, can be securely stored in the database 140. The systems and devices illustrated in FIG. 3 communicate and exchange information over the network 120, which facilitates integration and collaboration among the components.

The data acquisition engine 180 encompasses various components designed to support the execution of application 112 and application 152. These components include, but are not limited to, the platform application infrastructure 302, platform application code 304, platform application APIs 306, and/or platform application datasets and indexes 308. Together, these elements form the support of the data acquisition engine 180, providing the structures and resources to ensure the efficient functioning of the applications. Additionally, integration APIs 310 and blockchain APIs 312 are integrated into the data acquisition engine 180, facilitating execution of API requests, data retrieval from blockchains, access to data sources 160, and/or integration with various vendors and third parties for streamlined data exchange. These integration APIs 310 facilitate the secure and reliable flow of information, ensuring the responsiveness and effectiveness of the data acquisition process.

The analysis circuit 136 is shown to include, but is not limited to, a security stack designer and composition (SSDC) system 137, an incident response collaboration (IRC) system 138, and/or a security program orchestration (SPO) system 139. For example, the SSDC system 137 walk users through identifying what data and computations are most important, where the data resides, what vendor product, service, and/or procedural capabilities are in place to prevent/detect/respond to cyber-attacks, and/or based on these visualized gaps, determine what to prioritize.

The analysis circuit 136 includes several components that improve the capabilities of the response system 130. One of these components is the security stack designer and composition (SSDC) system 137, which is configured to guide users through the process of identifying and addressing potential vulnerabilities and gaps in their security infrastructure. In some implementations, the SSDC system 137 provides users with a systematic approach to evaluate the significance of their data and computational processes, determining their criticality in the context of cybersecurity. By utilizing the SSDC system 137, users can gain insights into the locations where their data is stored and processed, allowing for understanding of potential security risks. In general, the SSDC system 137 employs various techniques to identify locations where data is stored and processed within infrastructure of the organization. In particular, by leveraging data mapping and inventory techniques that allows the SSDC system 137 to identify data repositories, databases, file systems, and/or other storage systems where data is stored. For example, the SSDC system 137 can analyze network traffic and data flows within a network of an organization to identify sources and destinations of data. By monitoring network communication and analyzing data packets, the SSDC system 137 can trace the path of data transmission and determine the endpoints where data is stored or processed.

Additionally, the SSDC system 137 can utilize data discovery and scanning mechanisms (e.g., using data acquisition engine 180) to identify data repositories within infrastructure of an organization. This can involve scanning file systems, databases, data storage 176, cloud storage 173, and/or other data repositories to identify the locations where sensitive or critical data resides. In some implementations, the SSDC system 137 can integrate with data classification tools or metadata repositories (e.g., data sources 160) to gather information about the nature and sensitivity of the data. By understanding the characteristics and classification of data, the SSDC system 137 can identify the specific locations where sensitive data is stored or processed. By combining these techniques, the SSDC system 137 can provide organizations with a view of the locations where data is stored and processed. It allows organizations to understand the data flow across their infrastructure and gain insights into the potential security risks associated with data storage and processing environments.

For example, an organization that utilizes both on-premises servers and cloud storage 173 for data storage. The SSDC system 137 can perform an analysis of the network of the organization and infrastructure, monitoring data flows between different systems. It would identify the on-premises servers, databases, and/or file systems where certain data is stored. Additionally, it would detect the cloud storage providers and cloud repositories where data is stored. By mapping out these locations, the SSDC system 137 provides the organization with a clear understanding of the data storage landscape and allows them to apply appropriate security measures to protect the data in at least one (e.g., each) location.

In some implementations, the SSDC system 137 facilitates an assessment of the existing vendor products, services, and/or procedural capabilities that are currently in place to prevent, detect, and/or respond to cyber-attacks. This evaluation allows users to identify any gaps or areas of improvement in their security stack. Through visualizations and analysis, the SSDC system 137 helps users prioritize their security measures based on identified gaps and vulnerabilities. By highlighting areas that require attention, the SSDC system 137 empowers organizations to allocate their resources effectively and take proactive steps to enhance their overall security posture. Moreover, the SSDC system 137 is designed to be dynamic and adaptable, accommodating the ever-evolving threat landscape and the changing needs of organizations. It provides a user-friendly interface that simplifies the complex task of security stack design and composition, making it accessible to users with varying levels of technical expertise.

In some implementations, the IRC system 138 can be configured to collect, aggregate, and/or generate data and data structure that can be presented via application 112 and application 152 and can be configured to determine level of importance related to matter pre-incidents, pre-associate to internal incident team members, cyber insurers, breach counsel, incident response firms, and/or security vendors to reduce the time it takes to activate and triage live incidents in the future. By leveraging the capabilities of the IRC system 138, organizations can efficiently manage incidents, reduce response times, and/or ensure collaboration among various stakeholders.

In some implementations, the IRC system 138 can collect and aggregate relevant data. This can include gathering information from various sources such as incident reports, security logs, system alerts, and/or user-generated data. The IRC system 138 employs data collection mechanisms to capture and centralize this information, ensuring that incident responders have a consolidated view of the incident landscape. The term “incident landscape” refers to the overall environment and context in which incidents occur within systems and networks of the organization. It encompasses the various factors, elements, and/or conditions that shape the occurrence and impact of security incidents. The incident landscape includes aspects such as the infrastructure of the organization, network architecture, data assets, applications, user activities, potential vulnerabilities, and/or threat landscape. Understanding the incident landscape is important for incident responders as it allows them to gain insights into the unique security challenges of the organization, identify potential attack vectors, assess risks, and/or develop effective incident response strategies. By mapping and analyzing the incident landscape using the IRC system 138, organizations can proactively strengthen their defenses, detect and respond to incidents promptly, and/or minimize the impact of security breaches.

In some implementations, the IRC system 138 can generate data structures that facilitate the organization and presentation of incident-related information. These data structures facilitate the categorization, classification, and/or correlation of incident data, making it easier for incident responders to analyze and make informed decisions. The IRC system 138 can employ various techniques such as data modeling, schema design, and/or indexing to create efficient and structured data representations. By leveraging the data and data structures generated by the IRC system 138, organizations can determine the level of importance related to pre-incident matters. This involves assessing the potential impact and severity of different incident scenarios, identifying assets and systems, and/or evaluating the potential risks and vulnerabilities. This information helps organizations prioritize their incident response efforts, allocating appropriate resources and attention to high-priority incidents.

In some implementations, the IRC system 138 also facilitates pre-association of internal incident team members, cyber insurers, breach counsel, incident response firms, and/or security vendors. By establishing these pre-associations, organizations can expedite the activation and triaging of live incidents in the future. The IRC system 138 can maintain a database of trusted contacts and partners, allowing incident responders to quickly engage the expertise and support when responding to incidents. This reduces response times and enhances the overall efficiency of technology and incident handling. Moreover, the IRC system 138 facilitates seamless collaboration among various stakeholders involved in incident response. It provides a unified platform where team members can share information, communicate, and/or coordinate their efforts. The IRC system 138 can include features such as real-time messaging, task assignment, document sharing, and/or incident status tracking, facilitating collaboration and ensuring that stakeholders are aligned and working towards a common goal.

The security program orchestration (SPO) system 139 can be configured to manage and adapt a security program of an organization to address changes in the security posture and cyber threats. In some implementations, it operates by receiving inputs that indicate the changing state of the security posture, which can come from various sources such as technical indicators or human-assisted inputs through APIs or social media sharing. These inputs provide valuable information about emerging threats, vulnerabilities, or changes in the security landscape of the organization. Once the SPO system 139 receives these inputs, it analyzes and evaluates the information to determine the adjustments and changes to be implemented in the security program. This involves identifying areas or aspects of the security program that can be modified, such as updating security policies, configurations, access controls, or implementing additional security measures.

The orchestration aspect of the SPO system 139 coordinates and manages the implementation of these changes across the various vendor tools and configurations of the organization. It ensures that the modifications are applied consistently and effectively across different security systems and technologies, minimizing any potential gaps or inconsistencies that could compromise the overall security posture of the organization. Furthermore, the SPO system 139 can be configured to automate and streamline the process of implementing security program changes, reducing the manual effort and potential errors associated with manual intervention. It can leverage automation capabilities to efficiently propagate changes to the appropriate security tools, configurations, and/or policies, ensuring that the security program of the organization remains up-to-date and aligned with the evolving threat landscape.

Referring to the interplay of the analysis circuit 136 generally, the SSDC system 137 designs and composes the security stack. It guides users through the process of identifying data, determining its storage locations, and/or understanding the vendor products, services, and/or procedural capabilities to protect against, detect, and/or respond to cyber-attacks. By visualizing the existing gaps and vulnerabilities, the SSDC system 137 helps organizations prioritize their security efforts and make informed decisions to strengthen their security posture. The IRC system 138 focuses on collaboration and information sharing during incident response. It collects, aggregates, and/or generates data to be presented via applications 112 and application 152. This system facilitates the efficient and effective communication among internal incident team members, cyber insurers, breach counsel, incident response firms, and/or security vendors. By pre-associating relevant parties and establishing clear lines of communication, the IRC system 138 reduces the time it takes to activate and triage live incidents in the future, leading to improved incident response capabilities. The SPO system 139, on the other hand, plays a crucial role in managing the security program of the organization. It receives inputs indicating changes in the security posture or emerging cyber threats, whether through technical indicators or human-assisted inputs. Leveraging these inputs, the SPO system 139 determines adjustments in the security program and orchestrates the implementation of those changes across the various vendor tools and configurations of the organization. This ensures that the security program remains up-to-date and aligned with the evolving threat landscape, enhancing the overall security resilience of the organization.

Accordingly, together, these three systems create a powerful synergy within the security ecosystem of the organization. The SSDC system 137 helps design a robust security infrastructure, the IRC system 138 facilitates collaboration and information sharing during incident response, and/or the SPO system 139 ensures the agility and adaptability of the security program of the organization. By working in tandem, these systems contribute to a proactive approach to improve security, empowering organizations to mitigate risks, respond effectively to incidents, and/or continuously improve their security posture in a rapidly evolving threat landscape.

Referring now to FIGS. 4A-4B, a method 400 for incident response preparedness and readiness through the final incident closure and claim submission. Response system 130 (e.g., in particular analysis circuit 136) or third party device 150 can be configured to perform method 400. Further, any computing device or system described herein can be configured to perform method 400. Additionally, the functions and features described in method 400 can be performed on an application. The data acquisition engine 180 can communicate using APIs with the response system 130.

In broad overview of the incident response process (e.g., method 400), the analysis circuit 136 can implement method 400. The analysis circuit can include various computing systems such as readiness system 402, incident system 404, cybersecurity connection system 406, claim handling system 408, and/or remediation system 410 can at least one (e.g., each) be systems configured to implement steps within an incident response process. In particular, FIG. 4B shows exemplary activities or tasks performed in at least one (e.g., each) of the steps shown in FIG. 4A. Throughout the steps and activities data and data structures can be utilized (e.g., aggregate, collected, or generated) including data of business users 412, vendors 414, and/or insurers 416. APIs 171 and API request and returns can be sent and received by the one or more processing circuits to perform method 400. Additionally, fewer, or different operations can be performed depending on the particular implementation. In some implementations, some or all operations of method 400 can be performed by one or more processors executing on one or more computing devices, systems, or servers. In various implementations, at least one (e.g., each) operation can be re-ordered, added, removed, or repeated.

Referring to method 400 in more detail, the analysis circuit 136 can execute a readiness step by readiness system 402, where a readiness analysis is executed. In some implementations, during the readiness step by readiness system 402, the analysis circuit 136 can perform response readiness 418 and readiness review 420. During the response readiness 418, the analysis circuit 136 evaluates the level of preparedness of the organization to effectively respond to incidents. It assesses various factors such as the availability of incident response teams, the adequacy of incident response plans and procedures, the integration of incident response tools and technologies, and/or the establishment of communication channels and protocols. This evaluation helps identify any gaps or deficiencies in the response capabilities of the organization, ensuring measures are taken to address them.

Simultaneously (or in a logical order), the readiness review 420 conducted by the analysis circuit 136 involves a thorough examination of the overall readiness of the organization for incident response. It encompasses a review of the incident response framework of the organization, including its policies, procedures, documentation, and/or training programs. The analysis circuit 136 examines whether the incident response framework of the organization aligns with industry best practices, regulatory requirements, and/or internal objectives. It also assesses the ability of the organization to effectively coordinate and collaborate with external stakeholders, such as incident response providers, cyber insurers, breach counsel, and/or other relevant parties.

In some implementations, the readiness system 402 is configured to access the entity data of an organization and utilize this information to determine the security posture of the organization. The readiness system 402 can take into account various parameters such as the cybersecurity policies of the entity, system configurations, incident response readiness, and/or others. It can then model the security posture along with a plurality of security objectives of the organization to generate a set of cybersecurity attributes.

The analysis circuit 136 can also execute an incident step by incident system 404, where an incident analysis is executed. In some implementations, during the incident step by incident system 404, the analysis circuit 136 can perform incident response activation 422 and incident response management 424. During the incident response activation 422, the analysis circuit 136 triggers the actions to initiate the incident response process. It activates the predefined incident response plans, procedures, and/or resources to ensure a swift and coordinated response. This includes notifying the incident response team, engaging relevant stakeholders and vendors, and/or initiating communication channels to exchange information.

In some implementations, the incident system is configured to maintain the relationship between the entity and third party cybersecurity providers. That is, it is configured to model a plurality of cybersecurity protection plans between the entity and a third party. In particular, it provides a framework for integrating third party cybersecurity solutions into the systems of the entity, ensuring that these solutions align with the security objectives of the entity and can effectively address its cybersecurity needs.

Simultaneously (or in a logical order), the analysis circuit 136 executes incident response management 424, which involves the ongoing coordination, monitoring, and/or control of the incident response activities. For example, it ensures that the incident response team follows the established procedures, communicates effectively, and/or collaborates seamlessly to address the incident. The analysis circuit 136 provides real-time insights and updates on the status of the incident, facilitates information sharing between team members, and/or tracks the progress of incident containment, eradication, and/or recovery efforts. By effectively managing the incident response, the analysis circuit 136 helps minimize the impact of the incident and accelerates the return to normal operations. By performing the incident response activation 422, it initiates a rapid and coordinated response, while the incident response management 424 ensures effective coordination and control throughout the incident response process. This incident analysis and response approach facilitated by the analysis circuit 136 allows organizations to mitigate the impact of incidents, minimize downtime, and/or protect their assets and operations.

The analysis circuit 136 can also execute a proposal/quote/contract step by cybersecurity connection system 406, where a proposal/quote/contract generation is executed. In some implementations, during the proposal/quote/contract step by cybersecurity connection system 406, the analysis circuit 136 can perform invoice management 426. During the proposal/quote/contract step by cybersecurity connection system 406, the analysis circuit 136 leverages its capabilities to generate proposals, quotes, and/or contracts. It takes into account the requirements, parameters, and/or preferences of the involved parties, ensuring that the proposed terms align with their respective needs. The analysis circuit 136 utilizes relevant data, such as pricing information, service level agreements (SLAs), and/or contractual obligations, to generate customized proposals and quotes. In some implementations, within the proposal/quote/contract step by cybersecurity connection system 406, the analysis circuit 136 incorporates invoice management 426 functionality. This feature facilitates the handling and tracking of invoices related to the proposed services or products. The analysis circuit 136 ensures that accurate and timely invoices are generated, shared, and/or managed throughout the invoicing process. It can include features such as invoice creation, validation, tracking, and/or payment processing, streamlining the financial aspect of the proposal/quote/contract lifecycle.

In some implementations, the cybersecurity connection system 406 can be configured to determine and provide (e.g., connect) a cybersecurity protection plan, utilizing one or more protection parameters. The plans can correspond to a new cybersecurity attribute that has been identified as to protect the organization. The cybersecurity connection system 406 makes this protection plan available to the entity, which can then choose to activate it based on its needs and acceptance of the terms of the plan.

The analysis circuit 136 can also execute a claims step by claim handling system 408, where claims are generated and tracked. In some implementations, during the claims step by claim handling system 408, the analysis circuit 136 can perform proof of readiness 429, provide an application 430 (e.g., application 112 and application 152), generate and provide questionnaires 428, and/or perform claim management 427. In some implementations, proof of readiness 429 involves gathering and presenting evidence to substantiate the readiness of the organization in handling incidents and responding effectively. The analysis circuit 136 collects relevant data, such as incident response plans, documentation, training records, and/or compliance certifications, to demonstrate the preparedness of the organization. Additionally, the analysis circuit 136 provides an application 430, such as application 112 and application 152, to facilitate the claims process. This application serves as a centralized platform where users can access and submit their claims. It streamlines the entire claims workflow, facilitating efficient communication, documentation, and/or tracking of the claims from initiation to resolution.

In some implementations, the claim handling system 408 is configured to monitor the environmental data of the entity while modeling at least one of the plurality of cybersecurity protection plans. That is, the claim handling system 408 monitors for any anomalies or signs of potential cybersecurity incidents in the environment of the entity. When it detects a new cybersecurity incident associated with the entity from the environmental data, it generates a report, allowing the entity or vendor to promptly respond to the incident and prevent further damage.

In some implementations, as part of the claims step by claim handling system 408, the analysis circuit 136 also generates and provides questionnaires 428. These questionnaires are designed to gather information related to the incident or the claim being submitted. They serve as a structured means to collect relevant details and documentation that are used for claim evaluation and processing. Moreover, the analysis circuit 136 encompasses claim management 427 functionalities during the claims step by claim handling system 408. This includes activities such as claim validation, documentation management, claim status tracking, and/or communication with involved parties. The analysis circuit 136 ensures that claims are effectively managed, providing transparency and visibility into the progress and status of at least one (e.g., each) claim.

The analysis circuit 136 can also execute a remediation step by remediation system 410, where remediations are executed. In some implementations, during the remediation step by remediation system 410, the analysis circuit 136 can perform remediation tasks 432, open readiness issues and gaps 434, and/or execute underwriting 436 (e.g., of organizations to determine what type of vendor plans, products, or services they can qualify for). The execution of remediation tasks 432 includes implementing actions or measures to mitigate vulnerabilities, resolve security gaps, and/or address any identified weaknesses in the security infrastructure of the organization. The analysis circuit 136 can provide guidance and instructions to stakeholders, outlining the steps to remediate the identified issues effectively.

In some implementations, the remediation system 410 is configured to execute one or more remediation actions to mitigate a vulnerability or security gap. It bases its actions on the security posture of the entity. If a vulnerability is detected or a security gap is identified, the remediation system 410 executes to address the issue, employing a range of remediation actions such as patching software, modifying system configurations, or enhancing security policies.

Additionally, the analysis circuit 136 facilitates the process of opening readiness issues and gaps 434. It identifies areas where the organization can have shortcomings or deficiencies in its preparedness for potential incidents or security threats. By highlighting these gaps, the analysis circuit 136 helps organizations prioritize and allocate resources to address the identified issues and enhance their overall readiness posture. Moreover, the analysis circuit 136 can execute underwriting 436, which involves evaluating organizations to determine the type of vendor plans, products, or services they can qualify for. Through an assessment, the analysis circuit 136 analyzes various factors, such as the security measures of the organization, incident response capabilities, risk management practices, and/or compliance with industry standards. Based on the evaluation, the analysis circuit 136 provides insights and recommendations on suitable vendor offerings that align with the requirements of the organization and level of readiness.

In some implementations, the readiness system 402 is configured to continuously update the security posture of the entity. It does this by monitoring dynamic changes in the entity data, which can involve alterations in system configurations, updates to security policies, new cyber threats, and/or shifts in the cyber risk landscape. This continuous updating of the security posture ensures that the security status of the organization reflects the most current conditions. It allows the analysis circuit 136 to react to emerging threats or vulnerabilities, providing real-time protection for the data and systems of the entity.

In some implementations, the readiness system 402 can also be configured to tokenize and broadcast the security posture to a distributed ledger. This process involves converting the security posture into a format suitable for recording on a blockchain (e.g., a type of distributed ledger). It then broadcasts this tokenized data across the network of computers that maintain the ledger. Additionally, the readiness system 402 provides a public address of the tokenized updated security posture on the distributed ledger. This public address can be accessed by a plurality of third-parties for verification. This transparent and immutable record-keeping enhances trust among stakeholders and provides a verifiable proof of the security posture of the entity.

In some implementations, the readiness system 402 is further configured to generate a security roadmap. This roadmap includes a plurality of phases associated with the modeling of the set of cybersecurity attributes. At least one (e.g., each) cybersecurity attribute of the set is assigned a phase associated with the security roadmap of the entity. For example, the roadmap serves as a strategic plan that outlines the steps the entity can take to enhance its security posture. It provides a clear pathway to achieving the security objectives of the entity, ensuring that efforts are well-coordinated, and resources are optimally utilized. By assigning at least one (e.g., each) cybersecurity attribute to a phase of the roadmap, the readiness system 402 ensures that at least one (e.g., each) aspect of the security of the entity is appropriately addressed.

In some implementations, the cybersecurity connection system 406 can create and set in motion a cybersecurity protection obligation, in provide plans 425, between the entity and the third party upon receiving an activation of the cybersecurity protection plan. The cybersecurity protection obligation can be a binding agreement or contract that outlines the responsibilities and roles of the entity and the third party in securing the systems and data of the entity. This protection obligation is characterized by several protection attributes, which can involve various elements such as the scope of protection, the duration of the contract, the cybersecurity services to be provided, the response time in the event of a security incident, and/or the terms of service termination or renewal. Moreover, the cybersecurity connection system 406 can identify multiple cybersecurity protection plans (e.g., at provide plans 425) associated with various third-parties. These could include a wide array of cybersecurity service providers, at least one (e.g., each) offering distinct protection plans. For instance, a first cybersecurity protection plan could be offered by a first third party, while a second cybersecurity protection plan could be offered by a different third party. At least one (e.g., each) of these protection plans can be associated with the new cybersecurity attribute identified during the modeling process, indicating that they are specifically designed to address this aspect of the cybersecurity needs of the entity.

In some implementations, at least one (e.g., each) cybersecurity protection plan, in turn, is associated with one of several availability states. These states provide an immediate understanding of the status regarding its accessibility for the entity. The “available now” state means that the plan is currently accessible for implementation. The “available pending” state signifies that the plan will become accessible in the future, perhaps subject to certain conditions or the passing of a certain period. Conversely, an “unavailable” state denotes that the plan is not currently accessible, possibly due to it being phased out, fully subscribed, or not being offered in the region of the entity. Additional or fewer states can be added. This system of availability states allows the entity to quickly determine which plans are viable options for enhancing their cybersecurity posture.

In some implementations, the incident system 404 can establish a data (e.g., continuous, in real-time, periodically) monitoring channel between the entity and the third party. This communication stream allows for real-time (or near real-time) detection and response to any potential cybersecurity incidents. To achieve this, a first communication connection is established using a first application programming interface (API) between the computing system of the entity (e.g., client device 110) or one or more entity assets (e.g., client device 110) and the incident system 404. This connection allows the incident system 404 to continuously monitor the systems and data of the entity for any signs of a cybersecurity incident. Simultaneously, a second communication connection is established using a second API between a third party computing system (e.g., third party device 150) and the incident system 404. This connection allows the third party, often a cybersecurity service provider, to also monitor the systems and data of the entity, providing an additional layer of protection and vigilance.

Moreover, the claim handling system 408 can be configured to quickly respond to any detected cybersecurity incidents. Upon detection of a new cybersecurity incident, the claim handling system 408 generates alerts and provides a real-time dashboard for the entity and vendor. This dashboard provides an overview of the cybersecurity posture of the entity, data of the detected incident, recommended response actions, and/or updates on the response process. This real-time information allows the entity to rapidly understand and react to the cybersecurity incident, minimizing potential damage and downtime.

In some implementations, the remediation system 410 can use predictive analytics to identify potential security gaps before they can be exploited. It analyses patterns in the data and behaviors of the entity, as well as trends and threats in the broader cybersecurity landscape, to predict where vulnerabilities might arise. Upon identifying a potential security gap, the remediation system 410 proactively executes one or more remediation actions. These actions could involve updating security policies, patching software vulnerabilities, reconfiguring system settings, providing cybersecurity training to employees, or implementing additional cybersecurity measures.

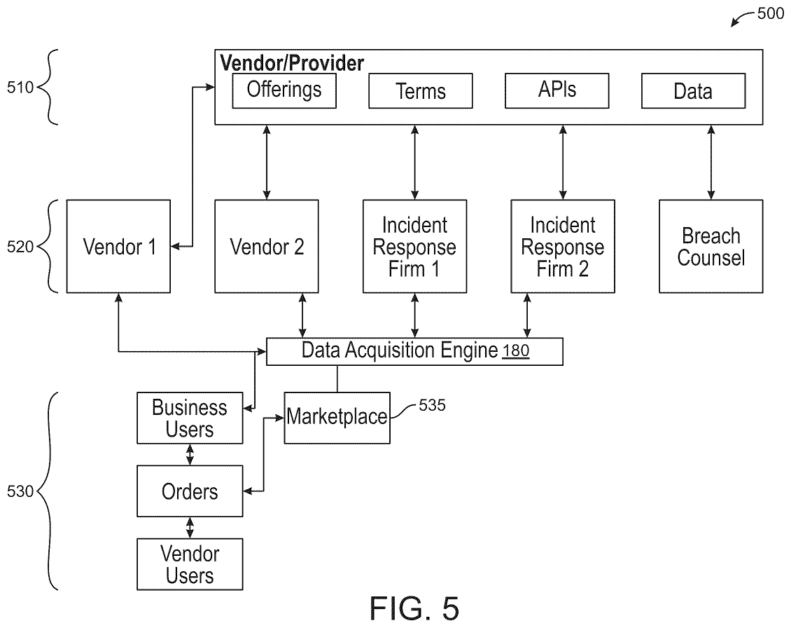

Referring now to FIG. 5, a vendor-provider marketplace 500, according to some implementations. The vendor-provider marketplace 500 depicts generally the interactions between vendors 510 and users 530 (e.g., directly or through partners) as well as vendors 510 to vendors 520. For example, at least one (e.g., each) vendor 520 can include, but is not limited to, offerings, terms, APIs, and/or data that can be provided and/or exchanged with to the response system 130 via the data acquisition engine 180 and other vendors, incident response firms, and/or breach counsel (e.g., law firm) (collectively referred to as “vendors 520”). In some implementations, those vendors 520 can communicate with the data acquisition engine 180 of FIG. 1A to generate dashboards of an application (e.g., application 112, application 152) and store data in database 140 for future use.

Expanding on the vendor-provider marketplace 500 depicted in FIG. 5, this marketplace serves as a central hub for interactions between vendors 510, users 530, and/or vendors 520, facilitating the exchange of offerings, terms, APIs, and/or data. At least one (e.g., each) vendor 510 within the marketplace encompasses a range of products, services, and/or resources that can be made available to users 530 directly or through the engagement of vendors 520. These vendors 520, which include incident response firms, breach counsel (such as law firms), and/or other relevant entities, play a crucial role in providing expertise and additional support to enhance incident response capabilities (e.g., a type of cybersecurity attribute). Through communication with the data acquisition engine 180, the vendors 520 can actively engage in generating dashboards within the application interfaces (e.g., application 112, application 152). These dashboards offer real-time insights and analytics, allowing users 530 to visualize and assess their incident response readiness, track ongoing incidents, and/or access relevant data stored in the database 140 for future reference. The data acquisition engine 180 serves as a communication bridge, allowing vendors 520 to contribute information and leverage the functionalities of the response system 130. It should be understood that the vendors 510, vendors 520, and/or users 530 depicted in the vendor-provider marketplace 500 can be executed by computer systems, exemplified by the computing system 200 shown in FIG. 2. These computer systems facilitate collaboration, data exchange, and/or transactional activities within the marketplace, ensuring a dynamic and efficient ecosystem for incident response management.

In certain implementations, the vendor-user interaction within the marketplace 535 extends beyond mere browsing and exploration. Vendors 510 and users 530 have the capability to place orders directly through the marketplace 535, initiating a streamlined process facilitated by the data acquisition engine. This integration of ordering functionality enhances the efficiency and convenience of the marketplace, facilitating transactions between vendors and users. Notably, the marketplace 535 serves as a platform for programmatic connectivity, allowing new partners to establish collaborative relationships efficiently. The marketplace incorporates contracting workflows and partnering processes, which are seamlessly facilitated through the application interface. Once a partnership is ratified, the partners can immediately engage in business activities within the platform, leveraging the full range of services and offerings available. This includes the ability to submit proposals, engage in reselling, establish technical connectivity for provisioning and licensing, establish API connections for data sharing, utilization, and/or presentation on the platform, and/or leverage pre-defined programmable logic for user, vendor, and/or partner interactions.

In some implementations, the marketplace 535 introduces dynamic and automated workflows that facilitate routing of inbound orders to the appropriate partner based on predefined criteria. This programmable logic ensures that orders are seamlessly directed to the designated partner for processing and fulfillment. Furthermore, programmatic activation of contracts and seamless order fulfillment processes are executed, ensuring a smooth and rapid delivery of the purchased offering, whether it is a product or service. The marketplace ecosystem facilitates the seamless integration of vendors, partners, and/or users, streamlining the entire order management process and facilitating timely and efficient delivery of products and services.

Distinguishing itself from other vendor marketplaces, this embedded marketplace 535 is seamlessly integrated within the applications and APIs 171 spanning the entire system architecture. This integration allows vendor offerings to be presented to users precisely when they need them, seamlessly integrating within the user flow during various stages of cybersecurity incident response planning, testing, and/or execution. Moreover, the marketplace becomes an integral part of the design and composition processes for constructing a robust cybersecurity stack, as well as during security program orchestration and adaptation to ensure the ongoing effectiveness of the cybersecurity program. By embedding the marketplace within the applications and APIs, users 530 have immediate access to an array of vendor offerings precisely at the point of need. Whether users are developing their incident response plans, conducting tests, executing response strategies, or adapting their security programs, the marketplace seamlessly integrates within their workflow, providing timely and relevant vendor options to enhance their cybersecurity capabilities (e.g., cybersecurity attributes). This unique approach eliminates the need for users to navigate separate platforms or search for vendors independently, streamlining the entire process and promoting efficiency in decision-making and procurement.

Additionally, this embedded marketplace fosters a holistic approach to cybersecurity management, facilitating collaboration between users 530 and vendors 510 throughout the entire ecosystem. By offering vendor options during incident response planning, testing, and/or execution, users can make informed decisions and select the most suitable solutions to mitigate risks effectively. Similarly, during the design and composition of their cybersecurity stack, users 530 can access a diverse range of vendor offerings directly within the application interface, allowing them to build a tailored security infrastructure. Additionally, during security program orchestration and adaptation, the marketplace 535 provides users with valuable insights and options to enhance the effectiveness and resilience of their security programs, ensuring continuous protection against evolving threats.

It should be understood that the embedded architecture of the marketplace allows for flexibility and scalability, accommodating additional systems, devices, data structures, and/or data sources as required. The marketplace can adapt to the evolving needs of users and vendors, expanding its offerings and functionalities to meet the dynamic nature of the cybersecurity landscape. This adaptability ensures that the marketplace remains a valuable resource for users, providing access to the latest innovations and vendor solutions while facilitating seamless collaboration and partnership within the cybersecurity ecosystem.

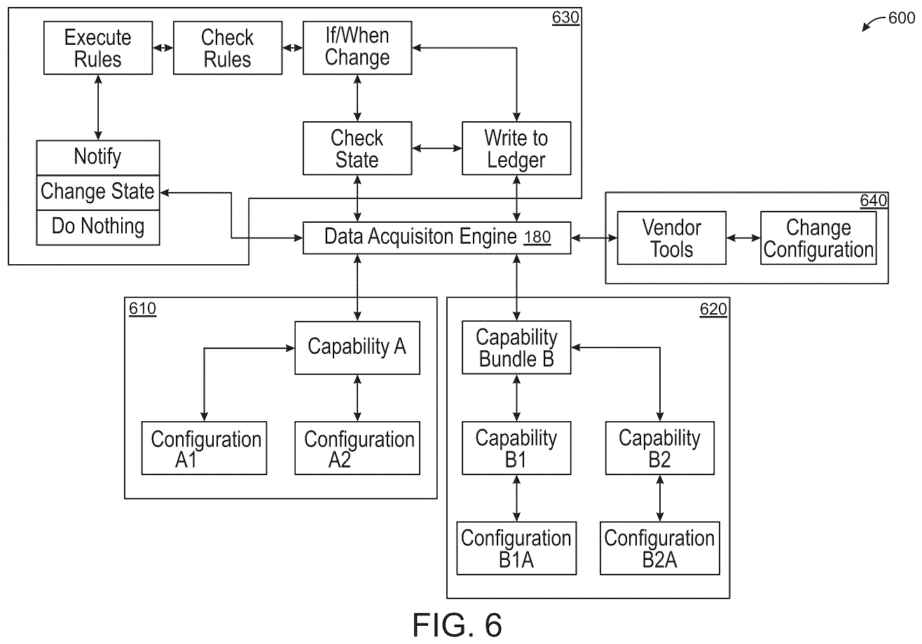

Referring now to FIG. 6, a method 600 for capturing the state of capabilities (sometimes referred to herein as “cybersecurity attributes”) (e.g., vendor technologies or configurations) in place and in use by users, retrieving state, and/or sharing of state at points in time as well as over a time period. Response system 130 (e.g., in particular analysis circuit 136 or data acquisition engine 180) or third party device 150 can be configured to perform method 600. Further, any computing device or system described herein can be configured to perform method 600. Additionally, the functions and features described in method 600 can be performed on an application.

In broad overview of method 600, capabilities 610 and 620 associated with a corporation of business can be received (e.g., capability A with configuration A1 and configuration A2, and/or capability bundle B with capability B1 and B2, where capability B1 has a configuration BIA and capability B2 has a configuration B2A). The capabilities 610 and 620 can be checked (e.g., check state) and the capabilities can be written to a ledger (e.g., database and/or blockchain 170) in steps 630. Once the capabilities 610 and 620 are received, a thorough check is conducted to verify their state and ensure their accuracy and validity. This check entails examining the current status and parameters of at least one (e.g., each) capability, evaluating factors such as readiness, compatibility, and/or compliance with established standards or requirements. By performing this assessment, any discrepancies or issues pertaining to the capabilities can be identified and addressed.

In some implementations, following the verification process, the next step involves recording the capabilities into a ledger. This ledger serves as a secure and reliable storage medium, which can take the form of a database or a blockchain 170. The capabilities, along with their associated configurations, are meticulously documented and stored within the ledger, ensuring the integrity and traceability of the information. This facilitates access to the capabilities data, their respective configurations, and/or any historical changes or updates that can occur over time. By writing the capabilities to the ledger, organizations gain a centralized and auditable repository that securely maintains a record of their capabilities. Additionally, the ledger ensures transparency and accountability by providing an immutable and tamper-proof audit trail of the capabilities and their configurations.

In turn in steps 630, a process can occur if a state has changed including, but not limited to, checking rules, execute rules, and/or notifying, changing state, and/or do nothing. If a change occurred (e.g., trigger condition, e.g., capability A changed, the data acquisition engine 180 can determine to change it back (or role it back), capability B changed and in turn then vendor technology is configured to change Y associated with the business or corporation) then the one more processing circuits can programmatically connect to vendor technology to change a configuration (e.g., utilizing API calls). In some implementations, at steps 640, the data acquisition engine 180 can communicate with vendor tools to change particular configurations.

Upon detecting a change in state, the data acquisition engine 180 evaluates the trigger condition, such as the alteration of capability A or capability B. Based on this evaluation, a decision is made regarding the appropriate course of action. For example, if capability A experiences a change, the data acquisition engine 180 can determine that a rollback is to be performed to revert the capability back to its previous state. Similarly, if capability B undergoes a change, the vendor technology associated with the business or corporation can be configured to adjust Y accordingly, aligning it with the modified capability. To effectuate these changes, the processing circuits within the data acquisition engine 180 (or within response system 130) establish programmatic connections with the vendor technology responsible for managing the configurations (e.g., at step 640). Moving forward to step 640, the data acquisition engine 180 actively engages in communication with the vendor tools to implement the desired changes. Through this interaction, the data acquisition engine 180 can efficiently orchestrate the configuration changes to align the capabilities with the desired state.

With reference to FIG. 6, the one or more processing circuits can utilize the various data structures (e.g., assets, locations, capabilities, threats) to collect, attribute, and/or adapt to determine if a trigger condition occurred (e.g., historical data of the corporation or business can be used to determine if a trigger condition occurred) In turn, the one or more processing circuits can execute one or more functions such as make an API request (e.g., to vendor, insurer, or business), store information in a database, and/or update a blockchain ledger (e.g., at step 630). Additionally, fewer, or different operations can be performed depending on the particular implementation. In some implementations, some or all operations of method 600 can be performed by one or more processors executing on one or more computing devices, systems, or servers.

In some implementations, in order to identify the occurrence of a trigger condition, historical data of the corporation or business is often utilized. This historical data provides valuable insights into the past behavior and patterns of the organization, allowing the processing circuits to make informed decisions regarding trigger condition identification. Upon determining that a trigger condition has indeed occurred, the one or more processing circuits initiate a series of functions and operations to address the situation. These functions can include making API requests to relevant entities such as vendors, insurers, or other businesses. Through these API requests, the processing circuits can retrieve crucial information or initiate actions to respond to the trigger condition effectively. Additionally, in certain implementations, the processing circuits can update a blockchain ledger, providing a secure and immutable record of the trigger condition and any associated changes made as a result.

In various implementations, at least one (e.g., each) operation can be re-ordered, added, removed, or repeated. This system will be used to deliver state of a business security configuration to facilitate insurance underwriting, whereby the facts of the state of the business user computing environment are known, and/or provable. This provides the underwriting insurer the ability to collect irrefutable proof-of-state of the business environment as part of their pre-underwriting and risk selection process and can be then used to facilitate programmatic binding as part of their application process. The system can be further utilized to provide programmatically and dynamically adaptable insurance products that change the coverage level based on the factual changes in state of the computing environment at the insured through the policy period. This allows the insurer to ensure that the insured has followed the underwriting criteria throughout the term of the policy. Cyber insurance renewals can be programmatically generated and automatically bound based on the binary data provided by the system during renewal as the insurer knows what the compliance history has been for the insured as well as the facts of the current state of the vendor capabilities and configurations in the insureds computing environment.

In various implementations, the underwriting process begins by collecting data from the security tools and configurations of the insured. This data can then be analyzed and matched against the underwriting requirements defined by the insurer. The collected data acts as irrefutable proof of the insured security posture, providing the insurer with a holistic understanding of the risk associated with the business environment of the insured. In some implementations, once the data has been collected and matched to underwriting requirements, the processing circuits can wrap this information with the context and metadata through a broker. The broker acts as an intermediary, consolidating and structuring the data in a standardized format that can be seamlessly transmitted to the quoting API of the insurer. This integration improves the underwriting application process, allowing the insurer to access the factual data of the security configuration and computing environment of the insured. With this data in hand, the insurer can programmatically assess the risk and make informed decisions regarding coverage and policy terms. This automated and dynamic approach empowers insurers to offer adaptable insurance products that can be adjusted based on the factual changes in the computing environment throughout the policy period, ensuring ongoing compliance with underwriting criteria and tailored coverage for the insured. Additionally, the system facilitates the automatic generation and binding of cyber insurance renewals based on the binary data provided during the renewal process. By utilizing the compliance history and the up-to-date facts of the computing environment of the insured, the insurer can renew the policy while maintaining an understanding of the risk profile of the insured and providing continuous coverage.

### Cyber Resilience Tokenization

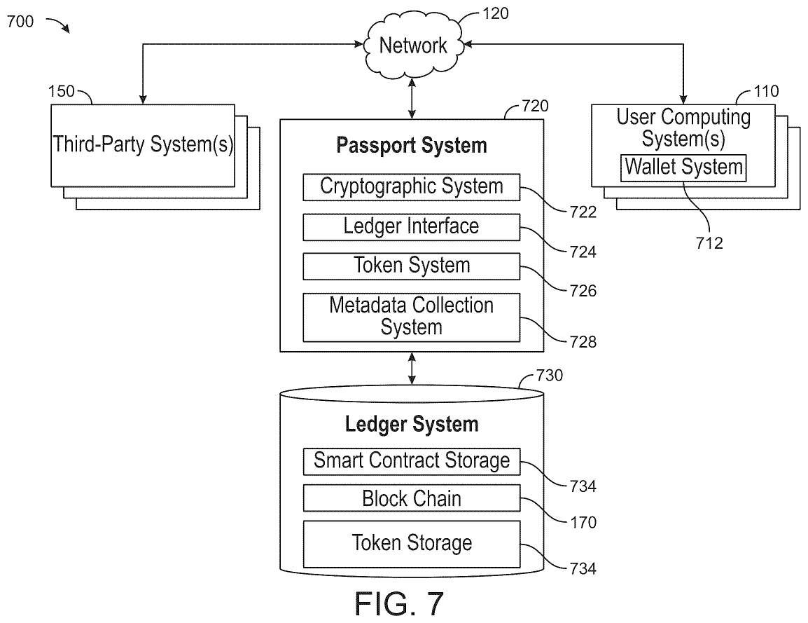

Referring to FIG. 7, a block diagram 700 of an implementation of a system for cyber resilience tokenization is shown, according to some implementations. The implementation shown in FIG. 7 can include client device 110 (also referred to herein as “client devices 110” and/or “user computing system(s) 110”), third party devices 150 (also referred to herein as “third party system(s) 150” and/or “third party device 150”), a passport system 720, and/or a ledger system 730. In some implementations, the client device 110 can include a wallet system 712. In some implementations, the passport system 720 can include a cryptographic system 722, a ledger interface 724, a token system 726, and/or a metadata collection system 728. In some implementations, the ledger system 730 can include smart contract storage 732, blockchain 170, and/or token storage 734. These components can be interconnected through a network 120 that supports secure communications profiles (e.g., TLS, SSL, HTTPS, etc.). In some implementations, the passport system 720 can incorporate the same or similar features and/or functionality as described regarding the response system 130 of FIG. 1A. Although the various computing elements of FIG. 7 can be described in the singular form (e.g., client device 110, third party device 150, etc.), it should be understood that the implementation shown in FIG. 7 can include two or more of any device/system described herein (e.g., two or more client device 110, two or more third party devices 150, etc.).

At least one (e.g., each) system or device of FIG. 7 can include one or more processors, memories, network interfaces (sometimes referred to herein as a “network circuit”) and user interfaces. The memory can store programming logic that, when executed by the processor, controls the operation of the corresponding computing system or device. The memory can also store data in databases. For example, memory can store programming logic that when executed by a processor within a processing circuit, causes a database to update parameters or store a system or event log. The network interfaces can allow the computing systems and devices to communicate wirelessly or otherwise. The various components of devices in system 100 can be implemented via hardware (e.g., circuitry), software (e.g., executable code), or any combination thereof. Devices, systems, and/or components in FIG. 7 can be added, deleted, integrated, separated, and/or rearranged in various implementations of the disclosure.

Generally, the client device 110, third party devices 150, passport system 720, and/or ledger system 730, wallet system 712, cryptographic system 722, ledger interface 724, token system 726, metadata collection system 728, smart contract storage 732, blockchain 170, token storage 734, and/or network 120 can include one or more logic devices, which can be one or more computing devices equipped with one or more processing circuits that run instructions stored in a memory device to perform various operations. The processing circuit can be made up of various components such as a microprocessor, an ASIC, or an FPGA, and/or the memory device can be any type of storage or transmission device capable of providing program instructions. The instructions can include code from various programming languages commonly used in the industry, such as high-level programming languages, web development languages, and/or systems programming languages. The client device 110, third party devices 150, passport system 720, and/or other various components of FIG. 7 can also include one or more databases for storing data that receive and provide data to other systems and devices on the network 120.

Generally, the passport system 720 can execute and/or be utilized to execute various processes and/or tasks corresponding with modeling cyber resilience data. For example, the passport system 720 can provide a single sign-on gateway (e.g., using an identity management system like AuthO) facilitating access to the associated security posture of the user, threat, incident, and/or insurance data sets using data sets encapsulated within various tokens. For example, the passport system 720 can generate a token (e.g., a passport) linked to various additional tokens and further linked to a control structure restricting access to one or more of the additional tokens based on rules (e.g., RBACs). For example, a cyber resilience identifier (e.g., passport) of an entity can include entity data and/or additional cyber resilience data stored in tokens, and the passport system 720 can provide and/or restrict access to one or more portions of the tokenized data based on various conditions, entity types, data types, regulations, and so on. That is, an entity can have a container with access controls and a passport created by the passport system 720 linked to both sensitive (e.g., private) and non-sensitive (e.g., public) data, and the passport system 720 can deny access (e.g., to sensitive data) and provide access (e.g., to non-sensitive data) based the access control (e.g., whether the user to access the data is a customer, insurer, vendor, MDR/XDR provider, etc.).

Generally, the passport system 720 can provide secure access to token-related data and facilitate interactions between different cybersecurity systems and data sources of FIG. 7 (e.g., client device 110, third party devices 150, ledger system 730, etc.) based on various access controls. For example, the passport system 720 can create a cyber resilience identity with tokens and rule-based access controls controlling access to the tokens. For example, the passport system 720 can generate a passport for a third party linked to controls such that the third party can access their own data within the token structure. In some implementations, a third party entity can use the passport system 720 to access performance tokens stored in the token structure, such as in a passport associated with the cybersecurity status of an entity, with RBAC rules restrict other entities from viewing or modifying these tokens. Another example can include third party vendors having access to their own evaluation tokens that include the results of security assessments relevant to their services, without the ability to access data from other vendors.

In some implementations, the passport system 720 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor. ASIC. FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the passport system 720 can include an interface circuit and function circuit.

In some implementations, the passport system 720 can model cyber resilience data using cyber resilience identities and associated metadata. For example, the passport system 720 can use templates to structure cyber resilience data and apply attributes to model various cyber resilience metrics (e.g., threat detection capabilities, response readiness). In some implementations, the passport system 720 can receive or identify cyber resilience data. For example, the passport system 720 can collect data from various sources, including security incident reports, vulnerability assessments, and/or system performance metrics. In some implementations, the passport system 720 can encrypt a portion of the cyber resilience data. For example, the passport system 720 can apply cryptographic techniques to secure sensitive information within the cyber resilience dataset, such as private keys or confidential incident data. In some implementations, the passport system 720 can generate a metadata object including metadata of cyber resilience data. For example, the metadata object can include information such as data creation timestamps, data source identifiers, and/or encryption keys. In some implementations, the passport system 720 can generate a cyber resilience identity including at least a link with the metadata object, a unique identifier (UID), and/or a performance event dataset. For example, the cyber resilience identity can include a URI linking to the metadata object, a UID for tracking the identity, and/or a dataset summarizing key performance events.

In some implementations, the passport system 720 can encapsulate the cyber resilience identity within a container including a control structure restricting one or more updates and redemptions of the metadata object. For example, the container can use access controls and permission rules to prevent unauthorized modifications or access to the metadata object. In some implementations, the passport system 720 can determine at least one access data structure being compatible with the control structure. For example, the passport system 720 can analyze data structures such as access control lists (ACLs) or role-based access controls (RBAC) to facilitate compatibility with the control structure. In some implementations, the passport system 720 can broadcast, using the control structure, the cyber resilience identity to a ledger or distributed ledger. For example, the passport system 720 can publish the cyber resilience identity to a blockchain or distributed ledger, and the identity can be securely recorded and accessed by authorized entities via the distributed ledger.

In some implementations, the token system 726 can generate various tokens. In some implementations, the token system 726 can generate cyber resilience identities (e.g., a passport including a token linked to various additional tokens with metadata). That is, generating the cyber resilience identities can include generating tokens that include metadata objects or metadata with information corresponding to components and/or metrics of the cybersecurity posture of the entity, such as firmographic information, security safeguards, threat detection capabilities, incident response data, compliance metrics, or other relevant cybersecurity information. For example, the token system 726 can generate, mint, or otherwise create unified safeguard tokens, unified requirements tokens, performance tokens, coverage tokens, incident readiness tokens, insurability readiness tokens, gap tokens, effectiveness tokens, and/or various additional tokens. For example, the token system 726 can structure a token to encapsulate data sets related to different aspects of cybersecurity such that a set of tokens can facilitate an evaluation of the security status of the entity (e.g., by an insurer or vendor). The various tokens generated by the token system 726 and encapsulated in cyber resilience identities are described in greater detail herein.

In some implementations, the cyber resilience identities can include a coverage token. The coverage token can be structured to store information about insurance policies, including policy numbers, premium amounts, and/or coverage data. That is, the token system 726 can generate a coverage token when the insurance coverage data of the entity is to be documented and managed. For example, the coverage token can be created to include policy information such as the insured client, domain, and/or premium data. In generating the cyber resilience identities, the coverage token generated by the token system 726 can include data on insurance coverage, retention terms, and/or claims associated with the policy. For example, the coverage token can store data related to premium payment schedules, policy numbers, and/or claim UIDs that are linked to an insurance policy of an entity corresponding to a cyber resilience identity.

In some implementations, the cyber resilience identities can include an effectiveness token. The effectiveness token can be structured to store a record of the security effectiveness of the organization over time, linking to historical data through performance tokens and capturing outcomes related to incidents and claims. That is, the token system 726 can generate an effectiveness token to document and evaluate the results of past and ongoing security measures within an organization. For example, the effectiveness token can be generated to include the unique effectiveness token UID, the creation date, a list of performance tokens, and/or outcomes related to security incidents and claims. In generating the cyber resilience identities, the effectiveness token generated by the token system 726 can include references to associated performance tokens, incident tokens, and/or claims tokens, providing a longitudinal view of security effectiveness. For example, the effectiveness token can include data indicative of how various incidents have impacted the security posture of the organization over time, including the effectiveness of response efforts and any gaps identified during evaluations.

In some implementations, the cyber resilience identities can include a gaps token. The gaps token can be structured to record and track information about vulnerabilities and compliance issues within the IT infrastructure of the organization. That is, the token system 726 can generate a gaps token to identify and monitor security gaps that could affect the cybersecurity posture of the organization. For example, the gaps token can be generated to include a unique gap UID, timestamp, description of the vulnerability, impact description, severity rating, and/or recommended actions for remediation. In generating the cyber resilience identities, the gaps token generated by the token system 726 can include metadata about at least one (e.g., each) identified gap, including the category of the threat, impact on confidentiality, integrity, and/or availability, and/or references to external resources for further information. For example, the gaps token can capture the severity of a local privilege escalation vulnerability in the IT infrastructure of the organization and provide recommendations for mitigating the threat.

In some implementations, the cyber resilience identities can include an IOCs (Indicators of Compromise) token. The IOCs token can be structured to store and describe indicators of malicious activity detected within an environment of the organization. That is, the token system 726 can generate an IOCs token when there is a need to catalog and track known indicators of compromise that are associated with cybersecurity incidents. For example, the IOCs token can be generated to include a unique indicator UID, type of indicator (e.g., file hash), description of the indicator, and/or a pattern representing the malicious activity. In generating the cyber resilience identities, the IOCs token generated by the token system 726 can include data such as the confidence level in the indicator, the type of malicious activity it represents, and/or the pattern or signature detected. For example, the IOCs token can store information about a malicious file hash associated with a known malware instance, helping to identify and respond to similar threats in the future.

In some implementations, the cyber resilience identities can include an incident token. The incident token can be structured to capture data about a cybersecurity incident, including the type, date, outcome, and/or associated claims data. That is, the token system 726 can generate an incident token when to document and manage the lifecycle of a cybersecurity incident within an organization. For example, the incident token can be generated to include a unique incident UID, the title of the incident, incident data such as the type of attack, impacted data, response actions taken, and/or the associated costs. In generating the cyber resilience identities, the incident token generated by the token system 726 can include references to related tokens, such as TTPs (Tactics, Techniques, and/or Procedures) tokens, IOCs tokens, and/or breach team data, providing an overview of the incident. For example, the incident token can document the timeline of a ransomware attack, the response efforts, the root cause analysis, and/or the financial impact on the organization.

In some implementations, the cyber resilience identities can include a performance token. The performance token can be structured to provide a record of evaluations associated with safeguards and requirements within an organization (e.g., at a time). That is, the token system 726 can generate a performance token when to store the results of evaluations and assessments related to the cybersecurity safeguards of the organization. For example, the performance token can be generated to include a unique performance token UID, the date of creation, safeguard results, safeguard transformation results, and/or comparison results against predefined requirements. In generating the cyber resilience identities, the performance token generated by the token system 726 can include outcomes of safeguard evaluations, transformation proofs, and/or any identified gaps in compliance at a point in time. For example, the performance token can track the effectiveness of endpoint security measures, document how well the measures meet the thresholds, and/or identify areas for improvement.

In some implementations, the cyber resilience identities can include a ransom token. The ransom token can be structured to capture data about a ransomware incident, including ransom demands, payment data, and/or outcomes. That is, the token system 726 can generate a ransom token to document and manage the specifics of a ransomware event within an organization. For example, the ransom token can be generated to include a unique ransom UID, the incident UID it is associated with, data of the ransomware attack such as the group involved, payment wallet address, currency type, and/or the outcome of the payment. In generating the cyber resilience identities, the ransom token generated by the token system 726 can include references to the breach team involved, post-incident follow-up data, and/or information about the threat actor. For example, the ransom token can document the financial impact of the ransom payment, the success rate of data decryption, and/or ongoing risks posed by the threat actor.

In some implementations, the cyber resilience identities can include a TTPs (Techniques, Tactics, and/or Procedures) token. The TTPs token can be structured to provide an overview of a detected cybersecurity threat event, outlining the tactics, techniques, and/or procedures identified. That is, the token system 726 can generate a TTPs token to document and analyze adversarial behaviors detected during a cybersecurity incident. For example, the TTPs token can be generated to include a unique TTP UID, event data such as the event code, provider, start and end time, and/or description of the event, as well as information about the threat, including the tactic employed, techniques used, procedures followed, and/or the threat actor involved. In generating the cyber resilience identities, the TTPs token generated by the token system 726 can include observations from the event, such as the actions taken by the adversary, the outcome of those actions, and/or any data artifacts observed. For example, the TTPs token can document a phishing attack, including how the attack was executed, the tools used by the attacker, and/or the impact on the organization.

In some implementations, the cyber resilience identities can include a unified asset token. The unified asset token can be structured to provide information about the assets managed within an organization, including types, operational statuses, and/or associated identifiers. That is, the token system 726 can generate a unified asset token when to document and manage the lifecycle of assets within the IT infrastructure of the organization. For example, the unified asset token can be generated to include a unique asset UID, the date of creation, asset data such as type, name, description, location, and/or owner, and/or the operational status of the asset. In generating the cyber resilience identities, the unified asset token generated by the token system 726 can include identifiers and sources related to the asset, such as inventory data, cloud provider information, and/or any additional metadata. For example, the unified asset token can document the operational status of the server, its cloud instance data, and/or any associated identifiers such that an organization can track and monitor assets.

In some implementations, the cyber resilience identities can include an incident readiness token. The incident readiness token can be structured to capture the attributes that demonstrate the preparedness of the organization for responding to cybersecurity incidents. That is, the token system 726 can generate an incident readiness token to document and verify an ability of the organization to handle cybersecurity incidents effectively. For example, the incident readiness token can be generated to include a unique incident readiness UID, the associated passport UID, and/or a description of the readiness of the organization to respond to cybersecurity incidents. In generating the cyber resilience identities, the incident readiness token generated by the token system 726 can include attributes such as the incident response plan, training and awareness programs, tools and technologies used, and/or testing exercises conducted. For example, the incident readiness token can document the annual incident response plan updates of the organization, quarterly training sessions of the organization, and/or various additional tools and technologies of the organization in place to detect and mitigate cybersecurity threats.

In some implementations, the cyber resilience identities can include an insurability readiness token. The insurability readiness token can be structured to capture attributes for an organization to qualify for cybersecurity insurance, including risk assessments, security measures, and/or incident history. That is, the token system 726 can generate an insurability readiness token to document and assess the preparedness of the organization for obtaining cybersecurity insurance. For example, the insurability readiness token can be generated to include a unique insurability readiness UID, the carrier UID, the associated passport UID, and/or a description of the preparedness of the organization for cybersecurity insurance. In generating the cyber resilience identities, the insurability readiness token generated by the token system 726 can include attributes such as risk assessments, security measures, documentation and compliance, and/or incident history. For example, the insurability readiness token can document the annual risk assessments of the organization, the implementation of strong cybersecurity controls, and/or the effective mitigation of past incidents, providing an overview of the qualifications of the organization for cybersecurity insurance.

In some implementations, the cyber resilience identities can include or be associated with a passport, which can be a token or a distinct entity interacting with other tokens. The passport can be structured to encapsulate information about an entity, including firmographic data, indicators of cybersecurity readiness, and more. That is, the token system 726 can generate or link to a passport to provide certain information corresponding to the cybersecurity posture and readiness of the entity for insurance purposes. For example, the passport can contain or link to various tokens, such as unified safeguard tokens, unified requirements tokens, performance tokens, coverage tokens, incident readiness tokens, insurability readiness tokens, gap tokens, effectiveness tokens, and/or various additional tokens. For example, the token system can generate a cyber resilience identity or passport providing access to metadata inclusive of various cyber resilience data (e.g., legal structure of the entity, number of protected records of the entity, preparedness for cyber insurance of the entity, etc.) through linked tokens. Additional, token system can 102 can generate the passport linked with a control structure to limit access to data and updates, as further described herein.

In some implementations, the wallet system 712 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor. ASIC. FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the wallet system 712 can include an interface circuit and function circuit.

In some implementations, the wallet system 712 can include a storage mechanism for holding digital assets, including cyber resilience tokens, private keys, and/or access credentials. In some examples, the wallet system 712 can perform cryptographic operations to encrypt and decrypt token-related data and sign transactions, authenticating the client device 110 during interactions with the passport system 720 and the ledger system 730. The wallet system 712 can manage permissions and access control so that authorized can entities initiate or authorize updates to the cyber resilience tokens stored within the ledger system 730. In some implementations, the wallet system 712 can communicate with dynamic non-fungible tokens (DNFTs) or other various tokens associated with the cyber resilience identity. For example, the wallet system 712 can store and manage multiple NFTs or DNFTs representing different aspects of a cybersecurity posture (e.g., cyber resilience status) of an organization or entity. The wallet system 712 can facilitate updates to the tokens by performing cryptographic operations that validate and record changes to the cybersecurity data encapsulated within the DNFTs. The wallet system 712 can also provide an interface that authorized entities use to access and manage the DNFTs, facilitating the review and assessment of the cybersecurity posture of the entity over time.

In some implementations, the wallet system 712 can store, create, and/or update a variety of tokens associated with the cybersecurity posture of an organization or entity. The wallet system 712 can create and update performance tokens, which can include results of cybersecurity events, assessments, or incident responses (e.g., a security breach response or a periodic vulnerability assessment). The wallet system 712 can create and maintain unified tokens, which can include data representing the state of various cybersecurity elements over time (e.g., safeguards implemented across the organization, internal and third party requirements compliance, or asset management). The wallet system 712 can capture and record evaluation tokens, which can include cybersecurity data captured at multiple points in time (e.g., snapshots of the organization cybersecurity posture at regular intervals). The wallet system 712 can aggregate and store roll-up tokens, which can include combined data from unified and real-time tokens to provide a view of the cybersecurity performance over a specified period (e.g., annual security performance summary). The wallet system 712 can create and update resilience tokens, which can include tokens representing different dimensions of the organization cybersecurity posture (e.g., tokens for cybersecurity resilience metrics). The wallet system 712 can further provide interfaces for entities to access, manage, and/or review the various tokens.

In some implementations, the systems or components of FIG. 7 can communicate over network 120. Network 120 can include computer networks such as the Internet, local, wide, metro or other area networks, intranets, satellite networks, other computer networks such as voice or data mobile phone communication networks, combinations thereof, or any other type of electronic communications network. Network 120 can include or constitute a display network. As a non-limiting example, network 120 can implement transport layer security (TLS), secure sockets layer (SSL), hypertext transfer protocol secure (HTTPS), and/or any other secure communication protocol. In some implementations, network 120 can be composed of various network devices (nodes) communicatively linked to form one or more data communication paths between participating devices. The network 120 can facilitate communication between the various nodes, such as the client device 110, third party devices 150, passport system 720, etc. (e.g., using an OSI layer-4 transport protocol such as the User Datagram Protocol (UDP), the Transmission Control Protocol (TCP), Stream Control Transmission Protocol (SCTP), etc.). At least one (e.g., each) networked device can include at least one network interface for receiving and/or transmitting data, typically as one or more data packets. An illustrative network 120 is the Internet (however, other networks can be used). Network 120 can be an autonomous system (AS), e.g., a network that is operated under a consistent unified routing policy (or at least appears to from outside the AS network) and is generally managed by a single administrative entity (e.g., a system operator, administrator, or administrative group).

In some implementations, the ledger system 730 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC. FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the ledger system 730 can include an interface circuit and function circuit.

In some implementations, the ledger system 730 can be a ledger or a decentralized ledger. For example, the ledger system 730 can include a distributed ledger technology (DLT) that supports immutable record-keeping and secure data transactions. The ledger system 730 can store various types of tokens and cybersecurity data, including performance tokens, unified tokens, evaluation tokens, roll-up tokens, and/or resilience tokens. The ledger system 730 can securely record updates and changes to tokens (e.g., providing data integrity and traceability). For example, the ledger system 730 can use blockchain to provide a tamper-evident record of token-related transactions.

In some implementations, the ledger system 730 can include smart contract storage 732, blockchain 170, and/or token storage 734. In some implementations, the smart contract storage 732, blockchain 170, and/or token storage 734 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the smart contract storage 732, blockchain 170, and/or token storage 734 can include an interface circuit and function circuit.

In some implementations, smart contract storage 732 can manage and execute predefined agreements related to token transactions and updates. In one example, smart contract storage 732 can store role-based access controls (RBACs or other rule-based control systems) or other access control mechanisms restricting access or updates to tokenized cyber resilience data stored via the ledger system 730. In some examples, the smart contract storage 732 can store rules or other data to automate processes such as token validation, data access control, and/or compliance checks. For example, smart contract storage 732 can store smart contracts that define the rules and logic for managing token transactions and updates. In some examples, smart contract storage 732 can manage contract templates that specify access permissions, including RBACs to restrict access based on user roles. That is, the smart contract storage 732 can implement RBAC to control permissions for executing transactions or modifying token data. Smart contract storage 732 can execute stored access controls/smart contracts to enforce access permissions, validate transactions, and/or verify compliance of entities or organizations with various cyber resilience parameters. In some implementations, smart contract storage 732 can process transactions according to terms, parameters, or rules to restrict access to tokens or other cyber resilience data.

In some implementations, blockchain 170 can include a decentralized ledger that records and validates token transactions. For example, blockchain 170 can utilize consensus mechanisms (e.g., proof of provenance, proof of work, proof of stake) to validate transactions involving tokenized cyber resilience data across a distributed network. In some examples, blockchain 170 can provide a tamper-evident and/or immutable record of token data by employing cryptographic techniques (e.g., hashing functions) to record and verify token transactions. That is, blockchain 170 can provide transparency and traceability of token-related activities by securely recording token transactions on a distributed computing architecture.

In some implementations, token storage 734 can store tokenized cyber resilience data. For example, token storage 734 can store and/or manage tokens including performance tokens, unified tokens, evaluation tokens, and/or roll-up tokens generated and/or provided by the token system 726. In some examples, token storage 734 interfaces with blockchain 170 to manage and organize token data. For example, token storage 734 can handle different token types, including performance tokens, unified tokens, evaluation tokens, and/or roll-up tokens. Token storage 734 can utilize data structures such as relational databases, NoSQL databases, or file systems to organize and manage tokens and/or corresponding data. In some examples, token storage 734 can maintain data accuracy by integrating with blockchain 170 to validate and update token records.

In some implementations, the passport system 720 can include one or more systems and/or subsystems to model cyber resilience data using cyber resilience identities and associated metadata (e.g., cryptographic system 722, ledger interface 724, token system 726, and/or metadata collection system 728). In some implementations, the cryptographic system 722, ledger interface 724, token system 726, and/or metadata collection system 728 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the cryptographic system 722, ledger interface 724, token system 726, and/or metadata collection system 728 can include an interface circuit and function circuit.

In some implementations, the metadata collection system 728 can receive or identify cyber resilience data. That is, receiving or identifying can include the metadata collection system 728 acquiring, processing, and/or categorizing data from various sources, such as cybersecurity events, system performance metrics, and/or vulnerability assessments stored on ledger system 730. For example, the metadata collection system 728 can gather and/or organize data attributes like event timestamps, sources, and/or types corresponding to the cyber resilience status of the entity and other cyber protection information of the entity. Additionally, the metadata collection system 728 can link these data attributes to cyber resilience metrics and update the corresponding records to reflect changes in the cyber protection posture of the entity.

In some implementations, the cryptographic system 722 can encrypt a portion of the cyber resilience data. That is, encrypting can include the cryptographic system 722 securing sensitive data using cryptographic techniques tailored to the requirements of the data. For example, the cryptographic system 722 can apply encryption algorithms to protect sensitive data, such as performance metrics or identifiers of an organization or entity. Further, the cryptographic system 722 can utilize key management techniques to facilitate secure data encryption and decryption process such that authorized entities can access the encrypted data. Additionally, the cryptographic system 722 can use asymmetric encryption to secure data before it is stored or transmitted. For example, the cryptographic system 722 can apply hashing algorithms to verify the integrity of data associated with cyber resilience events and assessments such that the data remains unaltered during transmission or storage.

In some implementations, the token system 726 and/or metadata collection system 728 can generate a metadata object including metadata of cyber resilience data. That is, the token system 726 can create structured metadata objects that include information about tokenized data, such as fields, tags, headers, and/or other relevant attributes like data type, source, and/or context. For example, the token system 726 can organize metadata into formats that provide descriptions and classifications for at least one (e.g., each) element of cyber resilience data. Further, the metadata collection system 728 can collect and integrate various metadata elements, such as timestamps, source identifiers, and/or data relevance indicators, into the metadata object. Additionally, the token system 726 can structure the metadata to improve the understanding and usability of the collected cyber resilience data.

In some implementations, the token system 726 can generate a cyber resilience identity including at least a link with the metadata object, a unique identifier (UID), and/or a performance event dataset. That is, generating can include creating, associating, and/or linking metadata objects, unique identifiers, and/or performance datasets with an identifier of an organization or entity. For example, the token system 726 can generate a passport that links to metadata stored in one or more tokens, at least one (e.g., each) containing data related to different aspects of the cyber resilience of the entity. The passport can include a unique identifier for tracking and linking the metadata object to other associated tokens. Further, the performance event dataset within the passport can capture and store cyber resilience performance data, such as that stored in multiple performance tokens, which can be collected at different points in time. For example, the token system 726 can issue or mint tokens linked to a single token that reference metadata objects and include unique identifiers for tracking, and the token system 726 can embed performance metrics and historical data within the tokens to provide insights into cyber resilience.

In some implementations, the token system 726 can encapsulate the cyber resilience identity within a container that includes a control structure restricting one or more updates and redemptions of the metadata object. That is, encapsulating can include implementing token gating mechanisms or smart contracts to enforce rules on who can update or redeem the cyber resilience identity, based on predefined criteria and access control policies. For example, the token system 726 can establish a control structure that allows a customer to view relevant data within their own passport while restricting the access of the insurer to tokenized data for underwriting decisions. Generally, the passport system 720 can implement a control structure that enforces rules on who can update or redeem the cyber resilience identity based on predefined criteria (e.g., entity type, user preferences/selections, etc.).

In some implementations, the ledger interface 724 can determine at least one access data structure that is compatible with the control structure. That is, determining can include analyzing various data structures to identify or determine alignment with the access control policies and update restrictions defined by the control structure. For example, the ledger interface 724 can evaluate different data structures to verify compatibility with access levels and permissions for interacting with the cyber resilience identity. Additionally, the ledger interface 724 can select and implement data structures that support the secure and compliant management of access and updates within the token system 726.

The control structure (e.g., implemented as a smart contract) governs access to a token structure containing various tokens, such as performance tokens, unified tokens, evaluation tokens, and/or roll-up tokens. The token structure can include metadata, such as unique identifiers (UIDs), creation timestamps, and/or links to related data sets. The smart contract specifies predefined rules for accessing and updating these tokens. The ledger interface 724 can process the smart contract to extract rules that define role-based access control (RBAC) permissions. For example, the smart contract can specify that at least one (e.g., each) third party can access their own data within the token structure. In some implementations, a third party entity can have access its own performance tokens stored in the token structure, such as in a passport associated with the cybersecurity status of an entity. The RBAC rules restrict other entities from viewing or modifying these tokens. Another example can include third party vendors having access to their own evaluation tokens that include the results of security assessments relevant to their services, without the ability to access data from other vendors.

The ledger interface 724 can configure the selected access data structure to enforce these RBAC permissions as extracted from the smart contract. That is, the configuration can include mapping the access permissions to the token structure, linking at least one (e.g., each) token type to the appropriate access control mechanisms. For example, performance tokens related to a particular third party can be linked to a role of the third party. Similarly, unified tokens related to internal compliance can be accessible by authorized roles within the organization itself (e.g., excluding third party access). The ledger interface 724 can integrate the configuration within the ledger system 730 to apply the rules of the control structure to token-related operations. The RBAC can facilitate access to tokens to entities or individuals that have been granted access or authorized to read, update, or add. For example, the control structure can use an access level of an entity or individual to determine whether to allow a user to read data but not update or add to the data (e.g., a third party insurer can access performance datasets on performance tokens linked to a passport of the prosecutive insured, but can be restricted from modifying certain performance data stored thereon), to have full rights (e.g., read/update/add, etc.), and so on. That is, the passport system 720 can provide an access level or permissions to a person or entity attempting to access or otherwise interact with tokenized data corresponding to a cyber resilience identity, and the access level/permissions can be used by the passport system 720 to restrict or allow the user or entity to perform various actions related to the tokens.

In some implementations, if the smart contract is modified, the ledger interface 724 can reconfigure the access data structures to match the updated RBAC rules. For example, if the smart contract is updated to change access permissions for a particular third party entity, the ledger interface 724 can adjust the RBAC configurations to reflect this change such that the access control mechanisms allows access and is consistent with the control structure. In some implementations, an access data structure can function as a token or another access control mechanism within the token structure. That is, the access data structure can facilitate operations, such as reading, writing, adding, or removing metadata objects associated with tokens in the cyber resilience identity (e.g., also operating and implemented as a token). For example, an access control token can link to other tokens representing performance, evaluation, or resilience data. The access control token can encapsulate the permissions for interacting with the tokens and can include metadata defining allowed operations and roles or entities authorized to perform at least one (e.g., each) operation. Additionally, an access data structure can implement write access to one or more metadata objects within the token structure. For example, an access control token can identify which entities have permission to update particular aspects of the cyber resilience identity, such as modifying performance metrics or altering the status of an evaluation token. Another access data structure can be used to manage read permissions, restricting a third party entity to viewing metadata associated with its own tokens within the structure without granting modification rights. In some implementations, an access control structure can function as a token that defines hierarchical permissions across multiple tokens. For example, a control structure token can specify that a designated role within an organization has the authority to add or remove tokens from the cyber resilience identity. Additionally, the access control token can be used to facilitate interactions with other tokens within the token structure to apply these permissions.

In some implementations, the ledger interface 724 can broadcast, using the control structure, the cyber resilience identity to a ledger or distributed ledger. That is, broadcasting can include publishing, sharing, or otherwise transmitting a passport (e.g., cyber resilience identity) of an entity. For example, the ledger interface 724 can transmit the cyber resilience identity to a blockchain or similar distributed ledger to maintain an immutable record of the cyber resilience identity and associated data. Additionally, the ledger interface 724 can store the cyber resilience identity locally (e.g., in a back-end database or other local data store). Further, the ledger interface 724 can transmit or send the cyber resilience identity (e.g., via a shareable link) to various entities, who can access a portion of the data corresponding with the cyber resilience identity but not access another portion of the data based on various access controls.

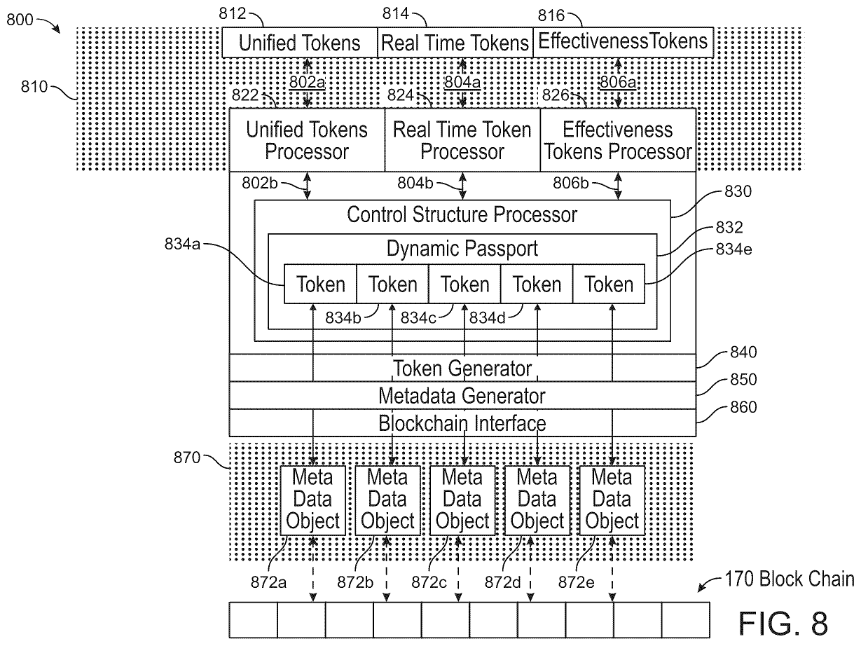

Referring now to FIG. 8, a block diagram 800 of an architecture of certain systems or devices of FIG. 7 is shown, according to some implementations. The implementation shown in FIG. 8 can include a token interface 810 including unified tokens 812, real-time tokens 814, and/or effectiveness tokens 816. The implementation shown in FIG. 8 can also include a smart contract control structure 820 including a unified token processor 822, a real-time token processor 824, and/or an effectiveness token processor 826. Further, the smart contract control structure 820 can include a control structure processor 830, a token generator 840, a metadata generator 850, and/or a blockchain interface 860. In some implementations, the control structure processor 830 can include a dynamic passport 832, and/or dynamic passport 832 can include tokens 834a-834e (collectively, 834). At least one (e.g., each) of the tokens 834 can be linked to a metadata interface 870 including one or more metadata objects 872a-872e (collectively, metadata objects 872). In some implementations, the implementation shown in FIG. 8 can include blockchain 170.

In some implementations, FIG. 8 depicts an example smart contract control structure 820. In some examples, the unified token processor 822, real-time token processor 824, and/or effectiveness token processor 826 can detect a presence of a token (fungible, non-fungible, partially-fungible, etc.), and can transmit the token to a compatibility processor (e.g., unified token processor 822, real-time token processor 824, effectiveness token processor 826) compatible with that particular token. The detection can be responsive to an action by the token interface 810 to transmit the tokens to the smart contract control structure 820. In some examples, the token interface 810 can include a communication channel between one or more of the smart contract control structure 820 and one or more of the unified tokens 812, real-time tokens 814, and/or effectiveness tokens 816. The token interface 810 can include an application programming interface compatible with the smart contract control structure 820 to detect various cyber resilience tokens. At least the token interface 810 or the smart contract control structure 820 can execute one or more instructions to determine whether one or more of the tokens are compatible with the smart contract control structure 820.

In some implementations, the unified token processor 822 can perform detection of unified tokens 812 via a link 802a or other communication channel (e.g., via a network such as network 120). The detection can be responsive to receiving a unified token from token system 726, client device 110, or third party devices 150, over link 802a. The unified token processor 822 can be configured to be compatible with a unified token 812, or can be generated to be compatible with a particular unified token 812. For example, the unified token processor 822 can be integrated with or store a hash based on a unified token 812 and a hash processor operable to generate a hash based on any unified token 812. The unified token processor 822 can generate a hash in response to detecting the presence of the unified token 812, and can determine whether the unified token 812 is compatible with the smart contract control structure 820 by comparing the generated hash with the stored hash. The unified token processor 822 can include logic to detect a unified token 812 passed to it, by, for example, a JSON object or a header argument. Additionally, the unified token processor 822 can provide the detected unified token to the control structure processor 830 via link 802b.

In some implementations, the real-time token processor 824 can perform detection of real-time tokens 814 via link 804a. The detection can be responsive to receiving a real-time token 814 from token system 726, client device 110, or third party devices 150, over link 804a. For example, the real-time token processor 824 can be integrated with or store a hash based on a real-time token 814 and a hash processor operable to generate a hash based on any real-time token 814. The real-time token processor 824 can generate a hash in response to detecting the presence of the real-time token 814, and can determine whether the real-time token 814 is compatible with the smart contract control structure 820 by comparing the generated hash with the stored hash. The real-time token processor 824 can include logic to detect a real-time token 814 passed to it, by, for example, a JSON object or a header argument. Additionally, real-time token processor 824 can provide the detected real-time token 814 to the control structure processor 830 via link 804a.

In some implementations, the effectiveness token processor 826 can perform detection of effectiveness tokens 816 via link 806a. The detection can be responsive to receiving an effectiveness token 816 from token system 726, client device 110, or third party devices 150, over link 806a. For example, the effectiveness token processor 826 can be integrated with or store a hash based on an effectiveness token 816 and a hash processor operable to generate a hash based on any effectiveness token 816. The effectiveness token processor 826 can generate a hash in response to detecting the presence of the effectiveness token 816, and can determine whether the effectiveness token 816 is compatible with the smart contract control structure 820 by comparing the generated hash with the stored hash. The effectiveness token processor 826 can include logic to detect an effectiveness token 816 passed to it, by, for example, a JSON object or a header argument. Additionally, the effectiveness token processor 826 can provide the detected effectiveness token 816 to the control structure processor 830 via link 806b.

In some implementations, the smart contract control structure 820 can include a control structure processor 830 configured to generate and/or store tokens 834. The tokens 834 can include one or more unified tokens 812, real-time tokens 814, and/or effectiveness tokens 816. That is, responsive to receiving one or more of the unified tokens 812, real-time tokens 814, and/or effectiveness tokens 816 from the unified token processor 822, real-time token processor 824, and/or/or effectiveness token processor 826, the control structure processor 830 can receive the tokens 834 via links 802b, 804b, and/or 806b. In some implementations, the control structure processor 830 can generate a container metadata object, such as a wrapper, where a control structure (e.g., a smart contract) is wrapped or otherwise linked to dynamic passport 832, which can further include links to metadata (e.g., stored data, fields, etc.) of tokens 834. For example, the dynamic passport 832 can be encapsulated in a container with a control structure and can generated by metadata generator 850 as part of the metadata interface 870. The container linking dynamic passport 832 and the control structure can provide access to the tokenized cyber information based on the control structure.

In some implementations, the control structure processor 830 can generate a dynamic passport 832 including a token with a link to (e.g., encapsulated in) a container. The link can be established via a digital signature or cryptographic hash that securely associates the dynamic passport 832 with corresponding metadata. The dynamic passport 832 can be provided to a metadata interface 870 such that a blockchain (e.g., blockchain 170) can verify and store the metadata securely on the chain. Additionally, the control structure processor 830 can encapsulate the dynamic passport 832 and tokens 834 within the smart contract control structure 820 to provide the container. For example, encapsulating can include encrypting the data and setting permissions for data access. That is, the encapsulation can restrict outputs of the container metadata object and the metadata objects 872. For example, when the dynamic passport 832 and tokens 834 are encapsulated, the control structure processor 830 can output when conditions or permissions are verified. In another example, when the dynamic passport 832 and tokens 834 are encapsulated in a container, the control structure processor 830 can output when a valid decryption key is presented. For example, the control structure processor 830 can authorize transactions after verifying that compliance and regulatory requirements are met based on data of the tokens 834.

In some implementations, the control structure processor 830 can be configured to perform segmentation or allocation of tokens 834 of the dynamic passport 832 based on parameters by accessing the metadata of a token and container and evaluating compliance with cyber resilience standards. Accordingly, the control structure processor 830 can automatically pool (or tranche) asset tokens (associated with underlying assets) based on parameters. For example, the parameters can be programmed into smart contracts of the control structure processor 830. For example, the dynamic passport 832 can include one or more segmented allocations of the tokens 834 (e.g., with token 834a and 834b segmented into an allocation and tokens 834c-834e segmented into another allocation). While not shown in FIG. 8, a segmented allocation smart contract control structure can be within the smart contract control structure 820 and be operated by the control structure processor 830. In some examples, this integration facilitates automated re-segmentation based on real-time data analysis. In another example, this integration facilitates compliance checks and performance tracking without external system intervention.

In some implementations, at least one (e.g., each) of the tokens 834 can include metadata objects 872. For example, links 809 can connect at least one (e.g., each) token 834 to a respective metadata object 872. In some examples, the metadata interface 870 can be utilized to connect at least one (e.g., each) token 834 to its metadata object 872. For example, the token 834a can be connected to the metadata object 872a via the link 809a, the token 834b can be connected to the metadata object 872b via the link 809b, and so on.

In some examples, the metadata interface 870 can include a communication channel between one or more of the tokens in the smart contract control structure 820 and metadata objects of blockchain 170. That is, metadata objects 872 can be accessed and verified through blockchain transactions to verify integrity and authenticity. Furthermore, blockchain 170 can store links to the metadata objects 872 or store the metadata objects 872 in blocks of the blockchain 170. For examples, the blockchain 170 can store the metadata objects 872 in blocks to verify that participants have consistent and unalterable access to the cyber resilience information stored in the tokens 834 of the dynamic passport 832.

In some implementations, the token interface 810 can include an application programming interface compatible with the smart contract control structure 820 to detect various cyber resilience tokens. In some examples, at least the token interface 810 or the smart contract control structure 820 can execute one or more instructions to determine whether one or more of the tokens (e.g., tokens 834 or corresponding unified tokens 812, real-time tokens 814, and/or effectiveness tokens 816) are compatible with the smart contract control structure 820.

In some implementations, the token generator 840 (e.g., token system 726) can generate one or more tokens (e.g., fungible, semi-fungible, or non-fungible tokens, collectively referred to herein as “controllable electronic records”) in accordance with a token obtained at one or more of the unified token processor 822, real-time token processor 824, and/or effectiveness token processor 826. For example, the token generator 840 can generate tokens based on a number of new metadata objects indicated by an obtained token, and linked with respective smart contract control structures. For example, the token generator 840 can generate a cyber resilience identity (e.g., dynamic passport 832) with links to one or more tokens at least one (e.g., each) linked with a particular smart contract control structure 820 with which the respective token is compatible. The token generator 840 can thus generate a corresponding number of keys that can control restrictions on output by the particular metadata object linked with the particular smart contract control structure compatible with the particular token. The token generator 840 can modify and delete tokens (e.g., tokens 834) linked with cyber resilience identity (e.g., dynamic passport 832), to update control of a partial distribution or exchange of metadata object control.

In some implementations, the metadata generator 850 can generate one or more metadata objects (e.g., metadata objects 872) in accordance with a token obtained at one or more of the unified token processor 822, real-time token processor 824, and/or effectiveness token processor 826 (e.g., at a compatibility processor). That is, the metadata object can include metadata of cyber resilience data. For example, metadata generator 850 can generate multiple tokens based on a number of new metadata objects linked with respective smart contract control structures and encapsulated in a container with a cyber resilience identity (e.g., passport). For example, the metadata generator 850 can generate one or more metadata objects 872 at least one (e.g., each) linked to respective tokens 834 and further linked, via the tokens 834, to the dynamic passport 832 with a particular smart contract control structure 820 by which the metadata object co is controlled. In some examples, the metadata generator 850 can modify and delete metadata objects linked with tokens or smart contract control structures to update control of a partial transfer of metadata object control. Further, the metadata generator 850 can modify and/or update tokens and/or associated information of existing tokens (e.g., tokens 834) corresponding to a cyber resilience identity (e.g., dynamic passport 832).

In some implementations, the blockchain interface 860 can include an API compatible with the blockchain 170 via metadata generator 850. The blockchain interface 860 can selectively add, modify, and/or delete blocks from the blockchain 170. The blockchain interface 860 can add, modify, and/or delete blocks in accordance with restrictions or interfaces of the blockchain 170, and/or can add, modify, and/or delete blocks independently of the restrictions or interfaces of the blockchain 170 at any portion or index of the blockchain 170.

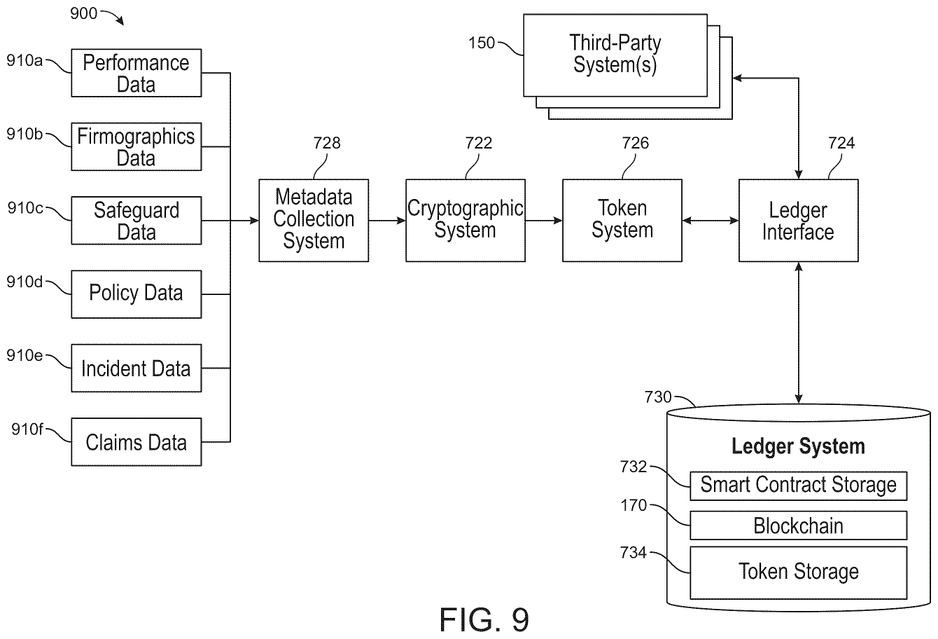

Referring now to FIG. 9, a block diagram 900 of an architecture of certain systems or devices of FIG. 7 is shown, according to some implementations. The implementation shown in FIG. 9 includes third party devices 150 and ledger system 730. The ledger system 730 can include smart contract storage 732, blockchain 170, and/or token storage 734. The implementation shown in FIG. 9 can also include metadata collection system 728, cryptographic system 722, token system 726, and/or ledger interface 724. The implementation shown in FIG. 9 can also include performance data 910a, firmographics data 910b, safeguard data 910c, policy data 910d, incident data 910e, and/or claims data 910f (collectively, cyber resilience data 910).

In some implementations, the metadata collection system 728 can receive or identify cyber resilience data 910. For example, the metadata collection system 728 can collect or retrieve performance data 910a (e.g., metrics related to cybersecurity incidents or system performance), firmographics data 910b (e.g., company size, industry type, or geographic location), safeguard data 910c (e.g., implemented security controls or measures), policy data 910d (e.g., security policies or compliance requirements), incident data 910e (e.g., records of security breaches or system failures), and/or claims data 910f (e.g., insurance claims or risk assessments) of an entity or organization. In some examples, the metadata collection system 728 can integrate data from various cybersecurity tools and databases (e.g., third party devices 150, blockchain 170, etc.) to compile a cyber resilience dataset. In some implementations, the metadata collection system 728 can provide the received or identified cyber resilience data to the cryptographic system 722.

In some implementations, the cryptographic system 722 can encrypt a portion of the cyber resilience data. For example, the cryptographic system 722 can apply symmetric encryption algorithms (e.g., AES) to secure sensitive data such as performance data 910a or firmographics data 910b. In another example, the cryptographic system 722 can use asymmetric encryption techniques (e.g., RSA) to protect keys and authentication credentials. Further, the cryptographic system 722 can implement hashing algorithms (e.g., SHA-256) to verify the integrity of the data by generating unique hash values for at least one (e.g., each) data record. In some implementations, the cryptographic system 722 can provide the portion of encrypted cyber resilience data to the token system 726.

In some implementations, the token system 726 can generate a metadata object including metadata of cyber resilience data. For example, the token system 726 can create metadata objects that encapsulate encrypted performance data, safeguard records, and/or compliance data. In some implementations, the token system 726 can include additional metadata such as timestamps, data sources, and/or integrity checks. In some implementations, the token system 726 can generate a cyber resilience identity including at least a link with the metadata object, a unique identifier (UID), and/or a performance event dataset. For example, the cyber resilience identity can include a UID to uniquely identify the entity, a link to a metadata object (e.g., data of one or more tokens), and/or include a dataset with performance events or incidents. In some implementations, the token system 726 can encapsulate the cyber resilience identity within a control structure restricting one or more updates and redemptions of the metadata object. The control structure can be a data structure or other system including a cyber resilience identifier (e.g., passport) with linked tokens and restricting accessing to metadata object (e.g., data) of certain tokens. In some implementations, the token system 726 can determine at least one access data structure being compatible with the control structure. For example, the token system 726 can utilize various access management techniques, such as access control lists (ACLs), role-based access controls (RBACs), or attribute-based access controls (ABACs), to verify that the access data structure aligns with the permissions and restrictions defined within the control structure. The passport system 720 can assess these access data structures to determine whether the structures comply with predefined standards or policies (e.g., determining whether an entity or authorized user has the appropriate credentials or attributes to access, modify, or update the metadata objects encapsulated within the control structure). Additionally, the token system 726 can dynamically adjust the access parameters based on changes in roles, permissions, or security requirements such that the control structure remains consistent with the evolving access needs of various entities and users involved in managing or interacting with the cyber resilience identity.

In some implementations, access controls, such as role-based access controls (RBACs) or access parameters, can be implemented in various forms to manage permissions for entities interacting with the metadata object (e.g., token). Access controls can include any method or mechanism that limits, restricts, or authorizes access to certain data based on predefined criteria. Examples of access controls could involve establishing rules that dictate who can view, modify, or delete data elements within the metadata object or cyber resilience identity. Such controls can be used to regulate access across different entities, such as allowing a third party like an insurer to view certain data, modify data, or be restricted from accessing other sensitive data. These access controls can also be configured within a broader access management framework, such as ACLs or RBACs, that dynamically adapts to the roles and permissions associated with different users or systems.

In some implementations, the token system 726 can generate a cyber resilience identity including at least a link with the metadata object, a unique identifier (UID), and/or a performance event dataset. For example, the cyber resilience identity can incorporate a UID to uniquely identify the entity, link to the metadata object to reference encrypted data, and/or include a dataset detailing performance events or incidents. The token system 726 can encapsulate the cyber resilience identity within a control structure restricting one or more updates and redemptions of the metadata object. Further, the token system 726 can determine at least one access data structure that aligns with the control structure. For example, the token system 726 can use access control lists or role-based access controls to verify alignment with the control structure for control over which data elements can be accessed or modified by different entities. In some implementations, the ledger interface 724 can broadcast, using the control structure, the cyber resilience identity to a ledger or distributed ledger. For example, the ledger interface 724 can interact with the ledger system 730, including smart contract storage 732, blockchain 170, and/or token storage 734, to submit the cyber resilience identity and associated metadata and publish the cyber resilience identity to blockchain 170. In some examples, the ledger interface 724 can also communicate with third-party devices 150 to share and verify the cyber resilience identity across different platforms and networks (e.g., to transmit to a vendor or insurer).

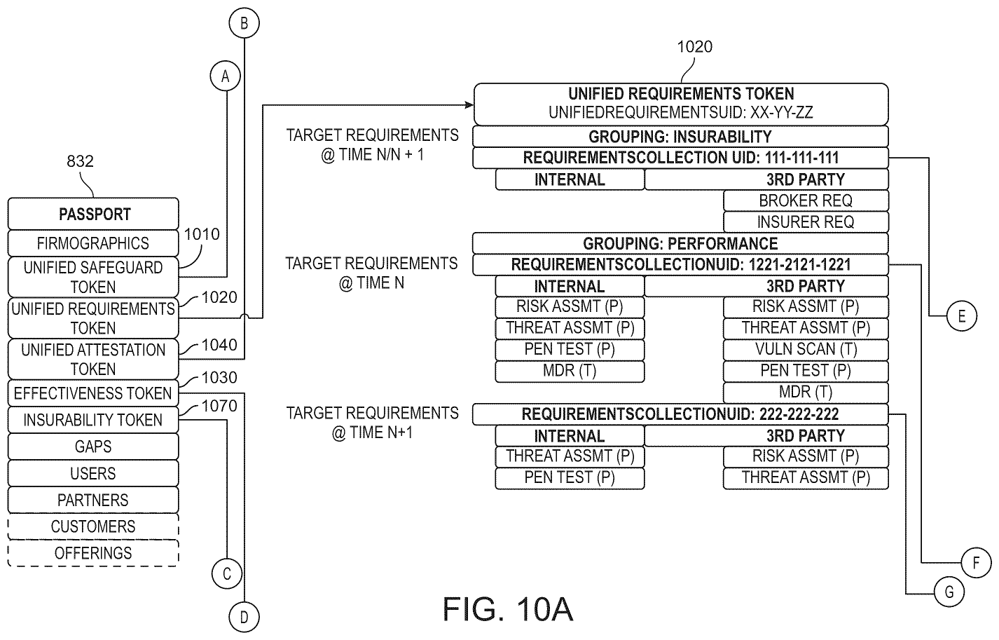

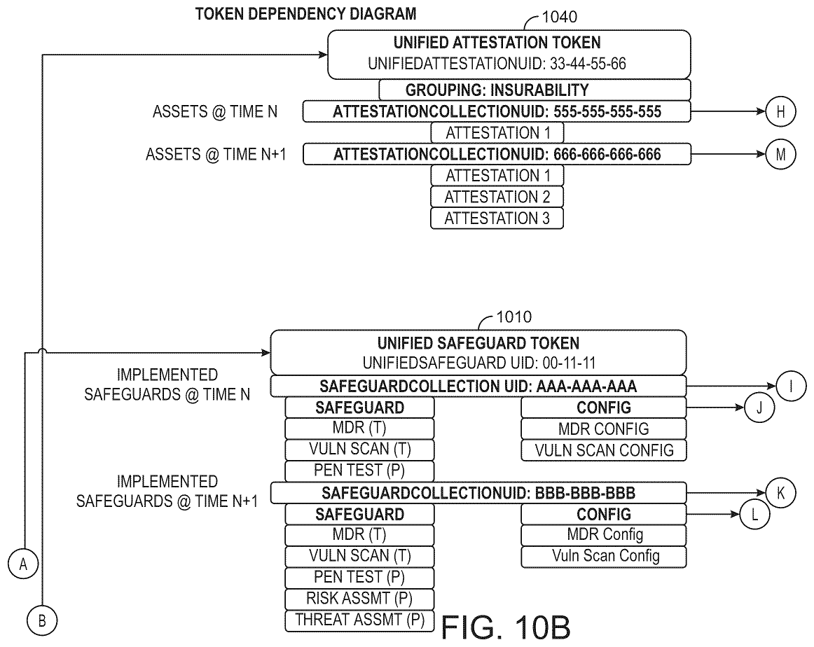

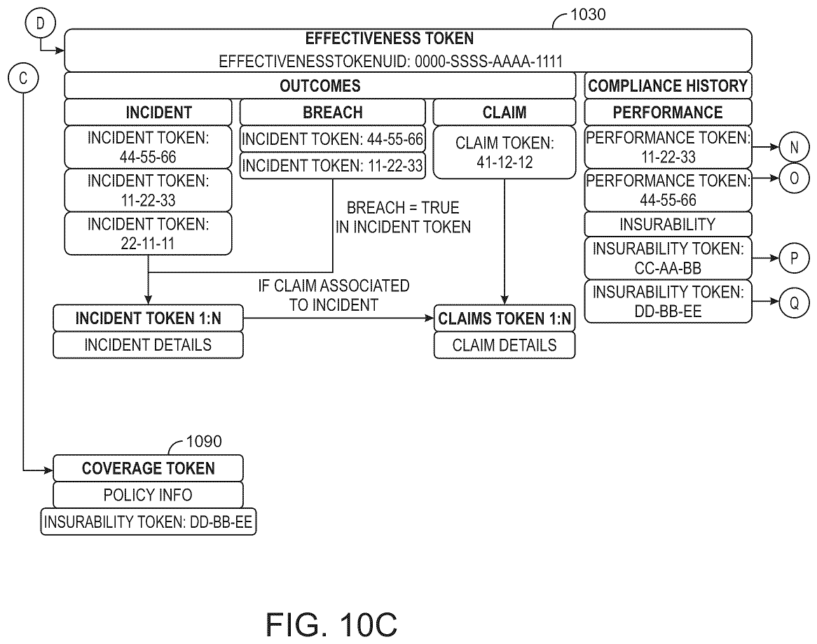

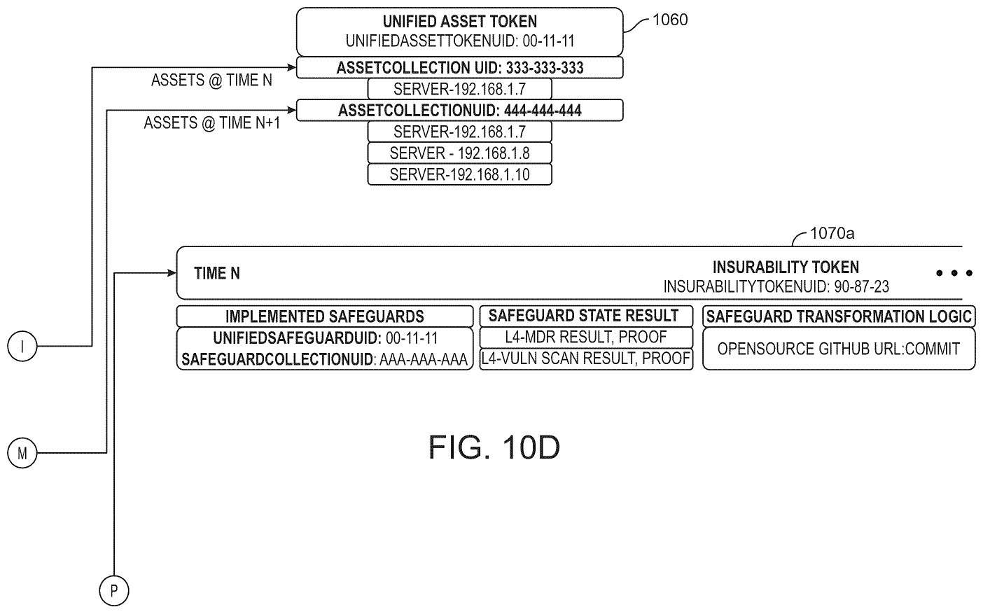

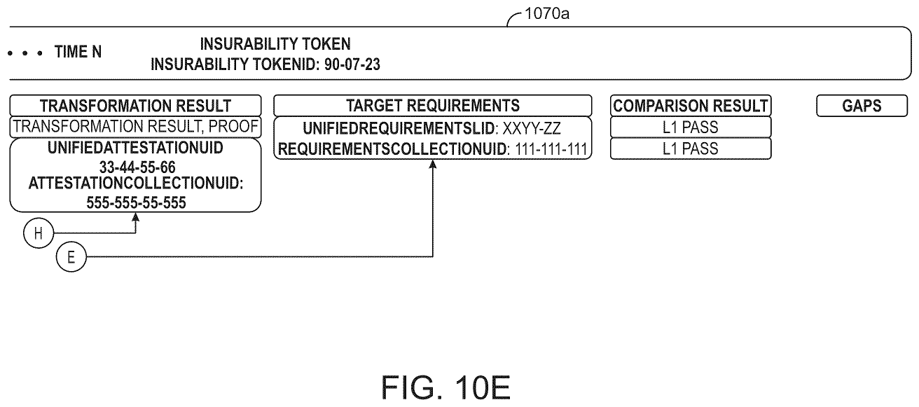

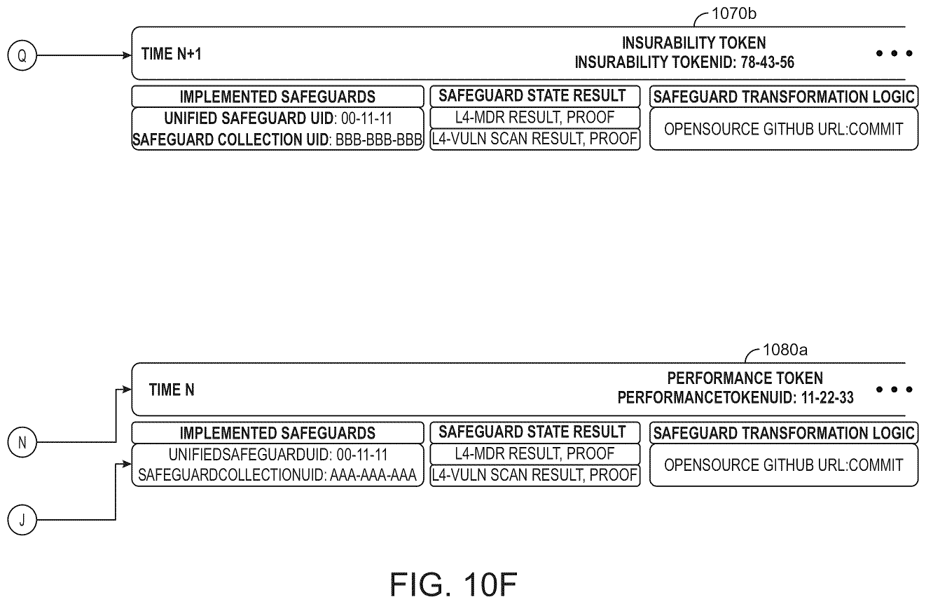

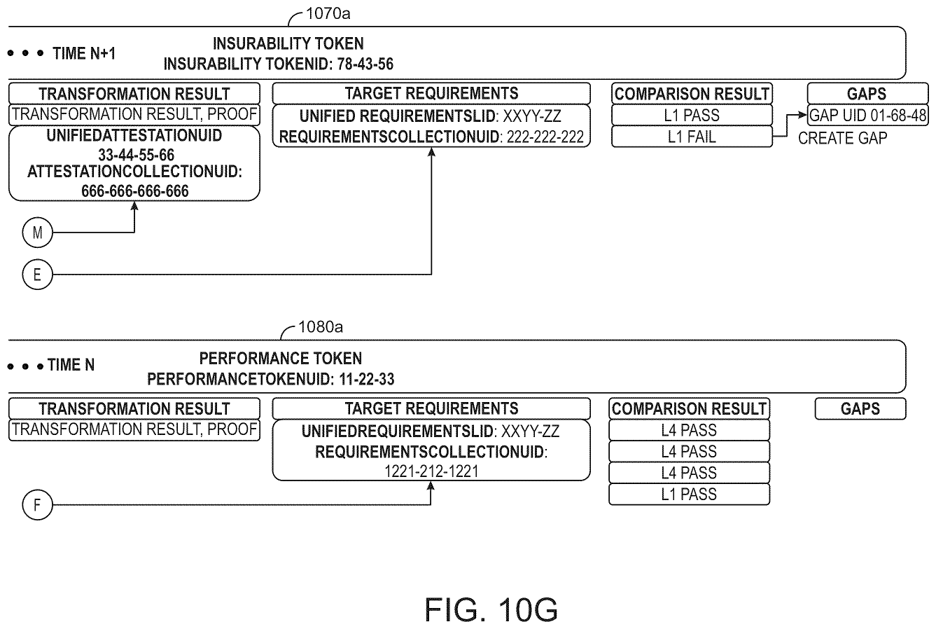

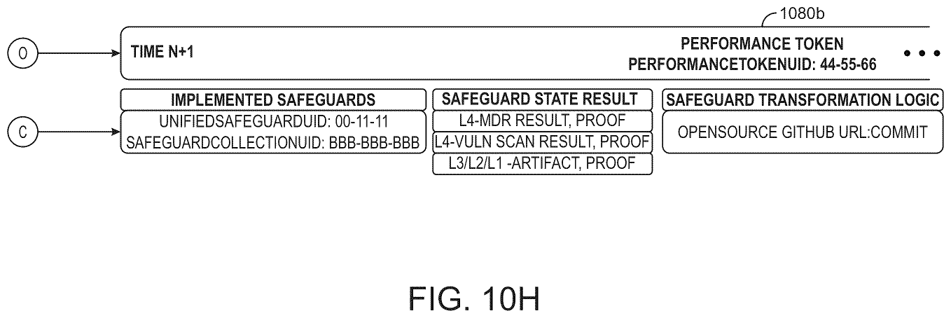

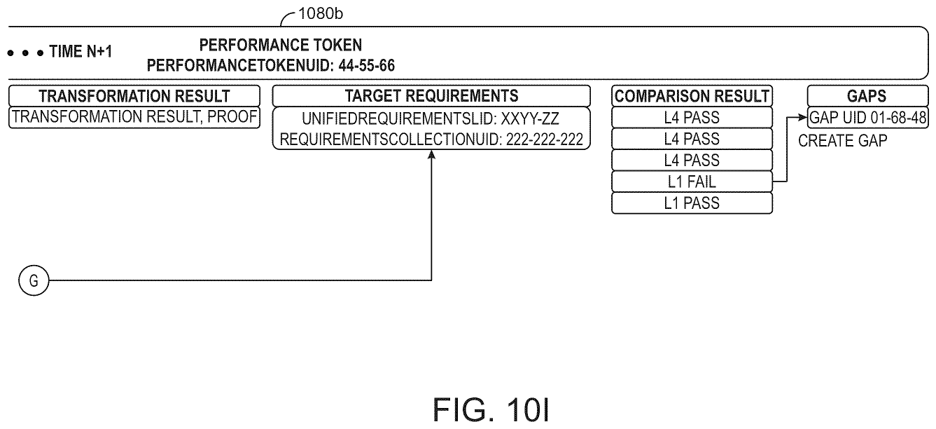

Referring generally to FIGS. 10A-10I, an architecture for tokenized cyber resilience data is shown, according to some implementations. Referring now to FIG. 10A, the dynamic passport 832 can include various cyber resilience data, such as firmographics data, unified safeguards token 1010, unified requirements token 1020, unified attestation token 1040, effectiveness token 1030, insurability token 1070a, gap information, users, partners, customers, offerings, and so on. In some examples, the unified safeguards token 1010 can receive data/be linked with other systems or data via point A, the unified attestation token 1040 can receive data/be linked with other systems or data via point B, the effectiveness token can receive data/be linked with other systems or data via point C, and the insurability token 1070a can receive data/be linked with other systems or data via point D, as further described herein. In some implementations, entities can interact with and/or access the dynamic passport 832 and/or linked tokens (e.g., unified safeguards token 1010, unified requirements token 1020) based on various rules (e.g., access controls with various access parameters).

In some implementations, FIG. 10A illustrates tokenized cyber security data over various times (e.g., time N/N+1, time N, time N+1, etc.). In some implementations, unified tokens (e.g., unified safeguards token 1010, unified requirements token 1020, unified attestation token 1040, etc.) can store metadata of cyber resilience data over a time period. For example, the unified requirements token 1020 can be generated by the token system 726 and can include a unified requirements UID and an insurability grouping with grouped cyber resilience data. In another example, the unified requirements token 1020 can include a first requirements collection UID corresponding to requirements (e.g., cyber resilience standards for a policy) at a first time (e.g., time N/N+1), which can be linked with other systems/and or data via point E, as further described herein. In another example, the unified requirements token 1020 can include a second requirements collection UID corresponding to requirements at a second time (e.g., time N+1), which can be linked with other systems/and or data via point F, as further described herein. Still yet, in another example, the unified requirements token 1020 can include a third requirements collection UID corresponding to requirements at a third time (e.g., time N), which can be linked with other systems/and or data via point G, as further described herein. For example, the first, second, and/or third UID can correspond to various internal and/or third party cyber resilience requirements at different times, such as risk assessment data, threat assessment data, other testing data, MDR data, pen test data, vulnerability scan data, broker requirements, insurer requirements, and so on.

Referring now to FIG. 10B, the unified attestation token 1040 can be linked to the dynamic passport 832 via point A. As described regarding the unified requirements token 1020, the unified attestation token 1040 can include groupings and/or data corresponding to attestations at various times. For example, the unified attestation token 1040 can be generated by the token system 726 and can include an insurability grouping with a first attestation collection UID corresponding with assets (e.g., attestation 1) at a first time (e.g., time N), and the first attestation collection UID can be linked with other systems/data via point H. Further, the unified attestation token 1040 can include a second attestation collection UID corresponding with assets (e.g., attestation 1, attestation 2, attestation 3, etc.) at a second time (e.g., time N+1), and the second attestation collection UID can be linked with other systems/data via point M. In some implementations, the unified safeguard token 1010 can be linked to the dynamic passport 832 via point B. For example, as described above, the unified safeguard token 1010 can include groupings and/or data corresponding to safeguards at various times. For example, the unified safeguard token 1010 can include a first safeguard collection UID corresponding with safeguards (e.g., MDR, vulnerability scans, penetration test rules, etc.) at a first time (e.g., time N), and the first safeguard collection UID can be linked with other systems/data via point I. The unified safeguard token 1010 can further include a first configuration, which can be linked to other data/systems via point J and include data corresponding to cyber resilience systems and/or protection techniques implemented in the cyber resilience architecture (e.g., MDR configurations, vulnerability scan configurations, etc.) of the organization. Further, the unified safeguard token 1010 can include a second safeguard collection UID corresponding with safeguards implemented at a second time (e.g., time N+1), and the second attestation collection UID can be linked with other systems/data via point K. The unified safeguard token 1010 can further include a second configuration, which can be linked to other data/systems via point L.

Referring now to FIG. 10C, a coverage token 1090 can be linked to the dynamic passport 832 via point C. In some examples, the coverage token 1090 can be generated by the token system 726 can include cyber protection information such as policy information (e.g., policy number, type, etc.) and various tokens including insurability information (e.g., an insurability token). In some implementations, the effectiveness token 1030 can be linked to the dynamic passport 832 via point D. The effectiveness token 1030 can include various data corresponding to cyber resilience outcomes, such as incident data (e.g., via incident tokens 1 through N), corresponding breach data (e.g., via incident tokens 1 through N), and corresponding claims data or data (e.g., via claims tokens 1 through N associated with incident tokens 1 through N). In some implementations, the effectiveness token 1030 can include various data corresponding to cyber resilience compliance history, such as performance data. For example, the performance data can include multiple performance tokens including respective timestamps or identifiers corresponding to cyber resilience performance of an entity during one or more incidents/breaches or claims associated with incident tokens and/or claims tokens, and the performance tokens (e.g., performance tokens 1080a-1080b) can be linked to other data/systems via point N and point O. In some implementations, the effectiveness token 1030 can include insurability data, such as one more insurability tokens (e.g., received via coverage token 1090). In some examples, the insurability tokens (e.g., insurability tokens 1070a-1070b) can be linked to other data/systems via point P and point Q.

Referring now to FIG. 10D, the dynamic passport 832 can be linked to the unified asset token 1060 via point I and/or via point M. For example, the unified asset token 1060 can be generated by the token system 726 and can include a first grouping of assets (e.g., server identifier 1) at a first time (e.g., time N) and a second grouping of assets (e.g., server identifier 1, server identifier 2, server identifier 3, etc.) at a second time (e.g., time N+1). In some implementations, the insurability token 1070a can be linked to the dynamic passport 832 via point P with the effectiveness token 1030. For example, the insurability token 1070a can include insurability data at a first time (e.g., time N), such as implemented safeguards and associated identifiers, safeguard state results (e.g., L4-MDR result and proofs, L4-vulnerability scan results and proofs), and/or safeguard transformation logic (e.g., accessible via a URL or other link). Referring now to FIG. 10E, the insurability token 1070a can further include a transformation result and/or proof, which can be linked via UIDs to point H with the unified attestation token 1040. The insurability token 1070a can further include target requirements, which can be linked via UIDs or other identifiers with the unified requirements token 1020. The insurability token 1070a can further include comparison results (e.g. L1) pass, gap data (e.g., data of missing and/or inadequate cyber protections), and more.

Referring now to FIG. 10F, the dynamic passport 832 can be linked to the insurability token 1070b via point Q. As shown in FIG. 10F, the insurability token 1070b can be generated by the token system 726 and can include insurability data at a second time (e.g., time N+1), such as implemented safeguards and associated identifiers, safeguard state results, and/or safeguard transformation logic. For example, the insurability token 1070b can include encrypted data of implemented safeguards, such as firewall configurations or endpoint protection settings, verified against cyber resilience requirements. The encrypted data can be encapsulated within a control structure configured to restrict updates or access based on cryptographic proofs, allowing authorized entities (e.g., those with permitted access based on RBACs) to modify, create, view, and/or retrieve the data in accordance with access controls defined for the dynamic passport 832. In some implementations, the dynamic passport 832 can be linked to the performance token 1080a via point N with the effectiveness token 1030. In some examples, the performance token 1080a can include performance data of an entity at a first time (e.g., time N), including implemented safeguards, results, transformation logic, and so on. In some implementations, the implemented safeguards can be linked, via point J, with a configuration of the unified safeguard token 1010.

Referring now to FIG. 10G, the insurability token 1070b can further include a transformation result and/or proof, which can be linked via UIDs to point M with the unified attestation token 1040. In some implementations, the insurability token 1070b can be generated by the token system 726 and can further include target requirements, which can be linked via UIDs or other identifiers with the unified requirements token 1020 via point E. Further, the insurability token 1070a can further include comparison results (e.g. L1 pass/fail), gap data (e.g., gap UIDs), and so on. In some implementations, the performance token 1080a can further include transformation results and/or proofs, comparison results (e.g., L4 pass/fail), and gaps. Further, the insurability token 1070b (or another token) can store cryptographic proofs of provenance corresponding with and entity and/or associated cyber resilience data. In some examples, the performance token 1080a can include target requirements and associated IDs, accessible via point F, from the unified requirements token 1020.

Referring now to FIG. 10H, the dynamic passport 832 can be linked to the performance token 1080b via point O with the effectiveness token 1030. In some examples, the performance token 1080b can be generated by the token system 726 and can include performance data of an entity at a second time (e.g., time N+1), including implemented safeguards, results, transformation logic, and so on. For example, the performance token 2080a and the performance token 2080b can include performance data sets encapsulated within a control structure corresponding to the dynamic passport 832, and access to data of the performance tokens 1080a-1080b can be granted based on a specific access data structure compatible with a control structure (e.g., allowing authorized entities to retrieve and/or update metadata of the performance token 1080b based on access controls, restricting access and/or updates to the performance data based on access controls, etc.). In some implementations, the implemented safeguards can be linked, via point L, with a configuration of the unified safeguard token 1010. Referring now to FIG. 10I, the performance token 1080b can further include transformation results and/or proofs, comparison results, and gaps. The performance token 1080b can also include target requirements and identifiers received via point G with the unified requirements token 1020.

### End Point Integration and Mapping

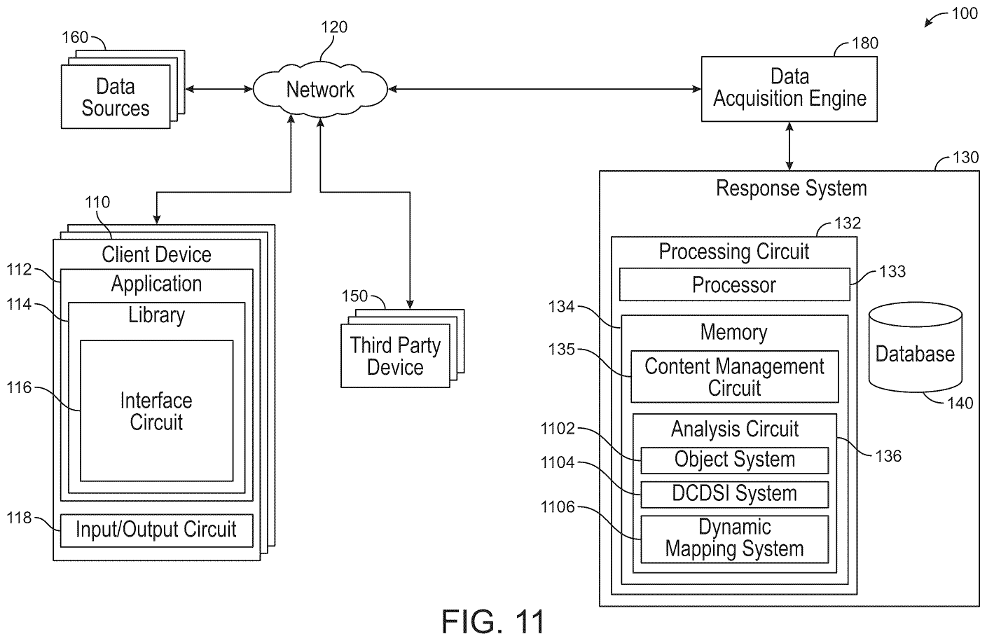

Referring to FIG. 11, a block diagram of an implementation of a system for endpoint integration and mapping is shown, according to some implementations. The implementation shown in FIG. 11 includes a client device 110 (also referred to herein as “client devices 110” and/or “user computing system(s) 110”), response system 130, third party device 150 (also referred to herein as “third party system(s) 150” and/or “third party devices 150”), data sources 160, and/or data acquisition engine 180. The various components of FIG. 11 can be interconnected through a network 120 that supports secure communications profiles (e.g., TLS, SSL, HTTPS, etc.). In some implementations, the elements shown in FIG. 11 can incorporate similar features and functionality as described regarding the elements shown on FIG. 1A and/or FIG. 7. For example, the response system 130, as shown in FIG. 11, incorporates similar functionality as described regarding the response system 130 of FIG. 1A, and the database 140, can incorporate the same or similar functionality as described regarding the database 140 of FIG. 1A, and so on. Specifically, like callout references of FIG. 1A are now further described, however the features and functionalities of components like the response system 130 in FIG. 11 still correspond to those referred to with the same callout reference in FIG. 1A. For example, response system 130 described in FIG. 11 can include additional functionality and features related to endpoint integration and mapping (also referred to herein as “linking”).

In some implementations, the client device 110 can include an application 112 and an input/output circuit 118. The application 112 can include a library 114, and the library 114 can include an interface circuit 116. In some implementations, the response system 130 can include a processing circuit 132 and a database 140. The processing circuit 132 can include a processor 133 and memory 134. The memory 134 can further include a content management circuit 135 and an analysis circuit 136. In some implementations, the analysis circuit 136 can include an object system 1102, a DCDSI system 1104, and/or dynamic mapping system 1106, as further described herein.

At least one (e.g., each) system or device of FIG. 11 can include one or more processors, memories, network interfaces (sometimes referred to herein as a “network circuit”) and user interfaces. The memory (e.g., memory 134) can store programming logic (e.g., content management circuit 135) that, when executed by the processor, controls the operation of the corresponding computing system or device. The memory can also store data in databases. For example, memory can store programming logic that when executed by a processor within a processing circuit, causes a database to update parameters or store a system or event log. The network interfaces can allow the computing systems and devices to communicate wirelessly or otherwise. The various components of devices in system 100 can be implemented via hardware (e.g., circuitry), software (e.g., executable code), or any combination thereof. Devices, systems, and/or components in FIG. 11 can be added, deleted, integrated, separated, and/or rearranged in various implementations of the disclosure.

Generally, the client device 110, response system 130, third party devices 150, analysis circuit 136, object system 1102. DCDSI system 1104, and/or dynamic mapping system 1106 can include one or more logic devices, which can be one or more computing devices equipped with one or more processing circuits that run instructions stored in a memory device to perform various operations. The processing circuit can be made up of various components such as a microprocessor, an ASIC, or an FPGA, and the memory device can be any type of storage or transmission device capable of providing program instructions. The instructions can include code from various programming languages commonly used in the industry, such as high-level programming languages, web development languages, and/or systems programming languages. The client device 110, response system 130, and/or other various components of FIG. 11 can also include one or more databases for storing data that receive and provide data to other systems and devices on the network 120.

In some implementations, one or more elements of FIG. 11 can be communicably coupled (connected) to a distributed ledger (e.g., blockchain 170 of FIG. 1B) or other authoritative data source to provide data integrity and security. For example, as described above regarding FIG. 1A, the database 140 can be a private ledger and data source 160 can be a public ledger, and data transactions (e.g., updates to proof/posture state data, cybersecurity parameters, entity data, etc.) recorded on the database 140 can be validated against entries recorded on the data source 160 to verify that updates to entries are accurately reflected and can be audited against an immutable record. In some implementations, the application 112 can be configured to integrate with technology and databases (e.g., database 140, response system 130, etc.) to access information used synchronizing or protecting data. The user can access the application 112 through a variety of devices, including client device 110. In some implementations, the response system 130 is operably connected to data acquisition engine 180 and includes analysis circuit 136 for endpoint integration and mapping.

In some implementations, third party devices 150 can include one or more endpoints. For example, third party devices 150 can include vendor endpoints, insurer systems, cloud service providers, threat intelligence platforms, or other external systems. Third party devices 150 can include various application programming interfaces (APIs) and can integrate with response system 130 to exchange data and improve the security posture of an organization. For example, third party devices 150 can communicate with the analysis circuit 136 of the response system 130 using a data communication link (e.g., network 120) maintaining the confidentiality and integrity of data transmitted between third party devices 150 and response system 130. Further, the third party devices 150 can provide a response to an endpoint call addressed to one or more of the third party devices 150 (e.g., a call performed by analysis circuit 136, etc.). In some examples, the data received from third party devices 150 can be processed by the response system 130 and/or analysis circuit 136 to assess and address potential cybersecurity threats.

In some implementations, third party devices 150 can include data sources that provide cybersecurity-related information to response system 130. For example, third party devices 150 could include cloud-based security services, threat intelligence platforms, or other external systems that monitor and report on cybersecurity incidents. The data provided by third party devices 150 can be integrated into response system 130 via dynamic mapping system 1106, which can map the received data to relevant cybersecurity parameters within the infrastructure of the organization. Additionally, third party devices 150 can operate in conjunction with DCDSI system 1104 to perform automated cybersecurity tasks. For example, third party devices 150 can response to DCDSI calls and execute various tasks (e.g., detecting threats, initiating a security audit, updating access controls, executing remediation protocols, etc.). DCDSI system 1104 can facilitate interaction between third party devices 150 and the internal systems of the organization by transmitting the appropriate data and commands (e.g., to integrate endpoint data and/or access information with the internal cybersecurity framework of the organization.

In some implementations, the response system 130 can execute various processes and/or functions for endpoint mapping and integrations. In some implementations, the response system 130 can include one or more processing circuits 132, including processor(s) (e.g., processor 133) and memory (e.g., memory 134). The memory 134 can have instructions stored thereon that, when executed by processor(s), cause the one or more processing circuits 132 to perform the various operations described herein. The operations described herein can be implemented using software, hardware, or a combination thereof. The processor(s) 133 can include a microprocessor, ASIC, FPGA, etc., or combinations thereof. In many implementations, the processor(s) 133 can be a multi-core processor or an array of processors. Memory 134 can include, but is not limited to, electronic, optical, magnetic, or any other storage devices capable of providing processor(s) with program instructions. The instructions can include code from any suitable computer programming language.

In some implementations, the response system 130 can include various systems and/or subsystems for endpoint mapping and integration, including analysis circuit 136. In some implementations, the analysis circuit 136 can identify one or more decentralized compute and data store interface (DCDSI) endpoints and corresponding access information. That is, identifying can include the analysis circuit 136 determining, locating, or categorizing decentralized interfaces across various platforms, such as APIs, blockchain nodes, cloud services, or other external systems that interact with cyber resilience data (e.g., insurer data, customer data, etc.). For example, the analysis circuit 136 can identify APIs provided by external services to be integrated into the cybersecurity infrastructure of the organization. Additionally, the analysis circuit 136 can extract access credentials and endpoint addresses from a third party security documentation of the service.

In some implementations, the analysis circuit 136 can generate an object package corresponding to the one or more DCDSI endpoints. That is, generating can include the analysis circuit 136 forming, initializing, calling, or otherwise creating a data structure that includes operations and information to interact with various types of decentralized compute and data store interface (DCDSI) endpoints. For example, in generating the object data package, the analysis circuit 136 can further initiate the object package based on an identifier corresponding to at least one DCDSI endpoint type (e.g., based on an insurer type). Additionally, the analysis circuit 136 can initiate an object package configured for a cloud storage API endpoint, structuring methods of the object package according to the endpoint. In another example, the analysis circuit 136 can initiate an object package for a blockchain endpoint that follows the protocols and data formats of the blockchain network. In some implementations, the object package is structured according to the at least one DCDSI endpoint type (e.g., vendor API endpoint, insurance API endpoint, cybersecurity tool endpoint, blockchain endpoint, cloud storage endpoint, or any other endpoint category). That is, the object package can include data formatting rules and access protocols customized to a category (e.g., user, insurer, administrator, third party service, or any system) corresponding to the identified DCDSI endpoint (e.g., a template/workflow based on an endpoint type).

In some implementations, in generating the object data package, the analysis circuit 136 can further map, in the object package, the access information to an access scheme corresponding to one or more formatted requests to access the one or more DCDSI endpoints. That is, mapping can include the analysis circuit 136 linking, providing, and/or associating access parameters and credentials with the corresponding data structure to facilitate communication with the identified DCDSI endpoints. For example, the analysis circuit 136 can map API request parameters (e.g., query strings, authentication keys, endpoint addresses, request methods, or any request parameter) and authentication tokens (e.g., OAuth tokens, API keys, session tokens, or any security credential) to a predefined access scheme for a cloud storage endpoint. In another example, the analysis circuit 136 can configure the object package to include headers and payload structures for a blockchain API call. In some implementations, the one or more formatted requests correspond with requesting protection data. Additionally, the formatted requests can include API calls to retrieve security policies, access logs, or threat intelligence from a decentralized data store.

Generally, a DCDSI endpoint can refer to any interface that allows decentralized computation or data storage across various categories. That is, the DCDSI endpoint can be a vendor API endpoint (or access point), insurance API endpoint (or access point), a cybersecurity tool interface, a blockchain node, a cloud service API, a distributed database, a peer-to-peer network interface, an edge computing node, a remote procedure call endpoint, or any distributed computing interface or third party endpoint interface. For example, a first DCDSI endpoint can be a vendor API endpoint. In another example, a second DCDSI endpoint can be an insurer API endpoint.

In some implementations, an object package can refer to a structured data payload configured to facilitate communication with an endpoint based on its category (or type, protocol, function). That is, the object package can be a configuration file, an API request template, a serialized data object, a command set, an executable script, or any structured data format dynamic to the endpoint type. For example, a first object package can be a JSON configuration file for insurance API integration. In another example, a second object package can be a serialized command object for blockchain transaction execution. In some implementations, a header of an object package can be a metadata segment that contains information about the package contents. For example, a header can be an API version identifier, a content-type specifier, a security token, a timestamp, or any metadata field. Additionally, a payload structure of an object package can be the data to be processed by the endpoint. For example, a payload structure can be a JSON object, an XML document, a binary data stream, a command list, or any structured data format.

In some implementations, an access scheme can refer to a predefined method for gaining access to an endpoint based on its category. That is, the access scheme can be an authentication protocol, a permission set, a session management routine, an API call sequence, a data retrieval strategy, or any access control method specific to the endpoint type. For example, a first access scheme can be OAuth-based token authentication for a cybersecurity tool. In another example, a second access scheme can be an API key verification process for an insurance API.

In some implementations, a formatted request can refer to a structured query or command sent to an endpoint based on its category. That is, the formatted request can be an HTTP GET request, a SQL query, a blockchain transaction, a remote procedure call, a file upload command, or any data retrieval or submission command suited to the endpoint type. For example, a first formatted request can be an HTTP POST request with JSON payload for an insurance API. In another example, a second formatted request can be a blockchain transaction submission.

In some implementations, the analysis circuit 136 can further perform a DCDSI endpoint request. In some implementations, the analysis circuit 136 can further perform a DCDSI endpoint request. That is, performing the DCDSI endpoint request can include accessing various decentralized interfaces, such as APIs, smart contracts, or blockchain nodes, to retrieve or verify data. For example, to perform the DCDSI endpoint request, the analysis circuit 136 can initiate an API call to a third party service to retrieve encrypted data logs or verify the integrity of transaction records. Additionally, in performing the DCDSI endpoint request, the response system 130 can access other decentralized endpoints, including cloud-based services or distributed ledgers, to process or store cybersecurity-related data. In some implementations, the analysis circuit 136 can initiate an API call to a third party API (e.g., insurer API) to retrieve encrypted data logs. In another example, the analysis circuit 136 can perform a request to a blockchain-based service to verify the integrity of transaction records.

In some implementations, in performing the DCDSI endpoint call, the analysis circuit 136 can invoke the object package to execute the DCDSI endpoint request using at least one formatted request of the one or more formatted requests. That is, invoking the object package can include calling methods within the object package that interact with decentralized endpoints, such as APIs, blockchain services, or cloud-based systems, to initiate data retrieval or processing operations. For example, to invoke the object package, the analysis circuit 136 can call a method within the object package that executes a formatted API request to retrieve cybersecurity metrics (e.g., threat intelligence data, incident response metrics, compliance status reports, quote data, product offerings) from a decentralized compute service. Additionally, when the analysis circuit 136 invokes the object package, the object package can execute methods linked to other decentralized interfaces, such as smart contracts or distributed storage systems, to perform or manage cybersecurity-related tasks.

In some implementations, in performing the DCDSI endpoint call, the analysis circuit 136 can receive output data including a response to the DCDSI endpoint request by a DCDSI system. That is, the output data can include a response to the endpoint call with various cyber resilience data, such as encrypted data sets, transaction verification results, security compliance report, quotes, product offerings, and more. For example, the output data can include an API response returned by the DCDSI endpoint in response to an API call made to a DCDSI endpoint address of the DCDSI endpoint. Additionally, the output data can include a formatted response to an API call (e.g., formatted cybersecurity metrics, threat intelligence data, incident response metrics, compliance status reports, quote data, and/or product offerings from a decentralized compute service. Additionally, when the analysis circuit 136 invokes the object package, the system can execute methods linked to other decentralized interfaces, such as smart contracts or distributed storage systems, to perform or manage cybersecurity-related tasks.

In some implementations, the analysis circuit 136 can update a distributed ledger, token, or data source based on the output data. That is, updating can include the analysis circuit 136 recording or modifying entries in a distributed system, such as a blockchain ledger, token-based system, or local data storage, based on data received from the DCDSI endpoint. For example, the analysis circuit 136 can store the retrieved compliance data or audit logs in a blockchain ledger (e.g., blockchain 170), and/or using various cyber resilience tokens (e.g., as described regarding FIGS. 7-10I). Additionally, the analysis circuit 136 can synchronize the updated data with local storage systems or replicate the data across decentralized networks such that output data can be accessed by various cybersecurity resources.

In some implementations, the analysis circuit 136 can include various systems and/or subsystems for endpoint mapping and integration, including object system 1102, DCDSI system 1104, and/or dynamic mapping system 1106. In some implementations, the DCDSI system 1104 can identify one or more decentralized compute and data store interface (DCDSI) endpoints and corresponding access information. DCDSI endpoints can be decentralized interfaces for computing and data storage, such as APIs, smart contracts, and/or other decentralized systems that interact with various services and platforms. For example, the DCDSI system 1104 can identify APIs, smart contract interfaces, decentralized storage gateways, or blockchain nodes associated with cloud storage services to be integrated into the cybersecurity framework of the organization. In another example, the DCDSI system 1104 can extract endpoint data such as URLs, authentication credentials, and/or parameters from technical documentation of a third party service (e.g., OpenAPI specification from third party devices 150). That is, the DCDSI system 1104 can extract the endpoint data by analyzing and/or parsing the documentation, extracting relevant metadata, and/or generating configuration templates. Further, the DCDSI system 1104 can analyze logs from previous endpoint communications and responses to identify recurring access patterns and optimize future endpoint integrations. For example, the DCDSI system 1104 can analyze response times and error rates to adjust retry logic and timeout settings. In another example, the DCDSI system 1104 can identify frequently accessed endpoints and prioritize their integration within the cybersecurity framework.

In some implementations, the object system 1102 can generate an object package corresponding to the one or more DCDSI endpoints. That is, generating the object package can include obtaining, creating, or providing a data structure. For example, the object system 1102 can generate an object package based on an endpoint type and modify the object template based on a workflow corresponding to the endpoint type. For example, the object package can be a software construct in object-oriented programming (OOP) containing methods configured for API calls, data exchange, and/or response handling specific to at least one (e.g., each) DCDSI endpoint. In another example, the object package can be a dynamic and/or modular data structure configured to interface with various endpoint protocols, facilitate integration, data transformation, and/or execution of automated workflows and other actions across decentralized platforms.

In some implementations, in generating the object package, the object system 1102 can further initiate the object package based on an identifier corresponding to at least one DCDSI endpoint type. That is, the object package can be configured based on an endpoint identifier or category (e.g., insurer, vendor, provider, etc.). For example, the object system 1102 can initiate an object package configured for an insurer API endpoint, structuring the object package according to the protocol requirements of the API. In another example, the object system 1102 can initiate an object package for an insurer or vendor endpoint, including data structures and communication protocols for the blockchain network.

In some implementations, the object package is structured according to the at least one DCDSI endpoint type. That is, a DCDSI endpoint type can include a range of categories, including but not limited to cloud service APIs, blockchain interfaces, insurance data providers, customers/users, cybersecurity tools, decentralized storage systems, financial transaction networks, IoT device gateways, machine learning model endpoints, remote sensing systems, edge computing nodes, healthcare data exchanges, digital identity verification services, content delivery networks (CDNs), smart contract platforms, federated learning systems, supply chain tracking interfaces, digital payment processors, environmental monitoring sensors, and/or telecommunication network interfaces. For example, the object system 1102 can incorporate data formatting rules and authentication mechanisms within the object package to match the endpoint type.

In some implementations, in generating the object package, the dynamic mapping system 1106 can further map the access information to an access scheme corresponding to one or more formatted requests to access the one or more DCDSI endpoints. That is, mapping can include the dynamic mapping system 1106 associating, providing, or otherwise linking various cyber resilience data and/or systems. For example, the dynamic mapping system 1106 can configure the object package to include predefined API request formats, authentication tokens, and/or headers customized to the DCDSI endpoint. In another example, the dynamic mapping system 1106 can align the access scheme with security protocols of the endpoint.

In some implementations, the one or more formatted requests correspond with requesting protection data. For example, the formatted requests can include API calls to retrieve compliance reports, incident logs, threat intelligence feeds, vulnerability assessments, security policy updates, access control lists, encryption keys, audit trails, system configuration files, real-time monitoring data, user activity logs, breach notifications, risk assessment scores, intrusion detection alerts, malware signatures, software patch statuses, regulatory compliance certificates, penetration testing results, encryption certificates, network traffic analyses, forensic investigation reports, data classification labels, endpoint protection statuses, phishing detection metrics, security training records, firewall configurations, tokenized credentials, multi-factor authentication logs, as well as quotes, pricing information, product data, service level agreements (SLAs), inventory status, purchase orders, contract terms, customer support tickets, billing records, and/or other cybersecurity-related data or business data from a decentralized compute service.

In some implementations, the DCDSI system 1104 can further perform a DCDSI endpoint request. For example, the DCDSI system 1104 can execute an API call to a vendor to obtain cyber resilience information responsive to the executed call. That is, the DCDSI system 1104 can perform a call or otherwise transmit a request to an endpoint to receive cyber resilience information. In another example, the DCDSI system 1104 can initiate a request to an insurer to access cyber insurance information. In some implementations, in performing the DCDSI endpoint call, the object system 1102 can invoke the object package to execute the DCDSI endpoint request using at least one formatted request of the one or more formatted requests. For example, the object system 1102 can trigger a formatted API call to access encrypted cybersecurity data stored on a remote server.

In some implementations, in performing the DCDSI endpoint call, the DCDSI system 1104 can receive output data including a response to the DCDSI endpoint request by a DCDSI system. That is, receiving can include the DCDSI system 1104 retrieving various cyber resilience data via a network. For example, the DCDSI system can access threat analysis reports, compliance metrics, vulnerability scans, incident response summaries, audit logs, encryption status updates, security policy adherence checks, access control validations, breach investigation reports, real-time monitoring alerts, user activity analytics, risk assessment results, intrusion detection logs, malware detection signatures, software patch compliance reports, regulatory compliance validations, penetration testing outcomes, encryption certificate verifications, network traffic summaries, forensic analysis findings, data classification compliance, endpoint protection statuses, phishing attempt detections, security training completion records, firewall rule evaluations, token authentication logs, multi-factor authentication activity reports, as well as retrieved quotes, pricing models, product specifications, service level agreement (SLA) compliance data, inventory updates, purchase order statuses, contract fulfillment metrics, customer support resolutions, billing summaries, and/or other security-related or business data returned by the DCDSI endpoint.

In some implementations, the dynamic mapping system 1106 can update a distributed ledger or data source based on the output data. For example, the dynamic mapping system 1106 can record the received data on blockchain 170 or in an internal database. That is, updating can include the analysis circuit 136 recording or modifying entries in a distributed system, such as a blockchain ledger, token-based system, or local data storage, based on data received from the DCDSI endpoint. For example, the analysis circuit 136 can store the retrieved cyber resilience data a blockchain ledger (e.g., blockchain 170), and/or using various cyber resilience tokens (e.g., as described regarding FIGS. 7-10I).

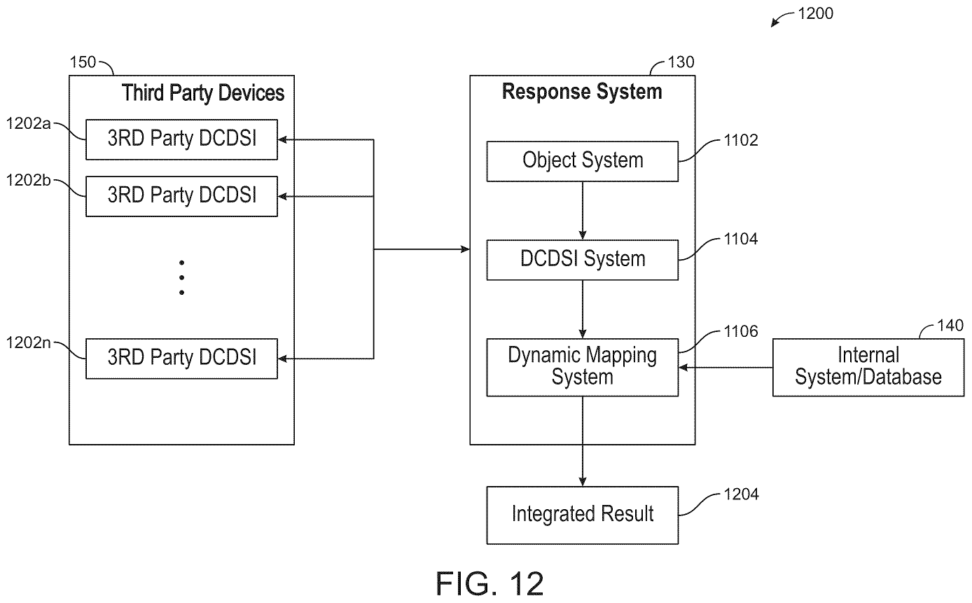

Referring now to FIG. 12, a block diagram 1200 of a more detailed architecture of certain systems or devices of FIG. 11 is shown, according to some implementations. The implementation shown in FIG. 12 can include response system 130, database 140, and/or third party devices 150. In some examples, the response system 130 can include the object system 1102, DCDSI system 1104, and dynamic mapping system 1106. The third party devices 150 can include one or more endpoints 1202a-1202n (e.g., third party DCDSIs). The implementation shown on FIG. 12 can also include an integrated result 1204. In some examples, the various components of FIG. 12 can communicate and/or be linked via a network (e.g., as described regarding FIGS. 1A and 7).

In some implementations, the response system 130 can integrate and map endpoint data for interfacing with the endpoints 1202a-1202n. For example, the DCDSI system 1104 can identify and catalog the endpoints 1202a-1202n and corresponding access information by analyzing the data provided by third party devices 150, data sources 160, etc. In some implementations, the object system 1102 can create an object package corresponding to at least one (e.g., each) identified endpoint 1202a-1202n, structuring the package based on the endpoint type (e.g., the endpoint 1202a corresponding to at least one of third party devices 150 including an insurer type, etc.). That is, the object package can include methods and/or data structures configured for interacting with the endpoint, such as predefined API request formats or templates, authentication tokens, and communication protocols corresponding to the endpoint. For example, the object package for an API endpoint can include JSON formatting rules, a package for a blockchain endpoint can incorporate data serialization methods and consensus verification steps, an object package for a vendor can include methods for purchasing a cyber resilience plan, and so on.

The dynamic mapping system 1106 can map the access information to an access scheme that aligns with the standards or other parameters corresponding to the endpoint. For example, mapping can include formatting various requests to determine that formatted requests are correctly configured for accessing the data (e.g., cybersecurity protection data) of the endpoint. That is, mapping can include linking or otherwise associated data and/or systems (e.g., matching the security protocols of the endpoint with the internal security policies of the organization to create an integration aligning with external and internal standards). Additionally, the dynamic mapping system 1106 can adapt the access scheme dynamically and adjust to changes in the requirements of the endpoint or the security posture of the organization.

Still referring to FIG. 12. In some implementations, in performing an endpoint request, the DCDSI system 1104 can invoke the object package generated by the object system 1102 to execute the request. That is, the DCDSI system 1104 can implement, execute, or otherwise trigger an API call using a formatted request that complies with the protocol of the endpoint for retrieving data and/or performing a call. Further, the DCDSI system 1104 can receive a response to the request from the endpoint as output data, which can be processed by the dynamic mapping system 1106 to generate the integrated result 1204. For example, the output data can be received as unstructured data and further transformed by the dynamic mapping system 1106 to correspond to formatting and/or other predefined requirements. That is, the integrated result 1204 can include a consolidated and/or processed outcome of the endpoint interactions (e.g., formatted response). In some examples, the dynamic mapping system 1106 can store the integrated resulted in a database or data store (e.g., database 140), or further transmit the integrated result 1204 to other systems within the cybersecurity framework of the organization. In some examples, the dynamic mapping system 1106 can also update a distributed ledger, such as blockchain 170, or other internal data sources based on the output data such that the cybersecurity posture of the organization is accurately reflected and/or stored in relevant systems and records. For example, after retrieving compliance data from an external API, the dynamic mapping system 1106 can record the results on a blockchain or internal system.

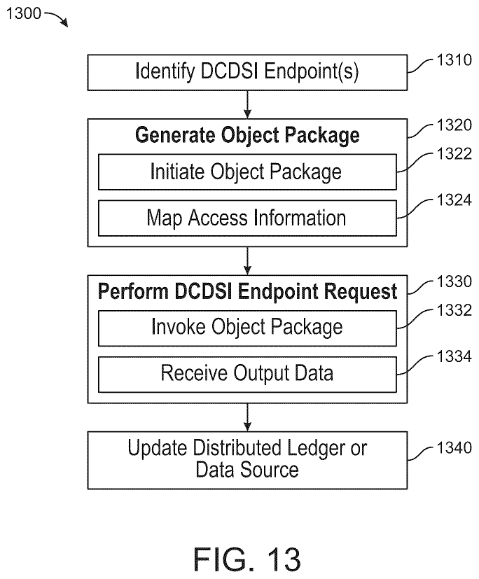

Referring now to FIG. 13, a flowchart for a method 1300 of modeling cyber resilience data using cyber resilience identities and associated metadata is shown, according to some implementations. One or more of the components described with respect to FIGS. 1A-1B or FIG. 11 can be used to perform the steps of method 1300. For example, the response system 130 of FIG. 1A-1B or the analysis circuit 136 of FIG. 11 can perform one or more of the steps of the method 2600. Additional, fewer, or different operations can be performed depending on the particular implementation. In some implementations, some, or all operations of method 1300 can be performed by one or more processors executing on one or more computing devices, systems, or servers. In some implementations, at least one (e.g., each) operation can be re-ordered, added, removed, or repeated.

In a broad overview of method 1300, at block 1310, the one or more processing circuits (e.g., analysis circuit 136 of FIG. 11) can identify DCDSI endpoint(s). At block 1320, the one or more processing circuits can generate an object package. At block 1322, the one or more processing circuits can initiate the object package. At block 1324, the one or more processing circuits can map access information. At block 1330, the one or more processing circuits can perform a DCDSI endpoint request. At block 1332, the one or more processing circuits can invoke an object package. At block 1334, the one or more processing circuits can receive output data. At block 1340, the one or more processing circuits can update a distributed ledger or data source.

In some implementations, at block 1310, the one or more processing circuits (e.g., analysis circuit 136 of FIG. 11) can identify DCDSI endpoint(s). In some implementations, at block 1310, the one or more processing circuits can identify one or more decentralized compute and data store interface (DCDSI) endpoints and corresponding access information. For example, the analysis circuit 136 can access various data sources 160 to extract information about the DCDSI endpoints. This access information can include elements such as endpoint addresses, authentication credentials (e.g., API keys, OAuth tokens, cryptographic keys), request parameters (e.g., query parameters, HTTP headers), and/or response formats (e.g., JSON, XML). For example, an endpoint address can refer to locations (e.g., URLs or IP addresses) used to access decentralized services. Further, request parameters can include instructions for interacting with the endpoints (e.g., query parameters, HTTP headers). In another example, response formats can include the structure or type of data returned by the endpoints (e.g., JSON, XML). The analysis circuit 136 can also retrieve metadata associated with these endpoints, including data transfer protocols (e.g., REST) and security requirements (e.g., encryption standards, authentication methods).

Additionally, the analysis circuit 136 can analyze historical data to identify patterns in how endpoints have been accessed in the past, which can provide information to inform the integration of new or additional endpoints. For example, the analysis circuit 136 can prioritize frequently accessed endpoints or adjust the access information based on past connection issues. The processing circuits can also apply predictive models to anticipate access parameters for new or updated DCDSI endpoints by referencing similar, previously integrated endpoints. In another example, the analysis circuit 136 can dynamically update a catalog of endpoints as new DCDSI endpoints are added, or existing ones are modified. Moreover, the identified DCDSI endpoints can include a range of decentralized interfaces, such as APIs for cloud services, blockchain nodes, and/or smart contracts. For example, the analysis circuit 136 can identify an API endpoint linked to a cloud-based data storage service, a smart contract for processing insurance claims, or a blockchain node for verifying cybersecurity incident logs.

In some implementations, at block 1320, the one or more processing circuits can generate an object package. For example, the object package can be a structured data object configured to facilitate communication with one or more DCDSI endpoints. The object package can include methods and data structures specifically configured for interacting with decentralized interfaces, such as APIs, blockchain nodes, or smart contracts. The object package can be generated based on the identified DCDSI endpoints and corresponding access information, encapsulating the data for making endpoint requests, such as the address of the endpoint, authentication credentials (e.g., API keys, OAuth tokens), and/or predefined request formats. For example, the object package can include a set of methods for executing various endpoint calls, such as HTTP requests, and/or additional methods for managing session tokens, handling encryption and decryption of data, and/or parsing responses returned by the endpoint. Additionally, the object package can be adapted to or customized based on different types of endpoints (e.g., an insurer endpoint can correspond to a predefined object package with predefined methods or functions for interacting with insurers, a vendor endpoint can correspond to an object including methods for interacting with vendors, etc.). For example, if the DCDSI endpoint is an API, the object package can include methods for constructing API calls (e.g., GET, POST) and handling standard response formats like JSON or XML. If the endpoint is a blockchain node, the package can include methods for interacting with smart contracts, validating transaction signatures, or retrieving data stored on the blockchain.

In some implementations, in generating an object package at block 1320, the one or more processing circuits can initiate the object package at block 1322. In some implementations, at block 1322, the one or more processing circuits can initiate the object package based on an identifier corresponding to at least one DCDSI endpoint type. For example, the analysis circuit 136 can use the Object-Oriented Programming (OOP) concept of reflection to dynamically identify and instantiate the appropriate class corresponding to the endpoint type. Reflection can allow the analysis circuit 136 to examine metadata about the endpoint at runtime, determining the methods, attributes, and/or interfaces to include in the object package. For example, if the DCDSI endpoint corresponds to a third party insurer, the analysis circuit 136 can initiate an object package configured to handle insurance workflows, such as processing claims or retrieving policy data. The analysis circuit 136 can select the appropriate class definitions using reflection, ensuring that the object package includes the logic and data structures for these operations. In another example, for a customer management endpoint, the one or more processing circuits can initiate an object package that includes methods for accessing and updating customer records. The analysis circuit 136 can dynamically load the correct classes and/or interfaces configured to interact with the endpoint based on the endpoint type. In some implementations, the object package is structured according to the at least one DCDSI type. For example, the one or more processing circuits can organize the object package to include data serialization formats, communication protocols, and/or security mechanisms that align with the endpoint type, facilitating the use of the object package for endpoint calls.

In some implementations, in generating an object package at block 1320, the one or more processing circuits can map access information at block 1324. In some implementations, at block 1324, the one or more processing circuits can map access information to an access scheme corresponding to one or more formatted requests to access the one or more DCDSI endpoints. For example, the analysis circuit 136 can structure access information, such as API keys, authentication tokens, endpoint URLs, and/or request parameters, into a format aligned with the access scheme for the endpoints. That is, as access scheme can include various information for accessing an API endpoint and/or provide a format configured to be accepted by the API endpoint. For example, the analysis circuit 136 can actively map data used for an endpoint call to predefined fields within the access scheme, aligning at least one (e.g., each) formatted request with the protocol of the endpoint and security requirements such that the endpoint provides a valid response or output responsive to an endpoint request conforming to the access scheme. The access scheme can include an endpoint address, structure and/or formatting requirements corresponding to an endpoint, and so on. For example, the analysis circuit 136 can incorporate OAuth tokens and endpoint-specific parameters when configuring API calls to cloud services, structuring the requests to comply with the security policies of third party devices 150. Additionally, if the DCDSI endpoints include blockchain nodes, the analysis circuit 136 can map access information to include cryptographic signatures and/or consensus parameters for interacting with the blockchain. In some implementations, the one or more formatted requests correspond with requesting protection data. For example, the analysis circuit 136 can format API calls to retrieve cybersecurity-related data, such as threat intelligence reports, incident logs, or compliance checklists, structuring these requests to match the specifications of the endpoint and support secure data retrieval.

In some implementations, at block 1330, the one or more processing circuits can perform a DCDSI endpoint request. For example, the analysis circuit 136 can execute an API call to a cloud service provider to retrieve real-time cybersecurity threat intelligence. The API call can include formatted requests, such as GET or POST requests, structured with the authentication tokens and query parameters specific to the cloud service endpoint. In another example, the analysis circuit 136 can initiate a request to a blockchain node, where the request involves submitting a transaction to verify the integrity of recent cybersecurity-related events. Initiating can include invoking smart contracts on the blockchain that manage the validation of incident reports or the authentication of security audits. Additionally, the analysis circuit 136 can perform a DCDSI endpoint request to a third party security service, such as a Managed Security Service Provider (MSSP), to gather data on detected vulnerabilities or security patches. In performing the DCDSI endpoint request, the analysis circuit 136 can adapt the request formats (e.g., endpoint calls) to meet the requirements of at least one (e.g., each) endpoint such that the requests are properly authenticated and routed through secure channels. For instance, when interacting with a decentralized storage network, the analysis circuit 136 can include commands to retrieve encrypted cybersecurity data, such as encrypted log files or configuration backups, from distributed nodes or tokens, and then process the responses to decrypt and analyze the retrieved data.

In some implementations, in performing a DCDSI endpoint call at block 1330, the one or more processing circuits can invoke an object package at block 1332. In some implementations, at block 1332, the one or more processing circuits can use the object package to execute or perform the DCDSI endpoint request using at least one formatted request of the one or more formatted requests. For example, the analysis circuit 136 can invoke the object package by activating methods within the package that correspond to the type of endpoint being accessed. Invoking can include calling or executing a method configured to communicate with a cloud-based API, where the formatted request includes the headers, authentication tokens, and/or query parameters tailored to the protocol of the endpoint. In another example, the analysis circuit 136 can invoke the object package for a blockchain-based DCDSI endpoint, where the request can include executing a smart contract function to verify the status of a cyber resilience token. The object package can be structured to dynamically adjust its methods based on the endpoint type such that the analysis circuit 136 can handle various types of DCDSI endpoints without rewriting core request logic. Additionally, the object package can include routines to manage potential issues during the endpoint interaction, such as timeouts or invalid responses, and can trigger alternative methods or retries to complete the DCDSI endpoint request.

In some implementations, in performing a DCDSI endpoint call at block 1330, the one or more processing circuits can receive output data at block 1334. In some implementations, at block 1334, the one or more processing circuits can receive output data, specifically as a response to the DCDSI endpoint request by a DCDSI system. For example, the analysis circuit 136 can receive output data from an API endpoint in direct response to the request, such as a set of compliance metrics or security incident reports. The output data can be in a structured format, such as JSON or XML, which allows the analysis circuit 136 to parse and process the information for further use. In another example, the output data received from a blockchain-based DCDSI system can include transaction records or verification results related to cyber resilience tokens corresponding to the initiated request. The analysis circuit 136 can process this data to update internal records or to trigger additional actions based on the results (e.g., response) received from the endpoint.

In some implementations, at block 1340, the one or more processing circuits can update a distributed ledger or data source based on the output data. For example, the dynamic mapping system 1106 can record the received output data in a blockchain ledger (e.g., blockchain 170), facilitating secure, immutable, and/or verifiable data storage. In another example, the one or more processing circuits can update an internal data source, such as database 140, by appending the output data to existing records. In some examples, updating can include mapping the output data to fields within the database, such as cybersecurity metrics, incident logs, or compliance reports such that that the information is categorized appropriately for future use. Additionally, the one or more processing circuits can create associations between the newly recorded output data and pre-existing records, facilitating data analysis and access to related information.

In some implementations, the one or more processing circuits can further determine entity data of an entity based on at least one token stored on the distributed ledger or data source. For example, the analysis circuit 136 can access the distributed ledger (e.g., blockchain 170) to retrieve a token associated with the entity, such as a unique identifier or an encrypted data block. The analysis circuit 136 can decode or decrypt the token to extract the entity data, which can include data like entity credentials, cybersecurity posture, or other relevant data for the endpoint request. In some implementations, performing the DCDSI endpoint request further includes providing the entity data and the access information as input to the object package. For example, the object system 1102 can integrate the retrieved entity data with the access information, structuring them within the object package for precise communication with the DCDSI endpoint. The object system 1102 can prepare the object package to include entity-specific parameters, such as authentication credentials or request parameters associated with the entity, aligning the DCDSI endpoint request with the requirements of the entity.

In some implementations, the access information comprises a taxonomy including at least one endpoint address and one or more (i) authentication credentials, (ii) request parameters, or (iii) response formats corresponding to the one or more DCDSI endpoints. That is, the taxonomy can include a structure or classification system that organizes and categorizes elements for interacting with decentralized services, such as endpoint addresses, based on various parameters (e.g., authentication credentials, communication parameters, etc.). For example, the analysis circuit 136 can implement the taxonomy to identify and organize relevant data to facilitate communication with DCDSI endpoints. Additionally, the taxonomy can include categories for security protocols, data formats, or other classifications relevant to the interaction with the endpoints.

In some implementations, performing the DCDSI endpoint request further includes providing, by the one or more processing circuits, the one or more (i) authentication credentials, (ii) request parameters, or (iii) response formats as the input to the object package based on the taxonomy. That is, providing can include organizing various inputs according to a received taxonomy (e.g., based on an API specification, for example) such that endpoint calls or requests can be received and/or processed by an identified endpoint. For example, the analysis circuit 136 can extract and arrange the necessary credentials and parameters from the taxonomy to facilitate the request. In some implementations, performing the DCDSI endpoint request further includes invoking, by the one or more processing circuits, the object package to perform the DCDSI endpoint request to the endpoint address. That is, invoking can involve instantiating an object and/or executing methods included within or corresponding to the object such that the object causes the request to be transmitted to the appropriate endpoint and further processed for providing a response. For example, the analysis circuit 136 can execute a method within the object package corresponding to an API “GET” function of an endpoint to transmit a request according to the endpoint standards or other endpoint data included in the taxonomy.

In some implementations, in accessing the token, the one or more processing circuits can further establish a data communication link with the ledger. For example, the analysis circuit 136 can initiate a secure connection with a blockchain network or a database that serves as the ledger, utilizing encrypted communication protocols to protect the integrity of the transmitted data. In some implementations, the ledger includes a blockchain network or database. For example, the blockchain 170 can store tokens associated with various entities, where at least one (e.g., each) token can represent unique identifiers, security credentials, or other encrypted information relevant to the entity. In some implementations, the one or more processing circuits can transmit, via the data communication link, a query to the blockchain network or database to identify the token, and the query can include an identifier or address corresponding with the entity. For example, the analysis circuit 136 can formulate and transmit a query that specifies the unique identifier or blockchain address of the entity, directing the query to the appropriate node within the blockchain network. In some implementations, the one or more processing circuits can retrieve, via the data communication link, the token from the blockchain network or database using the identifier or address. For example, upon receiving a response from the blockchain network, the analysis circuit 136 can extract the token data, which can include encrypted information specific to the entity. In some implementations, the one or more processing circuits can verify the authenticity of the token. For example, the analysis circuit 136 can apply cryptographic techniques to validate the digital signature of the token or check its provenance against a stored ledger of trusted entities. The verification process helps to confirm that the token has not been tampered with and is legitimate. In some implementations, the one or more processing circuits can extract the entity data from the token. For example, the analysis circuit 136 can decrypt the token to reveal the underlying entity data, such as access credentials, compliance history, or other relevant information for the DCDSI endpoint request.

In some implementations, in identifying the one or more DCDSI endpoints and the access information, the one or more processing circuits can extract, using a machine learning model, the access information from at least one document or content corresponding with the one or more endpoints. For example, the analysis circuit 136 can employ various machine learning models, such as natural language processing (NLP) models, supervised learning models, or deep learning neural networks, to analyze and extract relevant endpoint data from diverse sources. These sources can include unstructured data from API documentation, technical manuals, configuration files, and/or log files from previous interactions with the endpoints. The models can be trained and implemented to identify access information, such as endpoint URLs, authentication credentials, API keys, request parameters, and/or response formats. For instance, an NLP model might process API documentation to recognize and extract structured access data, while a deep learning model could analyze historical data to detect patterns and predict optimal configurations for new endpoints. Additionally, a supervised learning model can be used to continuously improve the accuracy of access information extraction by learning from labeled data sets and refining its predictions over time, and the analysis circuit 136 can then map the extracted information to the appropriate DCDSI endpoints.

In some implementations, the one or more processing circuits can detect an update to the one or more DCDSI endpoints based on monitoring the at least one document or content using the machine learning model. For example, the analysis circuit 136 can utilize a combination of machine learning models, such as recurrent neural networks (RNNs) for time-series analysis, and/or anomaly detection algorithms to monitor API documentation, configuration files, or change logs for any alterations or updates to the endpoints. These models can identify changes in endpoint URLs, new authentication protocols, updated request parameters, or modifications in response formats. In some implementations, the one or more processing circuits can modify the access information based on the detected update. For example, upon detecting an update, the analysis circuit 136 can automatically adjust the relevant access data, such as updating the endpoint URL, revising authentication credentials, or altering the structure of API requests to match the new specifications. In some implementations, the one or more processing circuits can map the modified access information to the access scheme corresponding to the one or more formatted requests. For example, the dynamic mapping system 1106 can reconfigure the object package to incorporate the modified access information such that future DCDSI endpoint requests are aligned with the updated endpoint requirements. For example, mapping can include updating the formatted request templates, adjusting security protocols, and/or verifying that the modified access scheme maintains compatibility with the new configuration of the endpoint.

In some implementations, in generating the object package, the one or more processing circuits can receive an object data structure including operations for communicating with and exchanging data with the one or more DCDSI endpoints based on the type. For example, the analysis circuit 136 can apply object-oriented programming (OOP) principles, such as reflection, to dynamically generate an object data structure tailored to the type of DCDSI endpoint. The object data structure can include predefined methods for API calls, data exchange protocols, and/or error handling routines that align with the requirements of the endpoint. By utilizing reflection, the analysis circuit 136 can identify and incorporate the appropriate classes, methods, and/or properties for interacting with different types of endpoints, allowing the object package to adjust its behavior based on the DCDSI endpoint (e.g., cloud-based APIs, blockchain nodes, smart contracts). In some implementations, in generating the object package, the one or more processing circuits can modify a state of the object data structure to cause the object data structure to perform the DCDSI endpoint request based on the access information. For example, the analysis circuit 136 can manage the state of the object data structure by tracking the current status of the DCDSI endpoint request, such as whether the request has been initiated, is in progress, or has been completed. The state can include data fields that store the current parameters of the endpoint, authentication status, or any intermediate data used for the request. By actively modifying the state, the analysis circuit 136 can trigger actions within the object data structure, such as sending an API request, adjusting request parameters based on real-time data, or handling a response from the endpoint.

In some implementations, in updating the distributed ledger or data source, the one or more processing circuits can map the output data to an output information scheme corresponding to one or more outputs from accessing the one or more DCDSI endpoints. For example, the analysis circuit 136 can map the output data to an output information scheme that organizes and categorizes the data based on predefined formats, making the data compatible with the structure of the distributed ledger or internal data source. In some examples, mapping can include translating raw data into structured formats, such as converting JSON responses from an API into a tabular format suitable for blockchain storage or database entries. The integrated result 1204 can be generated as part of a mapping process, consolidating and aligning the data with the output information scheme to provide a record of the interactions with the DCDSI endpoints. Additionally, the analysis circuit 136 can manage various types of output data, such as transaction records, audit logs, compliance reports, or other cybersecurity-related information, and/or map these outputs to the appropriate sections of the ledger or data source, facilitating efficient data retrieval and analysis in future operations.

In some implementations, the one or more DCDSI endpoints include one or more application programming interfaces (APIs). For example, the DCDSI endpoints can encompass APIs that interact with various third party services, such as cloud storage providers, financial transaction systems, or cybersecurity monitoring tools. These APIs can serve as interfaces for retrieving data, executing transactions, or interacting with decentralized compute and data storage systems. In some implementations, the access scheme includes one or more rules. For example, the access scheme can include a set of predefined conditions or parameters, such as authentication requirements, access permissions, or data format specifications, that govern how the DCDSI endpoints are accessed. In some implementations, the one or more processing circuits can validate the access information against at least one of the one or more rules to determine compatibility with the access scheme either (i) before performance of a data retrieval corresponding to the DCDSI endpoint request or (ii) after performance of the data retrieval. For example, before executing the DCDSI endpoint request, the analysis circuit 136 can compare the provided access credentials and parameters with the access rules to verify that the request complies with the security of the endpoint and access protocols of the endpoint. For example, validating can include checking for valid API keys, ensuring that the request is properly formatted, and verifying that the user has the permissions to access the requested data. In another example, after performing the data retrieval, the analysis circuit 136 can validate the retrieved data against post-retrieval rules, such as verifying that the data meets integrity checks and confirming that the data format aligns with the expected schema.

### Modeling Data Structures Using an Integration Gateway

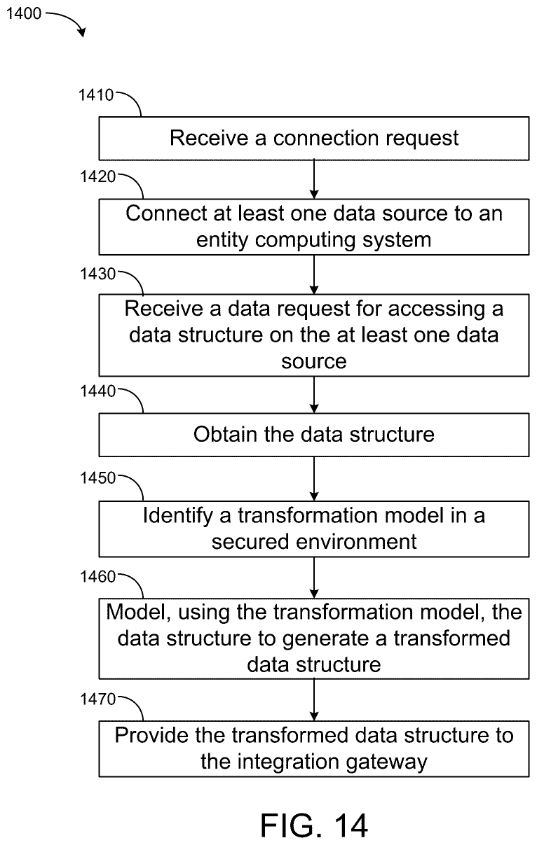

Referring now to FIG. 14, a flowchart for a method 1400 of modeling data structures using an integration is shown, according to some implementations. One or more of the components described with respect to FIG. 1A or FIG. 11 can be used to perform the steps of methods 1400. For example, the response system 130 of FIG. 1A or the analysis circuit 136 of FIG. 11 can perform one or more of the steps of the method 1400. In some implementations, some, or all operations of method 1400 can be performed by one or more processors executing on one or more computing devices, systems, or servers. In some implementations, at least one (e.g., each) operation can be re-ordered, added, removed, or repeated.

As used herein, an “integration gateway” refers to one or more interfaces (e.g., application program interfaces (API), graphical user interfaces (GUI), applications (e.g., frontend or backend), computing systems, or a combination thereof that enable a public environment (see below) to interface with protected (e.g., proprietary and/or confidential) executable code corresponding to at least one (e.g., each) of the unique identifiers (UIDs) (e.g., first UID, second UID, third UID, etc.). The integration gateway can include an application program interface (API) gateway, an enterprise application integration system, a business-to-business integration system, and more.

As used herein, a “public environment” refers to one or more public systems (e.g., computing systems and/or applications), public networks (e.g., public cloud environments), and/or processing circuits executing open-source executable components, modules, and/or libraries that can access the UIDs (e.g., the first UID, the second UID, and/or the third UID) via the integration gateway.

As used herein, a “secure environment” refers to a computing environment that includes protected (e.g., proprietary and/or confidential) executable code. The secure environment is not directly accessible by the public environment. The secure environment can use authentication and/or authorization mechanisms or rule-based permission structures to handle requests to access information from the secure environment.

As used herein, “protected executable code” refers to proprietary and/or confidential code the public environment can use via UIDs (e.g., the first UID, the second UID, the third UID, etc.). That is, the public environment can use the code for its one or more intended purposes via the UIDs, but the public environment is not aware of the implementation details (e.g., the raw executable code). The protected executable code can include connection instructions for connecting an entity computing system to a data source, APIs for retrieving data from data sources, and/or transformation models for modeling data retrieved from the data sources, and/or other types of confidential and/or proprietary executable code.

In a broad overview of method 1400, at block 1410, the one or more processing circuits (e.g., analysis circuit 136 of FIG. 11), can receive a connection request. At block 1420, the one or more processing circuits can connect at least one data source to an entity computing system. At block 1430, the one or more processing circuits can receive a data request for accessing a data structure on the at least one data source. At block 1440, the one or more processing circuits can obtain the data structure. At block 1450, the one or more processing circuits can identify a transformation model in a secured environment. At block 1460, the one or more processing circuits can model, using the transformation model, the data structure to generate a transformed data structure. At block 1470, the one or more processing circuits can provide the transformed data structure to the integration gateway.

Generally, the method 1400 can relate to an integration gateway. In some implementations, the integration gateway processes requests generated by clients and/or third-parties (e.g., connection requests, data requests, transformation requests, etc.). That is, the requests can be received and/or executed by one or more middleware and/or intermediary components that facilitate communications and interactions between different systems, applications, or services within one or more entities (e.g., enterprises, companies, organizations, etc.). Further, the integration gateway can connect disparate systems (e.g., frontend and/or back-end systems) facilitating data communication and/or cross-functionality. In some implementations, the integration gateway can be an API gateway (e.g., a system for managing APIs), an enterprise integration platform (e.g., a system for connecting, customer relationship management systems (CRMS), enterprise resource planning systems (ERPS), human resource management systems HRMS, and/or other enterprise systems) or a cloud-native tool (e.g., a system for connecting cloud environments. Further, the integration gateway can be implemented using closed-source tools (e.g., Kong Gateway, MuelSoft Anypoint Platform, Zapier, DataPower Gateway etc.), open-source tools (e.g., Apache Camel, Spring Cloud Gateway, WSO2 API Manager, Tyk, NGINX, etc.), and/or a combination of the two.

In some implementations, the transformation request can direct an integration gateway to execute one or more instructions. For example, the integration gateway can handle protocol translations (e.g., translating SOAP to REST), data transformations (e.g., converting XML to JSON), data management (e.g., managing and/or sequencing API calls), data security (e.g., handling authentication, authorization, encryption, and/or compliance), data routing (e.g., directing requests to backend systems or services based on rules or meta data), data catching and load balancing (e.g., catching frequently accessed data and/or distributing network traffic), and/or performance monitoring (e.g., tracking and/or logging performance metrics and/or errors). In some implementations, the integration gateway can interact with different systems (e.g., backend systems) and/or components (e.g., UID) using at least one of APIs (e.g., REST, SOAP, etc.), SDKs, webhooks, CI/CD pipelines, and/or plugins.

In some implementations, at block 1410 the one or more processing circuits (e.g., analysis circuit 136 of FIG. 11) can receive a connection request. That is, the one or more processing circuits, such as one or more processing circuits corresponding to an integration gateway (e.g., response system 130), can receive a request for connecting at least one data source to an entity computing system. Generally, the one or more processing circuits can directly or indirectly receive the connection request. In one example, a connection request sender (e.g., third party device 150) can directly send a connection request that the one or more processing circuits receive. In another example, the connection request sender can indirectly send the connection request to the one or more processing circuits through one or more intermediaries. Further, one or more processing circuits can store connection request on a database and/or retrieve connection requests from the same database. For example, analysis circuit 136 can store connection requests in database 140 and/or retrieve connection requests from database 140.

In some implementations, the connection request can include a first unique identifier corresponding with at least one data source. That is, the one or more processing circuits (e.g., input/output circuit 118 of FIG. 11) can embed the first unique identifier in the connection request, where the first unique identifier allow one or more processing circuits to access at least one data source corresponding to the first unique identifier. The connection request can be an executable command included in a communication protocol. For example, the connection request can be a command included in a TCP/IP protocol, an HTTP protocol, or any other communication protocol that could include a connection request. Further, the first unique identifier can be a parameter and/or metadata corresponding to a command included in a communication protocol.

In some implementations, the one or more processing circuits (e.g., analysis circuit 136 of FIG. 11) can identify connection instructions stored in a secure environment based on the first UID. Generally, the first UID in the connection request can correspond to a location in a secure environment that includes connection instructions. For example, the first UID can correspond to a location in database 140. In some implementations, the connection instructions include executable code for connecting the at least one data source to the entity computing system. The connection instructions can be one or more proprietary steps (e.g., confidential executable code, software-based intellectual property, software-based private information, etc.) for connecting the data source with the entity computing system. Further, the connection instructions can be proprietary to a developer of the connection instructions. That is, the developer of the connection instructions is free to access and/or use the connection instruction instructions without restrictions. For example, a client that develops the connection instructions, can access and/or use the connection instructions without restriction via client device 110. However, entity computing systems requesting access to a data source can connect to the data source via the first UID. For example, third party device 150 can access and/or use the connection instructions via the first UID because the third party corresponding to third party device 150 did not develop the connection instructions.

In some implementations, at block 1420 the one or more processing circuits (e.g., analysis circuit 136 of FIG. 11) can connect at least one data source to an entity computing system. Connecting the data source to the entity computing system can include at least one of a network-based connection (e.g., local area network, wide area network, wireless network, virtual private network, etc.), a peer-to-peer connection (e.g., direct cable connection, ad-hoc wireless network, etc.), a client-server connection (e.g., HTTP/HTTPS), a cloud-based connection (e.g., cloud platforms, collaboration tools, etc.), an inter-process communication (e.g., TCP/UDP sockets, message queues, APIs, etc.), a remote access connection (e.g., remote desktop protocol, secure shell, etc.), middleware/integration platforms (e.g., enterprise bus service, integration tools, etc.), a combination thereof, and/or much more. Further, connecting the data source to the entity computing system can include the one or more processing circuits (e.g., analysis circuit 136 of FIG. 11) verifying one or more credentials of the connection request sender, receiving one or more parameters, identifying requested data based on the one or more parameters, and/or selecting a connection protocol based on the data source and/or the requested data. In one example, third party device 150 and/or client device 110 can be an entity computing system that can connect to data sources 160 via network 120. In another example, third party device and/or client device 110 can be an entity computing system that first connects to data acquisition engine 180 via network 120 and then connects to data sources 160 via network 120.

In some implementations, the at least one data source can be external/internal to the entity computing system. The at least one data source can include databases, files/file systems, APIs, cloud platforms, enterprise systems, distributed legers, public/private data repositories, a combination thereof, and much more. The at least one entity computing system can include a computing system corresponding to a client (e.g. client device 110), third party (e.g., third party device 150), application (e.g., application 112), and much more.

In some implementations, at block 1430 the one or more processing circuits (e.g., analysis circuit 136 of FIG. 11) can receive a data request for accessing a data structure on the at least one data source. That is, the one or more processing circuits, such as one or more processing circuits corresponding to an integration gateway (e.g., response system 130), can receive a request that includes executable code for retrieving the data structure. Generally, the one or more processing circuits can directly or indirectly receive the data request. In one example, a data request sender (e.g., third party device 150) can directly send a connection request that the one or more processing circuits receive. In another example, the data request sender can indirectly send the data request to the one or more processing circuits through one or more intermediaries. Further, one or more processing circuits can store data request on a database and retrieve data requests from the same database. For example, analysis circuit 136 can store data requests in database 140 and retrieve connection requests from database 140.

In some implementations, the data request includes a second UID. That is, the one or more processing circuits (e.g., input/output circuit 118 of FIG. 11) can embed the second unique identifier in the data request, where the second unique identifier allow one or more processing circuits to access a data structure corresponding to the second unique identifier. The data request can be an executable command included in a communication protocol. For example, the connection request can be a command included in a TCP/IP protocol, an HTTP protocol, or any other communication protocol that could include a data request. Further, the second unique identifier can be a parameter and/or metadata corresponding to a command included in a communication protocol.

In some implementations, at block 1440 the one or more processing circuits (e.g., analysis circuit 136 of FIG. 11) can obtain data structures using the second UID. Generally, second UID in the data request can correspond to at least one application program interface (API). In some implementations, the at least one API includes executable code for obtaining the data structure on the at least one data source. The at least one API can include proprietary (e.g., private, secret, non-public, confidential, etc.) instructions, rules, and/or protocols for connecting the data source with the entity computing system. Further, the at least one API can be proprietary to a developer of the at least one API. That is, the developer of the at least one API is free to access and/or use the at least one API without restriction. For example, a client that develops the at least one API, can access and/or use the at least one API without restriction via client device 110. However, entity computing systems requesting data structures on a data source can obtain the data structures via the second UID. For example, third party device 150 can access and/or use the at least one API via the second UID because the third party corresponding to third party device 150 did not develop the at least one API. In some implementations, the at least one API corresponds with a collection module that collects data structures from the data sources. For example, the at least one API can invoke data acquisition engine 180 to collect data structures from data sources 160.

In some implementations, the at least one data source includes one or more data structures. Further, the integration gateway can store the one or more data structures retrieved from the at least one data source. For example, response system 130 can retrieve one or more data structures from data sources 160 using data acquisition engine 180 and/or store the one or more data structures in database 140. In some implementations, the data structure retrieved from the data source can be retrieved in a batch mode (e.g., retrieving data in pre-defined portions) and/or a streaming mode (e.g., retrieving data as the data becomes available).

In some implementations, at block 1450 the one or more processing circuits (e.g., analysis circuit 136 of FIG. 11) can receive a transformation request. In some implementations, at block 1410 the one or more processing circuits can receive a transformation request for transforming a data structure via an integration gateway. For example, the analysis circuit 136 can receive a transformation request from client device 110 and/or third party device 150 as part one or more processes for transforming data structures via an integration gateway. In some implementations, the transformation request can correspond to one or more data transformation requests (e.g., format transformation, structure transformation, protocol transformation, etc.). For example, a transformation request includes a request to change a data structure corresponding to a first format (e.g., JSON) to a transformed dataset corresponding to a second format (e.g., XML). Further, the transformation request can include a request to map one or more fields (e.g., userID, action, etc.) corresponding with the first format to one or more fields corresponding with the second format (e.g., <usr:UserID>, <usr:action>, etc.).

In some implementations, the transformation request can correspond to an integration request (e.g., a request processed by the integration gateway) initiated by the one or more processing circuits, (e.g., analysis circuit 136 of FIG. 11). That is, the transformation request, which includes accessing and/or applying the transformation model, is at least one operation executed as part of an integration request. In some implementations, the one or more processing circuits (e.g., analysis circuit 136 of FIG. 11), in accordance with the transformation request, obtains and/or applies a transformation model based on a structure and/or format of a data structure. For example, a first transformation request with a first data structure (e.g., HTTP) can correspond to a protocol transformation (e.g., HTTP to FTP conversion) and/or a second transformation request with a second data structure (e.g., JSON) can correspond to a data format conversion (e.g., JSON to XML).

In some implementations, the one or more processing circuits (e.g., analysis circuit 136 of FIG. 11) can initiate authorized transformation requests. That is, the one or more processing circuits (e.g., analysis circuit 136 of FIG. 11) places rules and/or restrictions on how the integration gateway can use transformation models. In some implementations, the one or more processing circuits (e.g., analysis circuit 136 of FIG. 11) verify authorized transformation requests by analyzing the UID. For example, analysis circuit 136 can verify that the UID corresponds with a transformation model that is compatible with the authorized transformation request.

In some implementations, at block 1450 the one or more processing circuits (e.g., analysis circuit 136 of FIG. 11) identify a transformation model stored in secure environment based on the third UID. That is, the third UID can correspond to a transformation model and/or a third party can use the third UID to obtain the transformation model from a secure environment. In some implementations, the secure environment can correspond to one or more secure data sources that are inaccessible by one or more computing systems operating in the public environment and/or executing open-source code. For example, the secure environment can correspond to a centralized or external system (e.g., a database). Further, the secure environment can be part of the integration gateway, or the secure environment can be external to the integration gateway. For example, response system 130 can be an integration gateway and/or database 140 can be a secure environment within the integration gateway. In some implementations, the public environment can be separate from the secure environment. For example, the public environment can be located on a first system, application, or network, and/or the secure environment can be located on a second system, application, or network.

In some implementations, at block 1450 the transformation model includes executable code for updating the data structure. That is, the transformation model can perform one or more computer-executable transformation techniques (e.g., computational operations, data filtering, data encoding/decoding, data aggregation, data enrichment, data normalization, data scaling, etc.) to transform one or more parts of the data structure (e.g., fields, format, keys, indices, pointers, etc.). In some implementations, the transformation model corresponds to specific transformation rules. For example, the transformation model can include rules that require data (e.g., unauthorized data) to me removed from the data structure before the transformation model is applied to the data structure.

Further, the transformation rules can correspond to specific transformation requests. For example, a first set of transformation rules can correspond to a first transformation request and/or a second set of transformation rules can correspond to a second transformation request. In some implementations, the transformation model transforms the data structure by applying a data mapping scheme. For example, transforming a data structure to a transformed data structure can involve data wrapping (e.g., wrapping the data structure in an envelope). Further, data wrapping can include mapping the data structure to one or more transformed data structure components. In some implementations, generating the transformed data structure includes serializing the transformed data structure into a string format so that it is suitable for transmission and/or validating the transformed data structure against a schema (e.g., WSDL) to ensure compliance.

In some implementations, at block 1460 the one or more processing circuits (e.g., analysis circuit 136 of FIG. 11) can model the data structure to generate a transformed data structure. That is, the transformation model can apply one or more transformation rules, logic, or algorithms to transform components of a data structure (e.g., parameters, fields, format, structure, etc). For example, a source system (e.g., entity, client, application, etc.) can send the data structure in a first format (e.g., XML) and the target system (e.g., customer, management system, etc.) can receive a transformed data structure in a second format (e.g., JSON). Further, modeling the data structure using the transformation model can include normalizing data, flattening data, enriching data, or encoding conversions. In some implementations, the transformation model can be implemented using mapping tools (e.g., XML-to-JSON mappings), data transformation languages (e.g., XSLT. JSONata, etc.), custom logic, etc. In some implementations, the one or more processing circuits (e.g., analysis circuit 136 of FIG. 11) can use the transformation model as part of an enterprise service bus (e.g., a middleware solution that facilitates communication and/or integration between different enterprise applications, systems and/or services) or cloud integration (e.g., systems for connecting on-premises systems with cloud-based platforms).

In some implementations, at block 1470 the one or more processing circuits (e.g., analysis circuit 136 of FIG. 11) can provide the transformed data structure to the integration gateway. That is, the integration gateway can receive the transformed data structure so that it can be transferred to one or more systems or applications. For example, the integration gateway can receive the transformed data structure and/or send the transformed data structure to client device 110. In some implementations, the integration gateway can receive the transformed data structure via file poling. That is, the integration gateway can monitor where the one or more processing circuits (e.g., analysis circuit 136 of FIG. 11) store the transformed data structure and/or processes the transformed data structure. In some implementations, the integration gateway can receive the transformed data structure via scheduled queries. That is, the integration gateway can query one or more databases for one or more transformed data structures. In some implementations, the integration gateway can receive the transformed data structure through event triggers. That is, the integration gateway can receive notification from one or more event trigger systems (e.g., AWS S3) about new transformed data structures and/or retrieve the new transformed data structures in response to the notifications.

In some implementations, one or more processing circuits (e.g., analysis circuit 136 of FIG. 11) restrict access, using the UID (e.g., the first UID, the second UID, the third UID), to the protected executable code (e.g., connection instructions, APIs, transformation model, etc.) from the public environment. That is, the UID can prevent the public environment from directly accessing (e.g., reading) the protected executable code. For example, the UID can correspond with one or more of the access controls described herein to prevent the public environment from accessing the protected executable code. In some implementations, the UID prevents the public environment from using the protected executable code. That is, the UID prevents the public environment from executing the protected executable code. For example, the one or more processing circuits (e.g., analysis circuit 136 of FIG. 11) can implement the access controls described herein as use controls that prevent the public environment from using the protected executable code.

In some implementations, the UIDs (e.g., the first UID, the second UID, the third UID, etc.) can correspond with access controls (e.g., encryption, API Keys, OAuth, multi-factor authentication (MFA), network segmentation, tokenization, etc.) to prevent the public environment from accessing the secure environment and/or protected executable code (e.g., connection instructions, APIs, transformation model, etc.). For example, a request to interact with the secure environment and/or the protected executable code (e.g., a transformation request, an API request, etc.) can include the UID as part of the request. In another example, the one or more processing circuits (e.g., analysis circuit 136 of FIG. 11) can map the UID to an access policy of an access control list (ACL) of the integration gateway, specifying what systems and/or applications have access to the secure environment and/or the protected executable code. In another example, the integration gateway can compare the UID against a secure database of valid UIDs to confirm access to the secure environment and/or protected executable code. In another example, the one or more processing circuits (e.g., analysis circuit 136 of FIG. 11) can encrypt the protected executable code and/or secure environment and the UID corresponds to an encryption key that provides access to the protected executable code and/or the secure environment. In another example, the one or more processing circuits (e.g., analysis circuit 136 of FIG. 11) can embed the UID in tokens (e.g., JWTs) and issue the tokens to clients or applications, wherein the integration gateway can validate the token to verify access to the secure environment and/or the protected executable code. In some implementations, the UIDs (e.g., the first UID, the second UID, the third UID, etc.) can contain sub-UIDs. Further, the one or mor processing circuits (e.g., analysis circuit 136 of FIG. 11) can use the sub-UIDs to manage access to the secure environment and/or protected executable code. For example, a primary UID can correspond to the model while the sub-UIDs manage access to one or more components of the secure environment and/or the protected executable code.

Further, the integration gateway can define access controls to the secure environment and/or protected executable code (e.g., connection instructions, APIs, transformation models, etc.). In some implementations, changes to access controls can be based on the UIDs (e.g., the first UID, the second UID, the third UID, etc.). For example, the integration gateway can interact with external access management systems (e.g., LDAP. OAuth, SAML-based systems, etc.) to modify access to the secure environment and/or the protected executable code based on the UID. In another example, the integration gateway can dissociate an old UID from a protected executable code and/or associate a new UID with the protected executable code so that the one or more processing circuits cannot use the old UID to access the secure environment and/or the protected executable code. In some implementations, changes to access controls can be based on a client or application. For example, the integration gateway can restrict access to the secure environment and/or protected executable code based on a change in status of a client or application (e.g., unauthorized). In another example, the integration gateway can use the UID to enforce different levels of client or application access control (e.g., read, write, modify, execute, etc.) to the secure environment and/or protected executable code. In some implementations, the changes to access control can be based on events. For example, the integration gateway can modify access to the secure environment and/or the protected executable code based on security events (e.g., data breaches, security vulnerabilities, unauthorized access, etc.) or modifications to the protected executable code (e.g., updating the protected executable code from version 1 to version 2).

In some implementations, the UID (e.g., the first UID, the second UID, the third UID, etc.) can obfuscates the protected executable code (e.g., connection instructions, APIs, transformation model, etc.) from the public environment. That is, the public environment can use the UID to use the executable code underlying the UID without revealing implementation information (e.g., proprietary code and/or algorithms, such as code and/or algorithms that are confidential or otherwise not accessible to the public) of the protected executable code to the public environment. The implementation details can be trade secrets or other forms of intellectual property. In some implementations, the UID corresponds to a specific version of the proprietary executable code (e.g., V1). That is, the UID can correspond to a modified version of earlier protected executable code. Accordingly, the public environment can use the protected executable code without being able to detect any changes or updates to the protected executable code.

In some implementations, the UIDs (e.g., the first UID, the second UID, the third UID, etc.) can include one or more UID formats. For example, the UIDs can be numeric identifiers, alphanumeric identifiers, hash values, addresses, and much more. Further, the numeric UIDs can be bit strings (e.g., 128-bit string) in one or more formats, such as hexadecimal, hyphenated, Base32, or compact. In some implementations, the UID (e.g., the first UID, the second UID, the third UID, etc.) can be at least one of a globally unique identifier (GUID), a universally unique identifier (UUID), and/or a universally unique lexicographically sortable identifier (ULID). Further, the UID can correspond to a specific version of the at least one of the UUID, GUID, or ULID (e.g., UUIDv1, GUIDv2, Montonic ULID, etc.). In some implementations, the UID type (e.g., UUID, GUID, or ULID) can depend on a particular client, system, and/or application. For example, Microsoft systems and/or SQL servers can use GUIDs, APIs and/or distributed systems can use UUIDs, and logs and/or timestamped systems can use ULIDs. In some implementations, the UID (e.g., the first UID, the second UID, the third UID, etc.) can serve as a reference indicator. For example, the UID can be associated with a model (e.g., a transformation model), an authentication token (e.g., JWT, API key, etc.), a parameter (e.g., a parameter for an executable function), an entity associated with an event (e.g., client and/or application event, etc.), a location in a non-public environment (e.g., a secure database), and much more.

In some implementations, the UID (e.g., the first UID, the second UID, the third UID, etc.) can be implemented using one of several identifier schemes including GUID, UUID, or ULID formats, each supporting distinct system requirements. That is, a GUID (Globally Unique Identifier) is a 128-bit value commonly used in Microsoft environments and can be generated using random or time-based inputs with optional inclusion of hardware identifiers. A UUID (Universally Unique Identifier) conforms to the ISO/IEC 9834-8 standard and includes variants such as UUIDv1 (time and node based), UUIDv3 and UUIDv5 (name-based using hashing), and UUIDv4 (random-based), where each variant provides a different entropy source for uniqueness across systems. In some implementations, UUIDs are formatted using hexadecimal strings with hyphen delimiters, typically used in APIs and cross-platform services to prevent identifier collisions across distributed components. In another example, ULIDs (Universally Unique Lexicographically Sortable Identifiers) are 128-bit identifiers composed of a 48-bit timestamp and 80 bits of entropy, offering lexicographical sortability and improved readability in log systems and time-ordered events. In some implementations, ULIDs can be encoded using Crockford Base32 encoding to avoid visually ambiguous characters. Further, systems that use chronological ordering of identifiers without relying on database indexing can use ULIDs to embed sortable timestamps directly into the UID value. In some implementations, the choice of GUID, UUID, or ULID is configured per integration context based on determinism, sortability, encoding requirements, or compatibility with existing systems.

In some implementations, the UIDs (e.g., the first UID, the second UID, the third UID, etc.) can be exposed in a public environment and/or accessible via the integration gateway. That is, one or more public systems, public networks, and/or processing circuits executing open-source executable components, modules, and/or libraries can access the UID (e.g., the first UID, the second UID, the third UID, etc.) via the integration gateway. For example, clients or applications (e.g., enterprise resource planning (ERP) system, customer relationship management (CRM) system, human resource management systems (HRMS), etc.), databases (e.g., relational databases, NoSQL databases, data warehouses, etc.), APIs (e.g., REST APIs, SOAP APIs, GraphQL APIs, etc.), IOT devices (e.g., smart devices, edge devices, etc.), messaging systems (e.g., RabbitMQ. Apache Kafka, etc.), cloud platforms (e.g., AWS, Azure, Google Cloud, etc.), legacy systems, workflow engines (e.g., Camunda, UiPath, etc.), external systems, (e.g., vendor systems), security systems (e.g., Okta, Microsoft Azure AD, etc.), end-user devices, analytics and/or monitoring tools (e.g., Tableau, Power BI, Promethus, etc.) can access the UID (e.g., the first UID, the second UID, the third UID, etc.) via the integration gateway.

In some implementations, the integration gateway can interact with the UIDs (e.g., the first UID, the second UID, the third UID, etc.). For example, the integration gateway can use the UID as a key or token to route requests or responses to one or more systems (e.g., backend systems) or endpoints (e.g., API endpoints). In another example, the integration gateway can use the UID as a parameter for one or more executable functions (e.g., a function for obtaining a transformation model). In another example, the integration gateway can use the UIDs to manage, and/or reference metadata associated with systems. In some implementations, the integration gateway can change the third UID from a first UID type or format to a second UID type or format. For example, the integration gateway can change a UUID to a to a ULID, change a UUIDv1 to a UUIDv2, change in a UID in 64-bit format to a UID in a 128-bit format, etc.

In some implementations, the one or more processing circuits (e.g., analysis circuit 136 of FIG. 11) can use the UID (e.g., the first UID, the second UID, the third UID, etc.) to decrypt an encrypted software (e.g., the connection instructions, APIs, transformation models, etc.). That is, the UID provides a key (e.g., a private key) or is used to derive the key (e.g., via a cryptographic hash) to decrypt the encrypted software. For example, analysis circuit 136 can encrypt the protected executable code using an encryption algorithm (e.g., AES-256) and/or the encryption key is derived from the UID directly or indirectly through a secure derivation process (e.g., PBKDF2, HMAC, or SHA-256 hash).

In some implementations, the one or more processing circuits (e.g., analysis circuit 136 of FIG. 11) can use the UID (e.g., the first UID, the second UID, the third UID, etc.) as a configuration index to access the protected executable code from the secure environment (e.g., secure repository, secure configuration file, etc.). That is, the one or more processing circuits can use the UID to load protected executable code stored in a secure environment. For example, analysis circuit 136 can use the UID to retrieve the protected executable code from an external memory unit.

In some implementations, the UID (e.g., the first UID, the second UID, the third UID, etc.) can grant a software license to the end-user (e.g., third party device 150) of the protected executable code (e.g., connection instructions, APIs, transformation model, etc.). That is, the UID grants the end-user the right to use the protected executable code subject to the terms and/or conditions of the software license. The software license can be a non-exclusive software license that includes an MIT license, an Apache License 2.0, a GNU General Public License, a Lesser General Public License, a Creative Commons License, an End User License Agreement, a subscription license, and/or any other type of non-exclusive software license.

In some implementations, the UID (e.g., the first UID, the second UID, the third UID, etc.) can serve as an obfuscation seed of the protected executable code (e.g., connection instructions, APIs, transformation models, etc.). That is, the UID can serve as a seed to a function or algorithm that generates the protected executable code dynamically at run time. For example, a procedural generation algorithm can construct the protected executable code based on the UID, ensuring it does not exist in a static or reusable form.

In some implementations, the one or more processing circuits (e.g., analysis circuit 136 of FIG. 11) can use the UID (e.g., the first UID, the second UID, the third UID, etc.) as a toggle feature. That is, the UID can enable or disable certain features or functions in the protected executable code (e.g., connection instructions, APIs, transformation models, etc.), such that the implementation of the protected executable code can be obfuscated or otherwise inaccessible to computing systems of the public environment. For example, the protected executable code can contain one or more paths, and/or the UID can activate the paths relevant to a particular deployment.

In some implementations, the one or more processing circuits (e.g., analysis circuit 136 of FIG. 11) can use the UID as a hashing or masking parameter. That is, the one or more processing circuits (e.g., analysis circuit 136 of FIG. 11) can use the UID (e.g., the first UID, the second UID, the third UID, etc.) to hash, mask, or encode data flowing through the protected executable code (e.g., connection instructions, APIs, transformation models, etc.), obfuscating the protected executable code. For example, one or more rules associated with the protected executable code can include UID-based hash functions that encode or decode data, hiding the specifics from the transformation process.

In some implementations, the one or more processing circuits (e.g., analysis circuit 136 of FIG. 11) can use the UID (e.g., the first UID, the second UID, the third UID, etc.) as a compiler directive. That is, the UID can act as a directive during the compilation of source code corresponding to the protected executable code (e.g., connection instructions, APIs, transformation models, etc.), resulting in binary output specific to the UID. For example, one or more customizable functions (e.g., preprocessor macros) can use the UID to conditionally include or exclude parts of the source code corresponding to the protected executable code.

In some implementations, the one or more processing circuits (e.g., analysis circuit 136 of FIG. 11) can use the UID (e.g., the first UID, the second UID, the third UID, etc.) as a machine learning or artificial intelligence model identifier. That is, the UID can be associated with a pre-trained machine learning model that performs operations corresponding to the protected executable code (e.g., connection instructions, APIs, transformation models, etc.), wherein the protected executable code resides in one or more model weights instead of the public environment. For example, the secure environment can host a machine learning or artificial intelligence model, and the UID can select the model and/or what parameters to load.

In some implementations, the one or more processing circuits (e.g., analysis circuit 136 of FIG. 11) can use the UID (e.g., the first UID, the second UID, the third UID, etc.) in conjunction with one or more methods for obfuscating the protected executable code (e.g., connection instructions, APIs, transformation models, etc.). That is, the protected executable code can use one or more methods to provide an additional layer of obfuscation. For example, analysis circuit 136 can compile the protected executable code into a binary module or library (e.g., dll, .so, .jar, etc.) so that the public environment interacts with the binary module or library without exposing proprietary information (e.g., confidential source code, intellectual property, etc.) about the protected executable code. In another example, the UID (e.g., the first UID, the second UID, the third UID, etc.) can obfuscates the protected executable code using one or more obfuscation tools (e.g., ProGuard, Obfuscator-LLCM, Minify, etc.) that make the protected executable code difficult to decipher. In another example, the integration gateway can divide the protected executable code across multiple layers (e.g., backend services, microservices, client-side applications, etc.) so that no single component has the complete implementation of the protected executable code.

In some implementations, the public environment can include at least one open-source executable component, module, or library, wherein the one or more processing circuits communicate, via the integration gateway, with the at least one open-source component, module, or library to transform the data structure. For example, the public environment can allow the integration gateway to access the transformation model via the UID and/or use the transformation model to model the data structure. In another example, the public environment can provide the transformed data structure to a client or application. Further, the public environment can include one or more plugins. For example, the public environment can include plugins that prevent excessive API requests from overloading backend systems. In some implementations, the public environment is part of an API management platform. That is, the public environment can allow the integration gateway to manage API traffic, route API requests to backend service, and monitor and/or analyze API usage. In some implementations, the public environment allows the integration gateway to handle translations of protocols (e.g., HTTP, gRPC, SOAP, MQTT, etc.). For example, the one or more processing circuits (e.g., analysis circuit 136 of FIG. 11) can use the public environment to convert one or more gRPC calls to one or more RESTful APIs to facilitate integration between modern and/or legacy systems. In some implementations, the one or more processing circuits (e.g., analysis circuit 136 of FIG. 11) use the public environment to manage security of the integration gateway. For example, analysis circuit 136 can use the public environment to authenticate API requests using tokens or enforce access control policies. In some implementations, the integration gateway can be partially or wholly constructed using the public environment.

In some implementations, the public environment can include at least one open-source component, module, or library. For example, the public environment can include open-source code repositories (e.g., GitHub, GitLab, Bitbucket, SourceForge, etc.), artifact repositories (e.g., JFrog Artifactory, Sonatype Nexus, Apache Archiva, etc.), packaging repositories (e.g., npm, PyPI, RubyGems, etc.), configuration repositories (e.g., HashiCorp Counsul, etcd, GitOPs Repositories, etc.), data repositories (e.g., Kong Gateway, WSO2 API Manager, Postman API Network, etc.), monitoring repositories (e.g., Elastic Stack, Prometheus, Grafana Loki, etc.), public domain repositories (e.g., OASIS Open Repositories, W3C Repositories, etc.), etc. In another example, the public environment can include message queues and/or event broker libraries (e.g., Apache Kafka, RabbitMQ. NATS, etc.), data transformation libraries (e.g., Jackson. Gson, jmespath, etc.), security libraries (e.g., OAuth2, JWT, Bouncy Castle, etc.), database libraries (e.g., Hibernate, SQLAchemy, MongoDB Driver, etc.), workflow libraries (e.g., Apache Camel, Temporal, Cadence, etc.), scheduler libraries (e.g., Celery, Quartz Scheduler, APScheduler, etc.), file libraries (e.g., Apache Commons IO, Apache Flink, etc.), protocol or networking libraries (e.g., Netty, HTTP Client Libraries, GRPC libraries, etc.), and so on.

In some implementations, the one or more processing circuits (e.g., analysis circuit 136 of FIG. 11) can communicate, via the integration gateway, with the at least one open-source component, module, or library to transform the data structure. For example, analysis circuit 136 can use API libraries (e.g., RESTful libraries, SOAP libraries, GraphQL libraries, etc.) to communicate API requests to the integration gateway. Further, the one or more processing circuits can use format libraries (e.g., JSON libraries, XML libraries, etc.) to handle transformation requests associated with API requests communicated to the integration gateway.

In some implementations, the secure environment can correspond to one or more secure data sources that are inaccessible by one or more computing systems operating in the public environment and/or executing open-source code. That is, the secure environment can be a restricted area within a system or network designed to ensure the confidentiality, integrity, and/or availability of the protected executable code (e.g., connection instructions, APIs, transformation models, etc.). For example, the secure environment can include systems that enforce strong authentication (e.g., encrypted databases, encrypted servers, etc.) or systems compliant with security standards (e.g., SOC 2, ISO 27001). In some implementations, the secure environment can use one or mechanisms to ensure the protected executable code is not accessible by the public environment. For example, the secure environment can reside on a separate network or Virtual Local Area Network (VLAN), include one or more permission structures, incorporate intermediary gateways (e.g., a proxy that enforces access rules), data abstraction protocols, include a zero-trust architecture, etc.

In some implementations, the secure environment can implement access controls that prevent direct or indirect communication from the public environment to the secure environment. That is, the secure environment can isolate (e.g., inaccessible) protected executable code (e.g., connection instructions, APIs, transformation models, etc.) by enforcing hardware-enforced access restrictions, firewall policies, or virtualized execution boundaries. In some implementations, the secure environment is hosted on a separate physical network segment or virtual private cloud (VPC) that is not routable from systems executing open-source components. For example, the secure environment can reside in a subnet with no public IP addressing and can enforce ingress and egress restrictions using network access control lists (ACLs) or software-defined perimeter (SDP) configurations. In another example, the secure environment can execute within a hardware-backed secure enclave (e.g., Intel SGX, AMD SEV) that prevents memory access by untrusted processes. In some implementations, the secure environment can use an API gateway configured to reject all unauthenticated or unsigned requests, where access is limited to tokens issued by trusted identity providers operating within a closed trust boundary. In another example, the secure environment can include middleware enforcing strict request validation, such that even if an interface is exposed, execution of protected executable code is not permitted unless verification conditions are satisfied. In some implementations, reverse proxies and one-way data links (e.g., data diodes) can be used to further restrict bidirectional communication and prevent data leakage from the secure environment to the public environment.

In some implementations, the one or more processing circuits (e.g., analysis circuit 136 of FIG. 11) can call an external API or service using the UID to obtain the software underlying the UID (e.g., connection instructions, APIs, transformation models, etc.). That is, the UID can act as a token to authenticate with an external service that hosts the protected executable code. For example, an API endpoint can receive an API request from a client and/or application involving access to a protected executable code, validate the UID (e.g., verify that the provided UID matches a stored transformation model), verify permissions (e.g., ensure a client/application making the API request has access to the protected executable code), and/or obtain, via a backend system, the protected executable code using the UID.

In some implementations, obtaining the protected executable code (e.g., connection instruction, APIs, transformation models, etc.) can include transmitting, by one or more processing circuits (e.g., analysis circuit 136 of FIG. 11), an API data request to one or more API endpoints corresponding with the secure environment. That is, a client or application can send an API data request directing the request to be fulfilled at the API endpoints corresponding with the secure environment. For example, the API request can include an HTTP method (e.g., GET), one or more headers with metadata (e.g., authentication tokens, content type (JSON or XML), user-agent details, etc.), and/or body information (e.g., model version, model type, etc.). Further, the API data request can include one or more HTTP clients (e.g., curl, fetch (JavaScript), axios (JavaScript), requests (Python), Postman, etc.).

In some implementations, the API data request can be followed by an API response. For example, the API response can include a status code (e.g., “200 OK for success,” “404 Not Found” for missing resources, etc.) or a response body (e.g., response containing the requested protected executable code in a JSON format). In some implementations, the one or more processing circuits (e.g., analysis circuit 136 of FIG. 11) send a plurality of API requests to a plurality of API endpoints. For example, analysis circuit 136 can send a plurality of API requests to a plurality of API endpoints, wherein a combination of the plurality of responses forms the protected executable code. Further, the integration gateway can use one or more tools or frameworks to support multiple API requests (e.g., Promise.all in JavaScript, multithreading in Python, etc.). In some implementations, the API data request can include aggregated endpoints. That is, the API data request can correspond to a single API endpoint that aggregates data from multiple sources internally.

In some implementations, the API data request can include at least the UID (e.g., the first UID, the second UID, the third UID, etc.). That is, the API data requests can use the UID as part of a request path, query parameter, or request body. In some implementations, the integration gateway can route the API data request to one or more API endpoints based on the UID. That is, the integration gateway can route the API data request to the API or microservice hosting the protected executable code (e.g., connection instructions, APIs, transformation models, etc.). In some implementations, one or more backend systems can process the API data request and use the UID to retrieve the protected executable code. For example, the one or more backend systems can use the UID to query a database or storage system to retrieve the protected executable code. Further, the integration gateway can validate the API data request (e.g., verify API token, verify client/application access permissions, etc.). In some implementations, the one or more backend systems can send the protected executable code back to the integration gateway and then the integration gateway sends the protected executable code back to the client or application that initiated the API data request.

In some implementations, the data structure can correspond to a first format, structure, fields, or protocols (FSFP), and wherein updating the data structure includes updating the first FSFP to a second FSFP, wherein the second FSFP corresponds to a default or standardized FSFP. For example, the data structure can be in the JSON format and updating the data structure can include transforming the data structure into a transformed data structure in the XML format. In another example, the data structure can be in the JSON format and updating the data structure can include transforming the data structure a transformed data structure corresponding to a token structure. Further, the token structure can include a header (e.g., token type, signing algorithm type, etc.), payload (e.g., claims, data, etc.), signature (e.g., data that verifies the authenticity of the token), and much more.

In some implementations, the FSFP (e.g., first FSFP or second FSFP) can define at least one of a schema, encoding standard, or protocol definition used to serialize or transmit the data structure. That is, the FSFP can include format definitions such as JSON, XML, Protobuf, Avro, or YAML; structural representations such as nested object hierarchies, flat key-value pairs, or array-based sequences; field naming conventions such as camelCase, snake_case, or kebab-case; and protocols such as REST, gRPC. SOAP, or MQTT. In some implementations, the first FSFP can correspond to native data configuration of a source system and the second FSFP can correspond to a normalized target configuration expected by a destination system or transformation model. For example, a source system can transmit a data structure in Protobuf with snake_case field names and the transformation model can update the FSFP by converting the Protobuf structure to JSON with camelCase field names. In another example, a data structure retrieved from an IoT sensor using MQTT and encoded in CBOR can be updated to a second FSFP corresponding to a JSON-based REST API schema. In some implementations, the FSFP update can include mapping fields between schemas, inserting default values, removing unsupported or deprecated fields, reordering field positions, flattening nested structures, or wrapping fields in a standardized envelope object. In some implementations, the transformation model can validate the updated FSFP against a schema definition (e.g., JSON Schema, XSD, or Protobuf.proto file) prior to transmission to the integration gateway or target endpoint.

In some implementations, the one or more processing circuits (e.g., analysis circuit 136 of FIG. 11) can generate activity metrics based on using the protected executable code (e.g., connection instructions, APIs, transformation models, etc.). That is, the activity metrics can provide insights into when, why, and/or how the protected executable code are used by the integration gateway. In some implementations, the activity metrics can include at least one of performance data, demand data, security data, and/or error data of the protected executable code.

The performance data can include throughput data (e.g., the number of instructions executed per second, the number of data structures processed by protected executable code in a given time, etc.), protected executable code latency data (e.g., the processing time per instruction and/or set of instructions corresponding to the protected executable code), network utilization (e.g., the bandwidth used by the protected executable code), horizontal scalability data (e.g., the number of nodes or instances used by the protected executable code), vertical scalability data (e.g., CPU usage, memory usage, etc.), queue processing time (e.g., the average time data structures wait in queue for at least one (e.g., each) instruction and/or set of instructions corresponding to the protected executable code), success rate (e.g., the percentage of successful instructions), complexity index (e.g., data that tracts the complexity of the protected executable code), and so on. In another example, the demand data can include the instruction total, (e.g., the total number of completed instructions), queue length (e.g., number of data sources and/or data structures in queue for the protected executable code), and/or usage patterns (e.g., peak usage times, data about the highest-use protected executable code, etc.), and so on.

The error data can include the instruction failure total (e.g., the total number of failed instruction executions), the error rate (e.g., the percentage of instructions that resulted in errors), the error breakdown (e.g., the analysis of what errors occurred, such as data quality errors, software errors, system errors, security errors, etc.), diagnostics information (e.g., data related to the source of the error), and so on.

The security data can include compliance metrics (e.g., data about whether the protected executable code comply with one or more policies or standards), resilience metrics (e.g., data corresponding to how resilient the protected executable code is to a cyberattack), threat detection data (e.g., data corresponding to anomalies and/or vulnerabilities detected during and after instructions execute), authentication information (e.g., the number of authorized clients and/or applications using the protected executable code), and so on.

In some implementations, the activity metrics are stored in a centralized or external environment (e.g., database). For example, the one or more processing circuits (e.g., analysis circuit 136 of FIG. 11) can store the activity metrics in database 140. In some implementations, the activity metrics can include data corresponding to the users of the protected executable code. For example, the activity metrics can include information (e.g., entity name, entity address, entity place of business, entity business type, etc.) for a plurality of third party devices 150 using an integration gateway such as response system 130.

In some implementations, the one or more processing circuits (e.g., analysis circuit 136 of FIG. 11) can monitor the protected executable code (e.g., connection instructions, APIs, transformation models, etc.) for activity metrics. That is, the one or more processing circuits (e.g., analysis circuit 136 of FIG. 11) can detect when the protected executable code starts and/or finishes and/or collect activity metrics for at least one (e.g., each) instruction and/or set of instructions corresponding to the protected executable code. Further, the one or more processing circuits (e.g., analysis circuit 136 of FIG. 11) can monitor the activity metrics in real time. In some implementations, the protected executable code can include monitoring hooks for monitoring the activity metrics. For example, the protected executable code can include API hooks that allow the integration gateway to collect and/or identify activity metrics. In some implementations, the one or more processing circuits (e.g., analysis circuit 136 of FIG. 11) can provide indicators (e.g., notifications) to one or more systems or applications (e.g., integration gateway, user devices, etc.) regarding activity metrics.

In some implementations, the one or more processing circuits (e.g., analysis circuit 136 of FIG. 11) can map the activity metrics to the UID (e.g., the first UID, the second UID, the third UID, etc.). That is, the UID can be used to identify activity metrics that correspond to the protected executable code (e.g., connection instructions, APIs, transformation algorithms, etc.). In some implementations, the one or more processing circuits (e.g., analysis circuit 136 of FIG. 11) can map the activity metrics to the UID using key-value mapping. That is, the UID can be associated with a set of values and the one or more processing circuits (e.g., analysis circuit 136 of FIG. 11) can store the activity metrics within the set of values and the UID can serve as a key. In some implementations, the one or more processing circuits (e.g., analysis circuit 136 of FIG. 11) can map the activity metrics to the UID using relational tables. That is, the one or more processing circuits (e.g., analysis circuit 136 of FIG. 11) can store the UIDs in a table, with related data either in the same table or in separate tables linked by relationships. In some implementations, the one or more processing circuits (e.g., analysis circuit 136 of FIG. 11) can map the activity metrics to the UID using key-path mapping. That is, the UID can be part of an object key or path linking the UID to activity metrics.

In some implementations, the one or more processing circuits (e.g., analysis circuit 136 of FIG. 11) can generate an activity token (e.g., cryptographic data structure) comprising activity metrics, broadcast the activity token to a plurality of network nodes, validate the activity token using a consensus mechanism (e.g., proof of work (POW), proof of stake (POS), delegated proof of stake (DPOS), practical byzantine fault tolerance (PBFT), proof of burn (POB), etc.), and/or record the activity token on a distributed ledger (e.g., blockchain). In some implementations, the one or more processing circuits (e.g., analysis circuit 136 of FIG. 11) can execute one or more smart contracts to record the activity metric on the distributed ledger. For example, a smart contract can correspond to one or more activity metrics and/or automatically record the one or more activity metrics on the distributed ledger as the one or more activity metrics are collected. In some implementations, the one or more processing circuits (e.g., analysis circuit 136 of FIG. 11) record the activity metrics outside the distributed ledger, but the one or more processing circuits record a proof of the activity metric on the ledger to ensure privacy. For example, the distributed ledger can contain proof that the protected executable code properly executed.

In some implementations, the one or more processing circuits (e.g., analysis circuit 136 of FIG. 11) can use the UID (e.g., the first UID, the second UID, the third UID, etc.) as part of a data request to display activity metrics. For example, an AIP request can include a call to a GET HTTP method in which the UID is passed as a parameter for one or more API endpoints. In some implementations, the one or more processing circuits (e.g., analysis circuit 136 of FIG. 11) provide the activity metrics to a user device via a graphical user interface (GUI). The one or more processing circuits (e.g., analysis circuit 136 of FIG. 11) can display the activity metrics in many forms, such as graphs, tables, charts, etc. Further, users can interact with the activity metrics on the user device. For example, user can apply filters to narrow the activity metrics displayed on a GUI.

In some implementations, the protected executable code (e.g., connection instructions, APIs, transformation models, etc.) can be associated with at least one protected executable code creator or protected executable code owner. The at least one protected executable code owner or protected executable code creator can be the same as at least one integration gateway owner or integration gateway creator. In some implementations, the one or more processing circuits (e.g., analysis circuit 136 of FIG. 11) can determine or identify a creator or owner of a plurality of protected executable code. That is, it is possible for the one or more processing circuits (e.g., analysis circuit 136 of FIG. 11) to identify the creators or owners of the protected executable code used by the integration gateway. For example, the protected executable code can include metadata that indicates the identity of the creator or owner of the plurality of protected executable code. In another example, the protected executable code can be accompanied by a descriptor file or manifest that includes details about the owner or creator of the plurality of protected executable code. In another example, a database can store cryptographic hashes/markers or digital signatures associated with the creator or owner of the plurality of protected executable code, wherein the decoding the cryptographic hashes/markers or digital signatures reveals the creator or owner of the plurality of protected executable code. In some implementations, the one or more processing circuits (e.g., analysis circuit 136 of FIG. 11) can link the UID (e.g., the first UID, the second UID, the third UID, etc.) to a registry that contains information about the creator or owner of the plurality of protected executable code.

In some implementations, the one or more processing circuits (e.g., analysis circuit 136 of FIG. 11) allocate an amount or a percentage of an amount to an account of the creator or owner of the plurality of protected executable code (e.g., connection instructions, APIs, transformation models, etc.). That is, the creator or owner of the plurality of protected executable code can provide incentives (e.g., money) for creating or owning protected executable code. In some implementations, a financial institution (e.g., a bank) manages the account associated with the creator or owner of the plurality of protected executable code. Further, the financial institution can notify the creator or owner of an account deposit via a notification on a user device. In some implementations, the one or more processing circuits (e.g., analysis circuit 136 of FIG. 11) can provide one or more incentives to the creator or owner of the plurality of protected executable code. For example, the creator or owner of the plurality of protected executable code can receive non-monetary incentives, such as certificates, tokens, awards, credits, etc. In some implementations, the creator or owner of the protected executable code can receive incentives at least one (e.g., each) time a third party uses the protected executable code. For example, the third party devices 150 can request to access and/or use the protected executable code by enabling a UID (e.g., the first UID, the second UID, the third UID, etc.), where at least one (e.g., each) instance of accessing and/or using the protected executable code via the UID can provide one or more incentives to the creator or owner of the protected executable code.

In some implementations, the one or more processing circuits (e.g., analysis circuit 136 of FIG. 11) can calculate an amount or a percentage of an amount to be allocated based on a usage metric corresponding to interactions with the protected executable code. That is, the usage metric can include at least one of the number of UID activations, duration of usage, volume of data processed, or a function execution count associated with the protected executable code. In some implementations, the one or more processing circuits can retrieve a revenue allocation rule from a secure environment, where the rule defines how much of a total value (e.g., payment, token value, credit value, etc.) should be distributed to an account associated with a given UID. For example, if a transformation model is used in 100 UID invocations, and the rule specifies a 0.5% per-use royalty, the one or more processing circuits can compute and allocate the total corresponding amount to the account of a creator. In another example, a tiered rule can specify that for up to 500 invocations a 0.3% rate is applied and for more than 500 invocations a 0.6% rate is applied, where the processing circuits compute cumulative usage and allocate the applicable amounts accordingly. In some implementations, the one or more processing circuits can store allocation transactions in a distributed ledger or a secure transaction log to maintain a verifiable record of all allocations tied to protected executable code usage.

In some implementations, the one or more processing circuits (e.g., analysis circuit 136 of FIG. 11) can transmit the computed allocation to an external payment system or token distribution service. That is, once the allocation is computed based on the revenue allocation rule, the one or more processing circuits can construct a transaction payload including the amount or percentage, the destination account identifier, and a usage reference (e.g., UID, timestamp, session ID, etc.). In some implementations, the transaction payload can be signed using a cryptographic signature and transmitted to a financial processing API or smart contract for execution. For example, if the allocation involves cryptocurrency or digital tokens, the one or more processing circuits can invoke a token transfer function on a blockchain-based smart contract, using the destination wallet address corresponding to the creator or owner of the protected executable code. In another example, if the allocation is processed through a traditional financial system, the processing circuits can format the payload for an ACH transfer or SWIFT instruction and transmit it to a transaction gateway of a bank. In some implementations, the one or more processing circuits can also trigger an acknowledgment mechanism that records the success or failure of the allocation in a tracking database, which can be queried by clients or creators via a reporting interface or audit tool.

In some implementations, the UID (e.g., the first UID, the second UID, the third UID, etc.) can correspond with one or more integration scenarios of the integration gateway. That is, the UID corresponds with unique connection instructions, APIs, transformation models, and any other unique protected executable code. The integration scenario can be based on the data source and/or the data structure. That is, the connection instructions, APIs, transformation models, and other forms of protected executable code corresponding to the UID can depend on the data source and/or data structure. For example, transforming data retrieved via a first data source can include a first set of UIDs and transforming data retrieved from a second data source can include a second set of UIDs, where the first set of UIDs can be the same as the second set of UIDs.

In some implementations, the UID (e.g., the first UID, the second UID, the third UID, etc.) can be compatible with one or more authorized integration scenarios. That is, the integration gateway can accept and/or process the UID if the UID corresponds with authorized integration scenarios. The integration gateway can verify whether the UID corresponds with one or more authorized integration scenarios. For example, the UID can correspond to an authorized integration scenario if the UID enables connection instructions, APIs, transformation models, and/or other forms of protected executable code specified in the integration scenario.

In some implementations, the integration gateway can use artificial intelligence, generative artificial intelligence, machine learning, or a combination thereof to improve the performance of the protected executable code (e.g., connection instructions, APIs, transformation models, etc.). For example, integration gateway can use the ML or AI algorithms to predict bottlenecks in a pipeline of requests (e.g., connection requests, data requests, transformation request, etc.), detect anomalies or failures in instructions, validate the data sources and/or data structures corresponding to the underling instructions, predict protected executable code rules or steps, optimize or update the protected executable code, etc. In some implementations, the integration gateway can use ML or AI to improve request handling. For example, the AI or ML can classify requests and/or assign one or more priority levels to the requests based on a plurality of factors (e.g., client/application need). In another example, the AI or ML can predict which request will require the most processing power and/or allocate resources accordingly to avoid bottlenecks. In some implementations, the protected executable code is based on AI or ML. For example, the protected executable code can incorporate AI or ML algorithms to perform any of the functions discussed herein (e.g., detecting anomalies in the protected executable code).

In some implementations, the one or more processing circuits (e.g., analysis circuit 136 of FIG. 11) can receive or identify a plurality of unstructured data corresponding to a plurality of data structures train an AI model or ML model using the plurality of unstructured data, model, using the AI model or the ML model, a plurality of data structure parameters (e.g., request method, API endpoints, query parameters, request headers, request body, transformation model, etc.) and/or generate, using the AI model or the ML model, at least one output based on at least one data structure parameter. For example, the AI model or ML model can train based on unstructured data corresponding to API requests, the AI model or ML model can model API endpoints, and the AI model or the ML model can generate a list of API endpoints for handling API requests.

In some implementations, the data structure can correspond with a first API request and/or the transformed data structure corresponds with a second API request. Further, the data structure can include at least one of a first HTTP method (e.g., GET, POST, PUT, DELETE, PATCH), a first URL (e.g., the API endpoints), a first header (e.g., authorization, content-type, accept, user-agent, etc.), a first body (e.g., payload), a first authentication mechanism (e.g., API key, OAuth Token, basic authentication, etc.), a first query parameter (e.g., parameters to filter, sort, or paginate the data being requested). Additionally, the transformed data structure can include at least one of a second HTTP method, a second URL, a second header, a second body, a second authentication mechanism, and/or a second query parameter. In some implementations, at least one of the first HTTP method, the first URL, the first header, the first body, the first authentication mechanism, or the first query parameter can be different from the second HTTP method, the second URL, the second header, the second body, the second authentication mechanism, or the second query parameter.

In some implementations, the one or more processing circuits (e.g., analysis circuit 136 of FIG. 11) can receive or identify the data structure (e.g., first API request) from a first system of application. For example, the first client or application can create the first data structure so that the first data structure can be received or identified. In some implementations, the first client or application can create and/or provide the data structure in response to one or more user actions via the first client or application (e.g., fetching data, sending data, updating data, backend processes, etc.).

In some implementations, the one or more processing circuits (e.g., analysis circuit 136 of FIG. 11) can direct the data structure to one or more endpoints (e.g., API endpoints) defined by the integration gateway. That is, the integration gateway can define where the data structure will be processed. In some implementations, one or more URLs define the one or more endpoints. The URL can include a base URL (e.g., https://example.com) and/or an endpoint path (e.g., /users/ ,/products/{id}/, etc.). In some implementations, the endpoints can include the UID (e.g., first UID, second UID, third UID, etc.). For example, the URL can include the UID (e.g., https://example.com/users/{UID}). In other implementations, the one or more processing circuits (e.g., analysis circuit 136 of FIG. 11) can include the UID in at least one of the headers, the request body (e.g., a JSON payload for a POST/PUT request), or the query parameters (e.g., query parameters for a GET request).

In some implementations, the one or more processing circuits (e.g., analysis circuit 136 of FIG. 11) validate/authenticate the data source, the data structures, and/or the requests (e.g., connection requests, data requests, transformation requests, etc.). For example, analysis circuit 136 can verify that the data sources, data structures, and/or the requests contain valid credentials (e.g., API key, OAuth token, JWT, etc.). In some implementations, validating/authenticating the data sources, data structures, and/or the requests includes verifying one or more permission structures. For example, analysis circuit 136 can verify that the client or application has permission to access API data (e.g., the transformation model, data the target of an API request, etc.). In some implementations, validating the data sources, data structures, and/or the requests includes input validation. For example, analysis circuit 136 can validate the request data (e.g., headers, query parameters, body, etc.) against predefined schemas and/or formats.

In some implementations, the one or more processing circuits (e.g., analysis circuit 136 of FIG. 11) can provide the transformed data structure to a second system or application. For example, analysis circuit 136 can provide the transformed data structure to a backend system (e.g., legacy system) that is capable of digesting and/or interpreting the transformed data structure. In some implementations, the one or more processing circuits (e.g., analysis circuit 136 of FIG. 11) send the transformed data structure (e.g., the second API request) to a server to generate a response data structure (e.g., API response). The response data structure can include at least one of an HTTP status code (e.g., 200 OK, 201 Created, 400 Bad request, 401 Unauthorized, 500 Internal Server Error, 503 Service Unavailable), a response header (e.g., content-type, content-length, authorization, cache-control. X-rate-limit, etc.), a response body (e.g., payload), a message (e.g., error or success message), response data (e.g., object, array, etc.), pagination information (e.g., page, limit, total_count, next_page, etc.), or links (e.g., URLs for related resources or actions).

In some implementations, the one or more processing circuits (e.g., analysis circuit 136 of FIG. 11) send the response data structure (e.g., API response) back to the client or application that initiated the data structure (e.g., the first API request). For example, the client or application receives the requested data in the response data structure (e.g., API response). In other implementations, the one or more processing circuits (e.g., analysis circuit 136 of FIG. 11) sends the response data structure to one or more servers for further processing. For example, analysis circuit 136 can use a webhook to send the data structure response (e.g., API response) to a server when an event or condition occurs. Further, the response data structure can be in a different format than the data structure. For example, the response data structure can be in an XML format while the data structure can be in the JSON format. In some implementations, the one or more processing circuits model the response data structure using the transformation model so that the transformed data structure (e.g., API response) has at least one of the same the same format, fields, structure, or protocols as the data structure (e.g., the first API request).

In some implementations, the one or more processing circuits, (e.g., analysis circuit 136 of FIG. 11) handle errors when the data structure (e.g., the first API request) is being processed. For example, the one or more processing circuits can provide one or more error codes (e.g., 400, 401, 403, 404, 500, etc.) to the client or application.

### Configuration of Exemplary Implementations

While this specification contains many specific implementation details and/or implementation details, these should not be construed as limitations on the scope of any implementations or of what can be claimed, but rather as descriptions of features specific to particular implementations and/or implementations of the systems and methods described herein. Certain features that are described in this specification in the context of separate implementations and/or implementations can also be implemented and/or arranged in combination in a single implementation and/or implementation. Conversely, various features that are described in the context of a single implementation and/or implementation can also be implemented and arranged in multiple implementations and/or implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Additionally, features described with respect to particular headings can be utilized with respect to and/or in combination with illustrative implementation described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing can be advantageous. Moreover, the separation of various system components in the implementations and/or implementations described above should not be understood as requiring such separation in all implementations and/or implementations, and it should be understood that the described program components and systems can generally be integrated together in a single software product or packaged into multiple software products.

Having now described some illustrative implementations, implementations, illustrative implementations, and implementations it is apparent that the foregoing is illustrative and not limiting, having been presented by way of example. In particular, although many of the examples presented herein involve specific combinations of method acts or system elements, those acts, and those elements can be combined in other ways to accomplish the same objectives. Acts, elements and features discussed only in connection with one implementation and/or implementation are not intended to be excluded from a similar role in other implementations or implementations.

The phraseology and terminology used herein is for the purpose of description and should not be regarded as limiting. The use of “including” “including” “having” “containing” “involving” “characterized by” “characterized in that” and variations thereof herein, is meant to encompass the items listed thereafter, equivalents thereof, and additional items, as well as alternate implementations and/or implementations consisting of the items listed thereafter exclusively. In one implementation, the systems and methods described herein consist of one, each combination of more than one, or all of the described elements, acts, or components.

Any references to implementations, implementations, or elements or acts of the systems and methods herein referred to in the singular can also embrace implementations and/or implementations including a plurality of these elements, and any references in plural to any implementation, implementation, or element or act herein can also embrace implementations and/or implementations including a single element. References in the singular or plural form are not intended to limit the presently disclosed systems or methods, their components, acts, or elements to single or plural configurations. References to any act or element being based on any information, act or element can include implementations and/or implementations where the act or element is based at least in part on any information, act, or element.

Any implementation disclosed herein can be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation can be included in at least one implementation. Such terms as used herein are not necessarily all referring to the same implementation. Any implementation can be combined with any other implementation, inclusively or exclusively, in any manner consistent with the aspects and implementations disclosed herein.

Any implementation disclosed herein can be combined with any other implementation, and references to “an implementation,” “some implementations.” “an alternate implementation,” “various implementations,” “one implementation” or the like are not necessarily mutually exclusive and are intended to indicate that a particular feature, structure, or characteristic described in connection with the implementation can be included in at least one implementation. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein can be implemented in other specific forms without departing from the characteristics thereof. Although the examples provided herein relate to controlling the display of content of information resources, the systems and methods described herein can include applied to other environments. The foregoing implementations and/or implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for transforming data structures in an integration gateway, comprising:
receiving, by one or more processing circuits, a connection request comprising a first unique identifier (UID) corresponding with at least one data source;
connecting, by the one or more processing circuits using the first UID, the at least one data source to an entity computing system;
receiving, by the one or more processing circuits, a data request for accessing a data structure on the at least one data source, the data request comprising a second UID;
obtaining, by the one or more processing circuits using the second UID, the data structure;
identifying, by the one or more processing circuits, a transformation model stored in a secure environment based on a third UID, wherein the transformation model comprises executable code for updating the data structure, and wherein the one or more processing circuits restrict access, using the third UID, to the transformation model and corresponding executable code from a public environment;
modeling, by the one or more processing circuits using the transformation model, the data structure to generate a transformed data structure; and
providing, by the one or more processing circuits, the transformed data structure to the integration gateway.

2. The method of claim 1, further comprising:
identifying, by the one or more processing circuits, connection instructions stored in the secure environment based on the first UID, wherein the connection instructions comprise executable code for connecting the at least one data source to the entity computing system, and wherein the one or more processing circuits restrict access, using the first UID, to the connection instructions and corresponding executable code from the public environment.

3. The method of claim 2, wherein the second UID corresponds to at least one application program interface (API), wherein the at least one API comprises executable code for obtaining the data structure on the at least one data source.

4. The method of claim 3, further comprising:
enabling, by the one or more processing circuits, the first UID, the second UID, or the third UID, wherein enabling the first UID, the second UID, or the third UID exposes the first UID, the second UID, or the third UID to the public environment.

5. The method of claim 1, wherein the public environment comprises at least one open-source component, module, or library, and wherein the one or more processing circuits communicate, via the integration gateway, with the at least one open-source component, module, or library to transform the data structure.

6. The method of claim 1, wherein the secure environment corresponds to one or more secure data sources inaccessible by one or more computing systems operating in the public environment and executing open-source code.

7. The method of claim 1, wherein the unique identifier (UID) is at least one of a globally unique identifier (GUID), a universally unique identifier (UUID), and a universally unique lexicographically sortable identifier (ULID).

8. The method of claim 1, wherein the data structure corresponds to a first format, structure, fields, or protocols (FSFP), and wherein updating the data structure comprises updating the first FSFP to a second FSFP, wherein the second FSFP corresponds to a default or standardized FSFP.

9. The method of claim 1, further comprising:
generating, by the one or more processing circuits, activity metrics based on using the transformation model, wherein the activity metrics comprise at least one of performance data, demand data, security data, or error data of the transformation model; and
mapping, by the one or more processing circuits, the activity metrics to the first UID, the second UID, or the third UID, wherein using the UID as a parameter to a user data request allows a user device to display the activity metrics via a graphical user interface (GUI).

10. The method of claim 9, further comprising:
generating, by the one or more processing circuits, an activity token comprising at least the activity metrics;
broadcasting, by the one or more processing circuits, the activity token to a plurality of network nodes;
validating, by the one or more processing circuits, the activity token using a consensus mechanism; and
recording, by the one or more processing circuits, the activity token on a distributed ledger.

11. The method of claim 1, further comprising:
determining or identifying, by the one or more processing circuits, a creator or owner of a plurality of transformation models; and
in response to using the transformation model, allocate an amount or a percentage of an amount to an account of the creator or owner of the plurality of transformation models.

12. A system for transforming data structures in an integration gateway comprising:
one or more processing circuits configured to:
receive a connection request comprising a first unique identifier (UID) corresponding with at least one data source;
connect, using the first UID, the at least one data source to an entity computing system;
receive a data request for accessing a data structure on the at least one data source, the data request comprising a second UID;
obtain, using the second UID, the data structure;
identify a transformation model stored in a secure environment based on a third UID, wherein the transformation model comprises executable code for updating the data structure, and wherein the one or more processing circuits restrict access, using the third UID, to the transformation model and corresponding executable code from a public environment;
model, using the transformation model, the data structure to generate a transformed data structure; and
provide the transformed data structure to the integration gateway.

13. The system of claim 12, the one or more processing circuits further configured to:
identify, connection instructions stored in the secure environment based on the first UID, wherein the connection instructions comprise executable code for connecting the at least one data source to the entity computing system, and wherein the one or more processing circuits restrict access, using the first UID, to the connection instructions and corresponding executable code from the public environment.

14. The system of claim 13, wherein the second UID corresponds to at least one application program interface (API), wherein the at least one API comprises executable code for obtaining the data structure on the at least one data source.

15. The system of claim 14, the one or more processing circuits further configured to:
enable the first UID, the second UID, or the third UID, wherein enabling the first UID, the second UID, or the third UID exposes the first UID, the second UID, or the third UID to the public environment.

16. The system of claim 12, wherein the public environment comprises at least one open-source component, module, or library, and wherein the one or more processing circuits communicate, via the integration gateway, with the at least one open-source component, module, or library to transform the data structure.

17. The system of claim 12, wherein the secure environment corresponds to one or more secure data sources inaccessible by one or more computing systems operating in the public environment and executing open-source code.

18. The system of claim 12, wherein the unique identifier (UID) is at least one of a globally unique identifier (GUID), a universally unique identifier (UUID), and a universally unique lexicographically sortable identifier (ULID).

19. The system of claim 12, wherein the data structure corresponds to a first format, structure, fields, or protocols (FSFP), and wherein updating the data structure comprises updating the first FSFP to a second FSFP, wherein the second FSFP corresponds to a default or standardized FSFP.

20. A non-transitory computer readable medium (CRM) comprising one or more instructions stored thereon and executable by one or more processors to:
receive a connection request comprising a first unique identifier (UID) corresponding with at least one data source;
connect, using the first UID, the at least one data source to an entity computing system;
receive a data request for accessing a data structure on the at least one data source, the data request comprising a second UID;
obtain, using the second UID, the data structure;
identify a transformation model stored in a secure environment based on a third UID, wherein the transformation model comprises executable code for updating the data structure, and wherein the one or more processors restrict access, using the third UID, to the transformation model and corresponding executable code from a public environment;
model, using the transformation model, the data structure to generate a transformed data structure; and
provide the transformed data structure to an integration gateway.
